(19) United States
(12) Patent Application Publication
(10) Pub. No.: US 2026/0259645 A1
(43) Pub. Date: Sep. 3, 2026

(54) MEDIA GENERATION SYSTEM AND METHOD

(71) Applicant: CyberFilm.AI Corporation, San Francisco, CA (US)

(72) Inventors: Russell S.A. Palmer, San Francisco, CA (US); Andrew M.A. Palmer, San Francisco, CA (US)

(21) Appl. No.: 19/554,413

(22) Filed: Mar. 2, 2026

Related U.S. Application Data
(60) Provisional application No. 63/766,233, filed on Mar. 3, 2025.

(51) Int. Cl. G06F 3/0484; G06F 3/0482; G06F 40/295; G06T 11/00; G11B 27/031

(52) U.S. Cl. CPC G06F 3/0484; G06F 3/0482; G06F 40/295; G06T 11/00; G11B 27/031

(57) ABSTRACT

A computer-implemented method for AI-assisted media generation comprises receiving, by a processor, user input defining a narrative concept for a media project. The method comprises maintaining, by the processor, a narrative state model storing structured narrative elements including plot metadata, character profile data, and scene information associated with the media project. The method comprises constructing, by the processor, a prompt based on the narrative state model and the user input. The method comprises transmitting, by the processor, the prompt to an external generative AI model via an application programming interface. The method comprises receiving, by the processor, generated content from the external generative AI model. The method comprises integrating, by the processor, the generated content into the narrative state model for display in a user interface.

### CROSS-REFERENCE TO RELATED APPLICATIONS

This application claims priority to U.S. provisional Application No. 63/766,233, titled SAGA FILMMAKING APP, filed Mar. 3, 2025, which is hereby incorporated by reference in its entirety.

### TECHNICAL FIELD

The present disclosure relates to media generation technologies, and more particularly to an AI-assisted media generation system and an AI-assisted media generation method.

### BACKGROUND

The creation of narrative media content, including films, television programs, and other visual storytelling formats, traditionally involves multiple distinct phases of development. These phases may include initial concept development, screenplay writing, visual planning through storyboarding, and pre-visualization of scenes before physical production begins. Each phase has historically required specialized skills, dedicated software tools, and substantial time investment from creative professionals.

Screenwriting software applications have provided tools for formatting and organizing screenplay content according to industry conventions. Storyboarding applications have enabled artists to create visual representations of planned shots and scenes. Video editing applications have provided timeline-based interfaces for arranging and composing media assets. However, these applications have generally operated as separate tools, requiring users to manually transfer information and creative decisions between different software environments throughout the production development process.

The emergence of generative artificial intelligence models has introduced capabilities for automated generation of text, images, audio, and video content. Large language models can generate narrative text based on prompts and contextual information. Image generation models can produce visual content from textual descriptions. Audio generation models can synthesize voice, sound effects, and music. Video generation models can create animated sequences from images or textual descriptions. These generative capabilities have been made accessible through application programming interfaces that enable software applications to invoke generation operations.

Prior approaches to AI-assisted content generation have typically required users to manually specify all relevant context for each generation request. When generating images depicting characters, users of prior systems were required to include character descriptions in each generation prompt, leading to inconsistent character depictions when descriptions varied across requests. The core technical limitation of prior generative AI approaches is “context amnesia” and data entry redundancy. Because generative models are inherently stateless and have limited context windows, users were forced to manually re-type character physical descriptions, plot points, and stylistic parameters into every single new generation prompt. This resulted in high error rates, typographical mistakes, and severely inconsistent outputs, such as a character looking completely different from one generated storyboard image to the next. Prior systems also lacked mechanisms for automatically identifying which generative AI models produced outputs that aligned with user preferences, requiring users to manually experiment with different models to identify suitable options. Additionally, prior systems did not optimize the utilization of context window capacity in generative AI models, often including insufficient context that resulted in generated content lacking coherence with established narrative elements, or exceeding context limits that resulted in truncation of important contextual information. These limitations of prior approaches increased the time and effort required to produce consistent, high-quality generated content and reduced the efficiency of AI-assisted creative workflows.

The data entry redundancy problem in prior systems scales with project complexity. In a prior-art workflow for generating a storyboard sequence containing one hundred shots, a user would be required to manually type a character's physical description one hundred separate times, once for each shot generation prompt. This repetitive data entry introduces exposure to human typographical omission, where the user may forget to include specific character attributes such as “wearing glasses” or “scar on left cheek” in one or more of the one hundred prompts. Such omissions cause the stateless generative AI model to produce inconsistent character depictions, where the same character may appear with different physical attributes across different storyboard frames. The present disclosure addresses this data entry redundancy by reducing the manual entry requirement to exactly one instance at the initial character profile creation, with automated injection of the stored physical description for all subsequent generation operations referencing that character.

Filmmakers and other media creators may benefit from tools that integrate generative AI capabilities into structured creative workflows. Such integration may reduce the time and specialized skills required to progress from an initial narrative concept through visual planning and pre-visualization. Coordination between narrative development, screenplay creation, and visual storyboarding may enable generated content to maintain consistency with established story elements and character definitions throughout the creative process.

Existing approaches to AI-assisted content generation present several technical challenges. First, generative AI models have varying context window capacities that limit the amount of contextual information that can be included in generation prompts. Inefficient utilization of available context window capacity may result in generated content that lacks coherence with established narrative elements, requiring users to manually review and correct inconsistencies. Second, maintaining visual consistency across multiple generated images requires users to repeatedly specify character attributes in each generation request. This repeated specification creates data entry redundancy, increases the likelihood of typographical errors or omissions, and results in inconsistent character depictions when users fail to consistently describe character attributes across generation requests. Third, when multiple generative AI models are available for a given generation task, users lack systematic methods for identifying which models produce outputs that best match their creative preferences. Without model preference data, users may repeatedly receive outputs from models that do not align with their preferences, reducing the efficiency of the creative workflow. The present disclosure addresses these technical challenges through context window optimization that maximizes utilization of available context capacity, automatic character attribute injection based on fuzzy name matching that eliminates redundant data entry, and model preference learning that analyzes user selection patterns to prioritize higher-quality models in subsequent generation operations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a computer-implemented method for AI-assisted media generation is provided. The method comprises receiving, by a processor, user input defining a narrative concept for a media project. The method comprises maintaining, by the processor, a narrative state model storing structured narrative elements including plot metadata, character profile data, and scene information associated with the media project. The method comprises constructing, by the processor, a prompt based on the narrative state model and the user input. The method comprises transmitting, by the processor, the prompt to an external generative AI model via an application programming interface. The method comprises receiving, by the processor, generated content from the external generative AI model. The method comprises integrating, by the processor, the generated content into the narrative state model for display in a user interface.

According to other aspects of the present disclosure, the method includes one or more of the following features. The plot metadata comprises at least one of a title, a logline, a theme, a story type, a genre, a tone, an audience designation, and a setting. The character profile data comprises at least one of a character name, a character role, a character arc, a character description, a personality trait, an archetype, a want, a need, a lie, and a ghost. The narrative state model can further store act structure data and beat sheet data defining narrative progression points within the media project. The beat sheet data may comprise a plurality of beat entries organized according to a predefined beat template, each beat entry comprising a beat label and a beat description. Constructing the prompt may comprise injecting character profile data from the narrative state model into the prompt to maintain character consistency across generated content. The generated content may comprise at least one of text content, image content, audio content, and video content. The external generative AI model may comprise at least one of a large language model for generating text content, an image generation model for generating image content, an audio generation model for generating audio content, and a video generation model for generating video content. The method further comprises transmitting the prompt to a plurality of external generative AI models via respective application programming interfaces and receiving a plurality of generated content options for display in the user interface for user selection.

According to another aspect of the present disclosure, a system for AI-assisted media generation is provided. The system comprises a memory storing instructions. The system comprises a processor coupled to the memory and configured to execute the instructions. The processor is configured to provide a story development interface configured to receive user input defining narrative elements including at least one of plot metadata, character profiles, act structures, and beat sheet entries. The processor is configured to provide a script editor interface configured to display screenplay content and receive user selections for AI-assisted text generation. The processor is configured to provide a storyboard editor interface configured to receive shot parameters including shot type and camera level selections for AI-assisted image generation. The processor is configured to provide a video editor interface configured to receive media assets including storyboard images, video clips, and audio elements, and to arrange the media assets in a sequence for video composition and export. The processor is configured to maintain a narrative state model that persists narrative elements across the story development interface, the script editor interface, the storyboard editor interface, and the video editor interface. The processor is configured to construct prompts for external generative AI models based on the narrative state model and user selections. The processor is configured to integrate generated content from the external generative AI models into the narrative state model.

According to other aspects of the present disclosure, the system includes one or more of the following features. The script editor interface can be further configured to receive a user selection of text within the screenplay content and a rewrite instruction, and the processor may be further configured to construct a prompt incorporating the selected text, the rewrite instruction, and narrative context from the narrative state model for transmission to a large language model. The script editor interface may be further configured to display a generate button adjacent to a cursor position within the screenplay content, and activation of the generate button may cause the processor to construct a continuation prompt based on preceding screenplay content and the narrative state model. The storyboard editor interface may be further configured to receive reference image selections including at least one of character reference images, location reference images, and prop reference images, and the processor may be further configured to inject the reference image selections into prompts transmitted to an image generation model. The processor may be further configured to retrieve character profile data from the narrative state model based on character name matching within a shot description and inject a physical description associated with a matched character into the prompt for the image generation model. The system may further comprise a timeline editor interface configured to receive media assets including storyboard images, video clips, and audio elements, and the processor may be further configured to arrange the media assets in a sequence and export a composed video file. The processor may be further configured to transmit storyboard images to a video generation model via an application programming interface to generate animated video clips incorporating camera motion parameters, and the timeline editor interface may be configured to receive the animated video clips for arrangement in the sequence.

According to another aspect of the present disclosure, a non-transitory computer-readable medium storing instructions that, when executed by a processor, cause the processor to perform operations is provided. The operations comprise displaying a storyboard editor interface presenting a sequence of storyboard frames associated with scenes of a narrative project. The operations comprise receiving a shot description and shot parameters for a new storyboard frame, the shot parameters including a shot type selection and a camera level selection. The operations comprise constructing a prompt incorporating the shot description, the shot parameters, and narrative context retrieved from a narrative state model associated with the narrative project. The operations comprise transmitting the prompt to an image generation model via an application programming interface. The operations comprise receiving a generated storyboard image from the image generation model. The operations comprise displaying the generated storyboard image within the storyboard editor interface for user selection.

According to other aspects of the present disclosure, the non-transitory computer-readable medium may include one or more of the following features. The narrative context may comprise at least one of character profile data including a physical description, scene context from a screenplay, and reference images associated with characters, locations, or props. The operations may further comprise receiving a character name within the shot description, matching the character name to character profile data stored in the narrative state model, and injecting the physical description associated with the matched character profile data into the prompt. The operations may further comprise transmitting the prompt to a plurality of image generation models via respective application programming interfaces and displaying a plurality of generated storyboard images for user selection.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a flowchart for a method for AI-assisted media generation, according to aspects of the present disclosure.

FIG. 2 illustrates a flowchart for a method for generating storyboard images, according to aspects of the present disclosure.

FIG. 3 illustrates a flowchart for a method for AI-assisted screenplay editing, according to aspects of the present disclosure.

FIG. 4 illustrates a flowchart for a method for video composition, according to aspects of the present disclosure.

FIG. 5 illustrates a block diagram of an AI-Assisted narrative media generation system, according to aspects of the present disclosure.

FIG. 6 illustrates an exemplary user interface for a storyboard view of a media generation system, according to aspects of the present disclosure.

FIG. 7 illustrates a block diagram of system architecture for an AI-assisted media generation system, according to aspects of the present disclosure.

FIG. 8 illustrates a flowchart for a narrative workflow pipeline for AI-assisted media generation, according to aspects of the present disclosure.

FIG. 9 illustrates a hierarchical project data model for a narrative media generation system, according to aspects of the present disclosure.

FIG. 10 illustrates a block diagram of a project-aware AI assistant architecture, according to aspects of the present disclosure.

FIG. 11 depicts a user interface for creating a new shot within a storyboard editor, according to aspects of the present disclosure.

FIG. 12 depicts a user interface for a story development page with a story types selection dropdown menu, according to aspects of the present disclosure.

FIG. 13 depicts a user interface element displaying a tooltip with examples of B Stories, according to aspects of the present disclosure.

FIG. 14 depicts a user interface for a beats editor page within a narrative media generation application, according to aspects of the present disclosure.

FIG. 15 depicts a user interface for an AI chat feature within a filmmaking application, according to aspects of the present disclosure.

FIG. 16 depicts a user interface wireframe for a script editor page, according to aspects of the present disclosure.

FIG. 17 depicts a user interface for a storyboard editor page, according to aspects of the present disclosure.

FIG. 18 depicts a user interface for a project management homepage, according to aspects of the present disclosure.

FIG. 19 depicts a user interface for a storyboard editor page with an integrated video editing timeline, according to aspects of the present disclosure.

FIG. 20 depicts a user interface for a film template plot page, according to aspects of the present disclosure.

FIG. 21 depicts a user interface for a film character page, according to aspects of the present disclosure.

FIG. 22 depicts a user interface for a film acts page, according to aspects of the present disclosure.

FIG. 23 depicts a user interface for a film beats page, according to aspects of the present disclosure.

FIG. 24 depicts a user interface for customizable beat templates, according to aspects of the present disclosure.

FIG. 25 depicts a user interface for a script editor page, according to aspects of the present disclosure.

FIG. 26 depicts a user interface for a script page with a storyboard taskpane, according to aspects of the present disclosure.

FIG. 27 depicts a user interface for transitioning from a script page to storyboards with an auto-generated prompt, according to aspects of the present disclosure.

FIG. 28 depicts a user interface for a storyboard page, according to aspects of the present disclosure.

FIG. 29 depicts a user interface showing a non-linear editing video editor component on a storyboard page, according to aspects of the present disclosure.

FIG. 30 illustrates a flowchart for a method for converting a novel manuscript into a film project using an AI chat interface, according to aspects of the present disclosure.

FIG. 31 illustrates a flowchart for a method for character voice synthesis and rehearsal mode, according to aspects of the present disclosure.

FIG. 32 illustrates a flowchart for a method for multi-model generation with preference tracking and adaptive ordering, according to aspects of the present disclosure.

FIG. 33 illustrates a flowchart for a method for aggregating reference images into an API payload for image generation, according to aspects of the present disclosure.

FIG. 34 depicts a user interface showing use of a character's first name in an image prompt, according to aspects of the present disclosure.

FIG. 35 depicts a custom-defined list of universal archetype patterns, according to aspects of the present disclosure.

FIG. 36 depicts a list of character archetypes with definitions, according to aspects of the present disclosure.

FIG. 37 depicts a list of character arcs with definitions, according to aspects of the present disclosure.

FIG. 38 depicts a user interface for rewriting a scene with AI and user instruction, according to aspects of the present disclosure.

FIG. 39 depicts a user interface for rewriting a scene with an optional text prompt and beat selection, according to aspects of the present disclosure.

FIG. 40 depicts a user interface showing a generate scene button inline on a script page, according to aspects of the present disclosure.

### DETAILED DESCRIPTION

The present disclosure relates to systems and methods for AI-assisted media generation. A computer-implemented method for AI-assisted media generation may enable users to develop media projects from initial concepts through completed video compositions using integrated generative artificial intelligence capabilities. The AI-assisted media generation method or system can be an AI-assisted narrative media generation method or system.

In some embodiments, the AI-assisted media generation method provides a structured workflow that guides users through multiple stages of creative development. The workflow begins with receiving an initial narrative concept from a user and progresses through story development, character creation, structural organization, screenplay writing, visual storyboarding, and video composition. At each stage, the method can leverage external generative AI models to assist users in generating and refining creative content.

The AI-assisted media generation method can address challenges faced by creators who seek to produce narrative media content with limited resources. By integrating generative AI capabilities across multiple modalities including text, image, audio, and video, the method enables users to progress from an idea to a composed media file within a unified application environment. The method can reduce barriers to entry for narrative media production by providing AI-assisted tools that augment human creativity rather than replace human creative decision-making.

In some embodiments, the method maintains contextual awareness across all stages of the creative workflow. As users develop plot elements, character profiles, and structural components, the method includes storing and organizing narrative information in a manner that enables subsequent AI-assisted generation operations to incorporate relevant context. The contextual awareness can promote consistency across generated content and reduce the need for users to repeatedly specify narrative details when generating new content.

The AI-assisted media generation method may also support multiple media formats including feature films, television series, short films, microdramas, and advertisements. The method can provide format-specific templates and structural frameworks that guide users through the development process appropriate for each media type. The method can support multilingual workflows and may enable deployment across web, mobile, and television interfaces.

The method includes integrating with external generative AI services through application programming interfaces. The architecture may be model-agnostic, enabling substitution or addition of generative models without requiring changes to the workflow structure. In some embodiments, the method includes transmitting prompts to multiple generative models and presenting users with multiple generated options for selection, which can enable users to choose outputs that align with creative preferences.

In some embodiments, the system maintains user privacy by storing user inputs, generated content, and project metadata in secure databases that ensure data integrity and confidentiality. The narrative projects created by users may be maintained as private to each user account, and users may not be required to disclose that AI-assisted tools were used in the creation of their narrative media content. The privacy features may enable users to present their completed works without attribution to the AI-assisted generation capabilities of the system, enabling users to maintain full creative ownership and control over how their projects are represented to collaborators, stakeholders, and audiences.

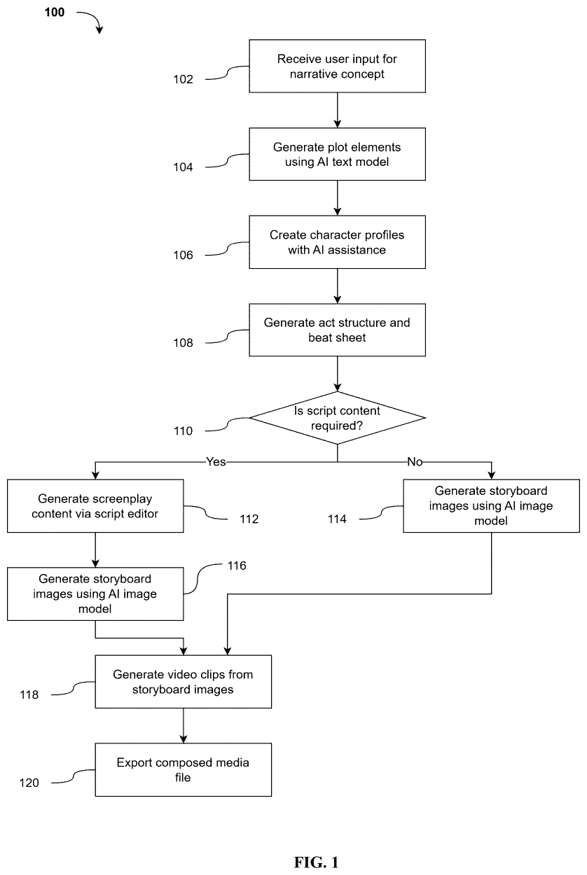

Referring to FIG. 1, a method 100 for AI-assisted media generation is illustrated. The method 100 can be performed by a processor executing instructions stored in a memory. The method 100 can enable users to develop narrative media projects from initial concepts through completed video compositions using integrated generative artificial intelligence capabilities.

The method 100 begins at a step 102 of receiving user input for a narrative concept. At step 102, the processor may receive, by the processor, user input defining a narrative concept for a media project. The user input may include an initial idea, a title, a genre selection, a theme, or other foundational narrative information that establishes the creative direction for the media project. In some embodiments, the user input may be received through a story development interface that presents structured input fields for capturing narrative concept information.

The method 100 proceeds to a step 104 of generating plot elements using an AI text model. At step 104, the processor may construct a prompt based on the user input received at step 102. The processor may transmit the prompt to an external generative AI model via an application programming interface. In some embodiments, the external generative AI model may comprise a large language model for generating text content. The processor may receive generated content from the external generative AI model, where the generated content may comprise text content including plot metadata such as a logline, themes, story types, genres, tone designations, audience designations, settings, and B-story information.

The method 100 continues to a step 106 of creating character profiles. At step 106, the processor may maintain a narrative state model storing structured narrative elements including plot metadata generated at step 104 and character profile data. The processor may construct prompts incorporating the plot metadata from the narrative state model to generate character profiles. The character profile data may include character names, character roles, character arcs, character descriptions, personality traits, archetypes, wants, needs, lies, and ghost information. The processor may receive generated content from the large language model and may integrate the generated content into the narrative state model for display in a user interface.

As further shown in FIG. 1, the method 100 proceeds to a step 108 of generating act structure and beat sheet. At step 108, the processor may construct prompts based on the narrative state model, which now stores plot metadata and character profile data, to generate structural elements for the narrative. The act structure may define the organizational framework for the narrative, such as a three-act structure for feature films or a teaser and four-act structure for television episodes. The beat sheet may define narrative progression points within the media project. The processor may transmit prompts to the large language model and may receive generated content comprising act definitions and beat entries. The narrative state model may store scene information associated with the media project based on the generated act structure and beat sheet.

The method 100 continues to a step 110 where the processor determines if script content is required. At step 110, the method 100 may branch based on whether the user desires to generate screenplay content or proceed directly to storyboard generation. In some embodiments, the determination may be based on user selection or project configuration settings stored in the narrative state model.

As shown in FIG. 1, if script content is required at step 110, the method 100 proceeds to a step 112 of generating screenplay content. At step 112, the processor may construct prompts incorporating narrative context from the narrative state model, including plot metadata, character profile data, and scene information. The processor may transmit the prompts to the large language model via the application programming interface and may receive generated content comprising screenplay text including scene headings, action descriptions, character dialogue, and transitions. The processor may integrate the generated screenplay content into the narrative state model.

Following step 112, the method 100 proceeds to a step 116 of generating storyboard images. At step 116, the processor may construct prompts based on the screenplay content and narrative context from the narrative state model. The processor may transmit the prompts to an external generative AI model comprising an image generation model for generating image content. The processor may receive generated content comprising storyboard images and may integrate the generated storyboard images into the narrative state model for display in a storyboard editor interface.

If script content is not required at step 110, the method 100 proceeds to a step 114 of generating storyboard images. At step 114, the processor may construct prompts based on the narrative state model without requiring screenplay content. The processor may transmit the prompts to the image generation model and may receive generated content comprising image content for storyboard frames. The generated storyboard images may be integrated into the narrative state model.

As further shown in FIG. 1, both paths from steps 114 and 116 converge at a step 118 of generating video clips. At step 118, the processor may construct prompts incorporating storyboard images and narrative context from the narrative state model. The processor may transmit the prompts to an external generative AI model comprising a video generation model for generating video content. In some embodiments, the processor may also transmit prompts to an audio generation model for generating audio content including voice, sound effects, and music. The processor may receive generated content comprising video content and audio content and may integrate the generated media into the narrative state model.

The method 100 concludes at a step 120 of exporting the composed media file. At step 120, the processor may arrange the generated video clips, audio content, and other media assets into a composed sequence. The processor may export the composed media file in a video format such as mp4. The method 100 may thereby enable users to progress from an initial narrative concept through a completed video composition using the integrated generative AI capabilities across text, image, audio, and video modalities.

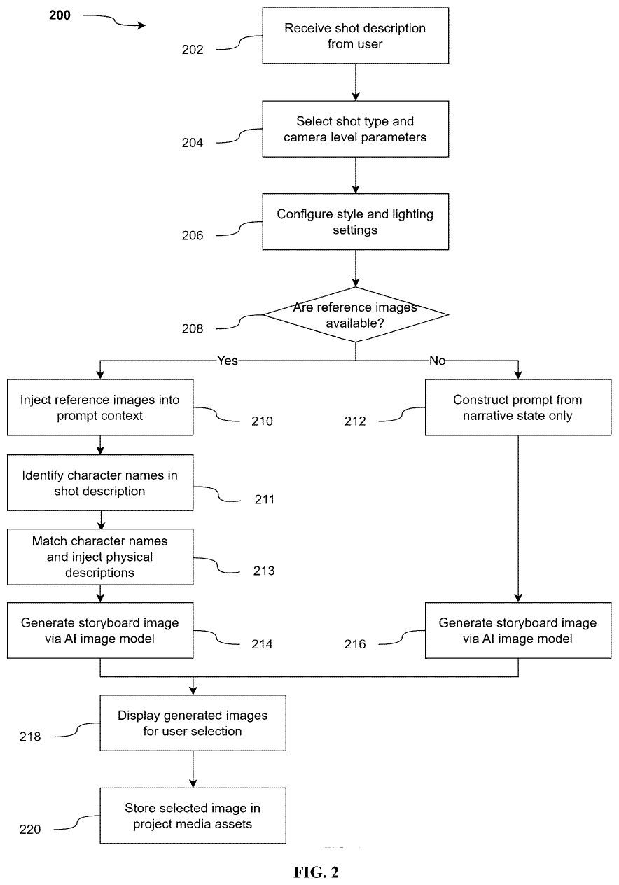

Referring to FIG. 2, a method 200 for generating storyboard images is illustrated. The method 200 may be performed by a processor executing instructions stored in a non-transitory computer-readable medium. The instructions, when executed by the processor, may cause the processor to perform operations for generating storyboard images within the AI-assisted media generation workflow described with reference to FIG. 1.

The method 200 begins at a step 202 of receiving a shot description. At step 202, the processor may display a storyboard editor interface presenting a sequence of storyboard frames associated with scenes of a narrative project. The storyboard editor interface may present existing storyboard frames and may provide controls for creating new storyboard frames. The processor may receive a shot description for a new storyboard frame, where the shot description may comprise text input from a user describing the visual content desired for the storyboard image.

As shown in FIG. 2, the method 200 proceeds to a step 204 of selecting shot parameters. At step 204, the processor may receive shot parameters for the new storyboard frame. The shot parameters may include a shot type selection and a camera level selection. The shot type selection may specify the framing of subjects within the storyboard image, such as extreme closeup, closeup, medium closeup, medium shot, cowboy shot, medium full shot, or full shot. The camera level selection may specify the vertical angle of the camera relative to the subject, such as eye level, low angle, high angle, or bird's eye view. In some embodiments, the storyboard editor interface may present dropdown menus or selection controls for receiving the shot type selection and the camera level selection from the user.

The method 200 continues to a step 206 of configuring style and lighting settings. At step 206, the processor may receive additional style configuration parameters for the storyboard image. The storyboard editor interface may include a cinematic style preset option that applies filmmaker-tuned prompt parameters for generating images with cinematic visual qualities. In some embodiments, the storyboard editor interface may include color palette selection controls for specifying the color scheme of generated storyboard images. The storyboard editor interface may also include lighting selection controls for specifying the lighting characteristics of generated storyboard images. The style settings may further include aspect ratio selections such as 16:9 for widescreen formats.

The system may abstract prompt engineering complexity from users by automatically constructing optimized prompts based on user selections and narrative context. Users may specify desired content using industry terminology familiar to filmmakers, such as shot type names, camera level designations, and style descriptions, without requiring users to master prompt engineering techniques or specialized syntax used by underlying generative models. The prompt constructor may translate user selections into model-specific prompt formats that have been refined through testing to produce high-quality results for each integrated generative model. The abstraction of prompt engineering may enable users to interact with the system as if describing desired content to a skilled artist, using natural language and professional terminology to communicate creative intent while the system handles the technical details of prompt construction and model communication.

In some cases, the prompt constructor may optimize prompt construction based on the context window capacity of the target generative model. Different generative AI models may support different context window sizes, ranging from smaller token limits to expanded context windows supporting 128,000 tokens or more. The prompt constructor may determine the available context window capacity for the target generative model and may fill the context window with narrative context retrieved from the narrative state model to maximize the relevance and coherence of generated content. When constructing prompts for models with larger context windows, the prompt constructor may include additional narrative context such as complete character profiles for all characters in the project, full beat sheet content, preceding screenplay scenes, and extended plot metadata. When constructing prompts for models with smaller context windows, the prompt constructor may prioritize the most immediately relevant narrative context and may truncate or summarize less critical context elements to fit within the available capacity. The context window optimization may enable the system to leverage the full capabilities of advanced generative models while maintaining compatibility with models having more limited context capacity.

The context window optimization may include algorithmic truncation and prioritization of the injected payload based on the target model's context window capacity. When the aggregate size of the narrative context retrieved from the narrative state model exceeds the available context window capacity of the target generative model, the prompt constructor may apply prioritization rules to determine which narrative elements to include and which to truncate or summarize. The prioritization rules may assign higher priority to narrative elements most immediately relevant to the current generation task, such as physical descriptions of characters appearing in the current shot, scene context from the immediately surrounding screenplay content, and style references from recent storyboard frames in the same scene. Lower priority may be assigned to more distant narrative context such as plot metadata, character backstory elements, or beat sheet content that provides general narrative direction but is less critical for the specific visual or textual generation task. The algorithmic truncation may prevent token-limit errors that would otherwise cause generation failures or data truncation by the external generative model, while maximizing the utilization of available context capacity to enhance the coherence and consistency of generated content.

As further shown in FIG. 2, the method 200 proceeds to a step 208 where the processor determines if reference images are available. At step 208, the method 200 may branch based on whether reference images associated with characters, locations, or props are available in the narrative state model associated with the narrative project. The narrative context may comprise at least one of character profile data including a physical description, scene context from a screenplay, and reference images associated with characters, locations, or props. In some embodiments, users may have uploaded or generated reference images on character pages, location pages, or prop pages within the application.

In some cases, the character reference images may include images depicting characters wearing different costumes and outfits that appear throughout the narrative project. Users may upload or generate reference images showing each character in their main costumes, wardrobe changes, and outfit variations that occur across different scenes or acts within the media project. The costume and outfit reference images may be stored in the narrative state model in association with the corresponding character profile data and may include metadata identifying the scenes or narrative contexts in which each costume appears. When generating storyboard images, the processor may retrieve the appropriate costume reference image based on the scene context, enabling the image generation model to depict the character wearing the correct costume for the corresponding point in the narrative. The costume reference functionality may reduce the need for users to describe character wardrobe in each shot description and may promote visual consistency in character appearance across storyboard frames depicting the same narrative timeframe.

If reference images are available at step 208, the method 200 proceeds to a step 210 of injecting reference images. At step 210, the processor may retrieve reference images from the narrative state model and may incorporate the reference images into the prompt construction process. The reference images may include character reference images depicting character appearances, location reference images depicting scene settings, and prop reference images depicting objects that appear within scenes. In some embodiments, the processor may inject one or more previous images from the same scene as style references to promote visual consistency across storyboard frames within a scene.

In some cases, the system may utilize a multi-image reference injection method to enforce character consistency. Instead of providing a single text prompt to the AI model, the system's Prompt Construction Layer may dynamically aggregate and inject a payload containing multiple visual anchors. For example, the system may simultaneously inject a character's portrait headshot, an image of the character wearing a specific scene-appropriate costume, and the immediately preceding storyboard frame as style references. Providing this multi-image array heavily constrains the visual generation model's latent space, resulting in highly consistent character depictions across sequential movie scenes. The multi-image reference injection method may retrieve character reference images from the Characters node of the narrative state model, costume reference images associated with the current scene context, and the most recent storyboard frame from the same scene. The aggregated visual references may be transmitted to the image generation model API along with the text prompt, enabling the model to maintain visual consistency across multiple generated storyboard images without requiring the user to manually specify character attributes in each generation request.

As shown in FIG. 2, following step 210, the method 200 may proceed to a step 211 of identifying character names within the shot description. At step 211, the processor may parse the shot description text to identify character names that appear within the description. The processor may compare text tokens within the shot description against character names stored in the narrative state model to identify references to characters defined within the narrative project. The character name identification may utilize fuzzy matching techniques to accommodate variations in character name references, such as nicknames, abbreviated names, or partial name matches.

The character name identification at step 211 may utilize Large Language Model (LLM) based Named Entity Recognition (NER) via Natural Language Processing (NLP) to accommodate variations in how users reference characters within shot descriptions and other user input. In some embodiments, the primary implementation transmits the prompt text to an LLM, which uses probabilistic semantic analysis to decipher and extract the intended character entity, and then queries the narrative state model to retrieve the corresponding physical description payload. Because user prompts often contain nicknames, abbreviated names, or contextual aliases, the LLM-based approach provides more robust matching than traditional string-matching algorithms. While traditional mathematical distance algorithms such as Levenshtein distance calculations that measure the minimum number of single-character edits required to transform one string into another or Jaro-Winkler similarity calculations that account for character transpositions and assign higher similarity scores to strings that match from the beginning may be utilized as secondary or fallback embodiments, the primary and preferred implementation utilizes the LLM to perform semantic Named Entity Recognition and probability-based token classification. Because the primary implementation utilizes an LLM, the similarity threshold operates as a probability confidence score rather than a strict mathematical string-distance integer. In practice, the system evaluates the LLM's output probability, such as an 80% or 0.80 confidence threshold, to determine if a text token in the prompt is a positive match for a character profile stored in the narrative state model. The thresholds may be automatically and dynamically adjusted by the system based on the specific characteristics and complexity of the user's media project. For example, the system may apply a lower, more permissive confidence threshold for simple projects with very few characters, and may automatically apply a higher, stricter threshold for complex projects with distinctly named characters or a large ensemble cast to prevent false-positive matches. The LLM-based Named Entity Recognition capability enables the system to correctly identify character references even when users employ nicknames, abbreviated names, informal variations, or minor typographical errors in their input.

In some embodiments, the LLM-based Named Entity Recognition may include pronoun resolution capabilities that enable the system to identify character references even when characters are referenced by pronouns rather than by name. When processing shot descriptions or screenplay content, the processor may analyze contextual pronouns such as “he,” “she,” or “they” and resolve the pronouns to corresponding character profile nodes based on the narrative context. For example, when a shot description states “John walks in. He sits down,” the processor may identify that the pronoun “He” refers to the character “John” based on the preceding sentence context, and may retrieve and inject the physical description associated with the “John” character profile into the prompt even though the character name is not explicitly repeated in the portion of the description referencing the seated action. The pronoun resolution capability may utilize the contextual understanding capabilities of the large language model to maintain accurate character-to-description mappings throughout extended narrative sequences where characters are introduced by name and subsequently referenced by pronouns.

The LLM-based Named Entity Recognition and fuzzy matching capabilities may accommodate typographical errors in user input. When a user enters a character name with a typographical error, such as “Russel” when the character profile is stored as “Russell,” the probabilistic matching may still achieve a high confidence score and accurately map the misspelled input back to the correct character profile node in the narrative state model. The system may evaluate the semantic similarity and contextual likelihood of the input token representing the intended character, enabling successful character identification and physical description injection even when the user input contains missing letters, transposed characters, or other common typographical variations. The tolerance for typographical errors may reduce friction in the creative workflow by enabling users to type quickly without requiring precise spelling of character names in every shot description or generation prompt.

The method 200 may proceed to a step 213 of matching character names to character profiles and injecting physical descriptions into the prompt. At step 213, for each character name identified at step 211, the processor may retrieve the corresponding character profile data from the narrative state model. The processor may extract the physical description associated with each matched character profile and may inject the physical description into the prompt being constructed for the image generation model. The injection of physical descriptions may enable the image generation model to depict characters with visual attributes consistent with the character definitions established in the narrative project. When multiple character names are identified within a single shot description, the processor may retrieve and inject physical descriptions for all matched characters, organizing the injected descriptions in a manner that enables the image generation model to distinguish between the multiple characters within the generated storyboard image.

In some cases, the processor may inject one or more previous images from the same scene as style references to promote visual consistency across storyboard frames within a scene. The previous shot injection may implement a Sequential Frame-Referencing Algorithm that executes an automated look-back query during prompt construction. When generating a new shot, such as Scene 2 Shot 2, the processor traverses the hierarchical data tree to retrieve the immediately preceding chronological frame within the same scene, such as Scene 2 Shot 1. This preceding frame is injected directly into the external image generation model's API as a baseline style reference. By passing prior generated outputs as input ingredients for the next generation sequence, the system mathematically restricts the generative model's latent space, resulting in highly consistent temporal continuity across the scene. The injection of previous shots as style references may enhance consistency across storyboard frames by providing the image generation model with visual context that extends beyond textual descriptions, maintaining environmental lighting, color grading, and temporal continuity. In some embodiments, the number of previous shot images injected into the prompt may be configurable based on the capabilities of the image generation model API, with some model APIs supporting upload of multiple reference images while others may support only a single reference image.

With continued reference to FIG. 2, following step 210, the method 200 proceeds to a step 214 of generating a storyboard image. At step 214, the processor may construct a prompt incorporating the shot description, the shot parameters, the style settings, the reference images, and narrative context retrieved from the narrative state model associated with the narrative project. The processor may transmit the prompt to an image generation model via an application programming interface. The processor may receive a generated storyboard image from the image generation model.

If reference images are not available at step 208, the method 200 proceeds to a step 212 of constructing a prompt. At step 212, the processor may construct a prompt incorporating the shot description, the shot parameters, the style settings, and narrative context from the narrative state model without reference images. The prompt may incorporate character profile data including physical descriptions retrieved from the narrative state model based on character names appearing in the shot description. The prompt may also incorporate scene context from a screenplay stored in the narrative state model.

Following step 212, the method 200 proceeds to a step 216 of generating a storyboard image. At step 216, the processor may transmit the prompt constructed at step 212 to the image generation model via the application programming interface. In some embodiments, the processor may transmit the prompt to a plurality of image generation models via respective application programming interfaces. The processor may receive generated storyboard images from the image generation models.

As further shown in FIG. 2, both paths from steps 214 and 216 converge at a step 218 of displaying images for selection. At step 218, the processor may display the generated storyboard image within the storyboard editor interface for user selection. In some embodiments, where the prompt was transmitted to a plurality of image generation models, the processor may display a plurality of generated storyboard images for user selection. The display of multiple generated options may enable users to select storyboard images that align with creative preferences from among outputs generated by different image generation models.

The method 200 concludes at a step 220 of storing the selected image. At step 220, the processor may receive a user selection indicating which generated storyboard image to retain for the narrative project. The processor may store the selected storyboard image in the narrative state model in association with the corresponding scene and shot within the narrative project structure. The stored storyboard image may be available for subsequent operations including video generation as described with reference to step 118 of the method 100.

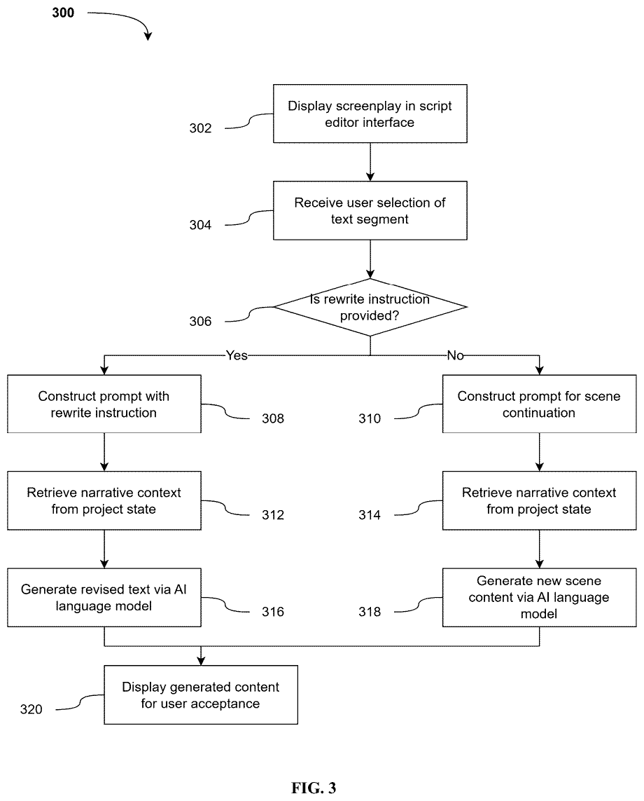

Referring to FIG. 3, a method 300 for AI-assisted screenplay editing is illustrated. The method 300 may be performed by a processor executing instructions stored in a memory. The method 300 may enable users to edit and generate screenplay content within a script editor interface using AI-assisted text generation capabilities that incorporate narrative context from the narrative state model described with reference to FIG. 1.

The method 300 begins at a step 302 of displaying screenplay in a script editor. At step 302, the processor may display screenplay content within a script editor interface. The script editor interface may provide screenplay formatting styles and keyboard shortcuts consistent with industry-standard screenwriting software. In some embodiments, the script editor interface may provide formatting options for scene headings, action descriptions, character names, dialogue, parentheticals, and transitions. The script editor interface may display line numbering along a margin of the screenplay editing workspace. In some embodiments, the method 300 may include a step of automatically classifying scenes within uploaded screenplay content for organized access and navigation. The automatic scene classification may enable users to navigate between scenes within the screenplay using a scene list or scene selection controls.

In some cases, the script editor interface may support upload of screenplay content in various text formats used in the screenwriting industry. The supported upload formats may include Final Draft format files with the .FDX file extension, which is a standard format used by professional screenwriting software. The supported upload formats may also include Fountain format files with the .fountain file extension, which is a plain text markup format for screenwriting that enables screenplay formatting using simple text conventions. The script editor interface may parse uploaded screenplay files and convert the content into the internal representation used by the narrative state model, preserving scene headings, action descriptions, character names, dialogue, parentheticals, and transitions according to the formatting conventions of the uploaded file format. The file format support may enable users to import existing screenplay content developed using other screenwriting applications, facilitating integration of the AI-assisted narrative media generation capabilities with established screenwriting workflows.

As shown in FIG. 3, the method 300 proceeds to a step 304 of receiving user text selection. At step 304, the processor may receive a user selection of text within the screenplay content. The user selection may comprise a highlighted portion of text such as a line of dialogue, an action description, or an entire scene. In some embodiments, the script editor interface may display selection controls adjacent to the selected text for initiating AI-assisted editing operations. The script editor interface may be configured to receive a user selection of text within the screenplay content and a rewrite instruction.

The method 300 continues to a step 306 where the processor determines if a rewrite instruction is provided. At step 306, the method 300 may branch based on whether the user has provided a rewrite instruction for the selected text or whether the user desires to generate new content at a cursor position. In some embodiments, the script editor interface may display a rewrite button that, when activated, prompts the user to enter a rewrite instruction in natural language. In some embodiments, the script editor interface may be configured to display a generate button adjacent to a cursor position within the screenplay content for initiating continuation operations.

As further shown in FIG. 3, if a rewrite instruction is provided at step 306, the method 300 proceeds to a step 308 of constructing a prompt with instruction. At step 308, the processor may be configured to construct a prompt incorporating the selected text, the rewrite instruction, and narrative context from the narrative state model for transmission to a large language model. The rewrite instruction may comprise natural language feedback such as “make this longer and funnier” or director notes specifying desired changes to the selected text. The prompt may incorporate the selected text as the content to be revised and the rewrite instruction as guidance for the revision.

Following step 308, the method 300 proceeds to a step 312 of retrieving context. At step 312, the processor may retrieve narrative context from the narrative state model associated with the narrative project. The narrative context may include plot metadata, character profile data, act structure data, beat sheet data, and surrounding screenplay content. The retrieved context may enable the large language model to generate revised text that maintains consistency with established narrative elements and character voices.

In some cases, the script editor interface may include a slugline-based image generation feature that enables users to generate storyboard images directly from scene headings within the screenplay. A scene heading, also referred to as a slugline, typically specifies the location and time of day for a scene using industry-standard formatting conventions such as INT. or EXT. followed by the location name and time designation. The script editor interface may display a create image control adjacent to scene heading lines within the screenplay editing workspace. Activation of the create image control may trigger an Automated Slugline-to-Image Orchestration process, where the processor parses the text, automatically retrieves the associated location and time-of-day metadata, and populates a generation taskpane with the extracted information. The user may then append spatial metadata such as Shot Type and Camera Level selections before the system orchestrates the final prompt. The processor may construct a prompt incorporating the scene heading information, narrative context from the narrative state model including character profiles and plot metadata, and any action descriptions immediately following the scene heading. The processor may transmit the prompt to an image generation model via an application programming interface and may receive a generated storyboard image depicting the scene location and context specified in the slugline. The generated storyboard image may be automatically associated with the corresponding scene in the narrative state model, enabling users to build storyboard sequences directly from screenplay content without requiring separate navigation to the storyboard editor interface. This direct programmatic bridge from a word-processing element to a multi-modal generation pipeline enables transformation of formatted text objects directly into parameterized visual generation requests.

As shown in FIG. 3, following step 312, the method 300 proceeds to a step 316 of generating revised text. At step 316, the processor may transmit the prompt constructed at step 308, incorporating the retrieved context from step 312, to the large language model via an application programming interface. The processor may receive generated content from the large language model comprising revised text that addresses the rewrite instruction while maintaining consistency with the narrative context.

If a rewrite instruction is not provided at step 306, the method 300 proceeds to a step 310 of constructing a continuation prompt. At step 310, activation of the generate button may cause the processor to construct a continuation prompt based on preceding screenplay content and the narrative state model. The continuation prompt may incorporate screenplay content preceding the cursor position as context for generating new content that continues the narrative flow. In some embodiments, the script editor interface may provide an optional text input field for the user to provide additional guidance for the continuation generation.

Following step 310, the method 300 proceeds to a step 314 of retrieving context. At step 314, the processor may retrieve narrative context from the narrative state model, similar to the context retrieval at step 312. The retrieved context may include character profile data, scene information, and beat sheet data that inform the generation of new screenplay content.

As further shown in FIG. 3, following step 314, the method 300 proceeds to a step 318 of generating new content. At step 318, the processor may transmit the continuation prompt constructed at step 310, incorporating the retrieved context from step 314, to the large language model via the application programming interface. The processor may receive generated content from the large language model comprising new screenplay content such as action descriptions, dialogue, or scene continuations.

Both paths from steps 316 and 318 converge at a step 320 of displaying content for acceptance. At step 320, the processor may display the generated content within the script editor interface for user review and acceptance. In some embodiments, the script editor interface may present the generated content in a manner that enables the user to accept, edit, or reject the generated content. The user may accept the generated content to integrate the generated content into the screenplay, or the user may edit the generated content before acceptance to refine the AI-generated text according to creative preferences. The method 300 may thereby enable users to leverage AI-assisted text generation for both rewriting existing screenplay content and generating new screenplay content while maintaining narrative consistency through context-aware prompt construction.

In some embodiments, the script editor interface may be configured to generate screenplay content incrementally rather than generating an entire screenplay in a single operation. The incremental generation approach may enable users to generate partial scenes one at a time, providing users with the option to accept generated content, edit the generated content, and integrate the generated content into the screenplay before proceeding to generate additional content. The incremental approach may enable users to maintain creative ownership of the screenplay by curating and refining AI-generated content throughout the writing process. In some embodiments, the script editor interface may display a generate button that assists users experiencing writer's block by providing AI-generated content when users encounter difficulty progressing with manual writing. Activation of the generate button may cause the processor to generate fresh text and ideas based on the narrative context stored in the narrative state model, enabling users to continue moving forward with screenplay development. The generated content may serve as a starting point that users may easily edit and refine according to creative preferences, enabling users to fill pages with content while maintaining creative control over the final screenplay.

The incremental generation approach reflects a design philosophy that positions AI-assisted tools as augmentation for human creativity rather than replacement of human creative decision-making. Based on research and user feedback, the system recognizes that the vast majority of writers do not desire to have their entire screenplay written for them by an AI system. Instead, the incremental generation approach enables users to generate partial scenes one at a time, providing users with the opportunity to review, accept, edit, or reject each generated portion before proceeding to generate additional content. This approach enables users to maintain creative ownership of their screenplay by curating and refining AI-generated content throughout the writing process, resulting in a final screenplay that reflects the user's creative vision and voice rather than purely AI-generated output. The incremental approach may also reduce wasted generation cycles by enabling users to course-correct the narrative direction after each generated segment rather than generating large amounts of content that may require extensive revision or rejection.

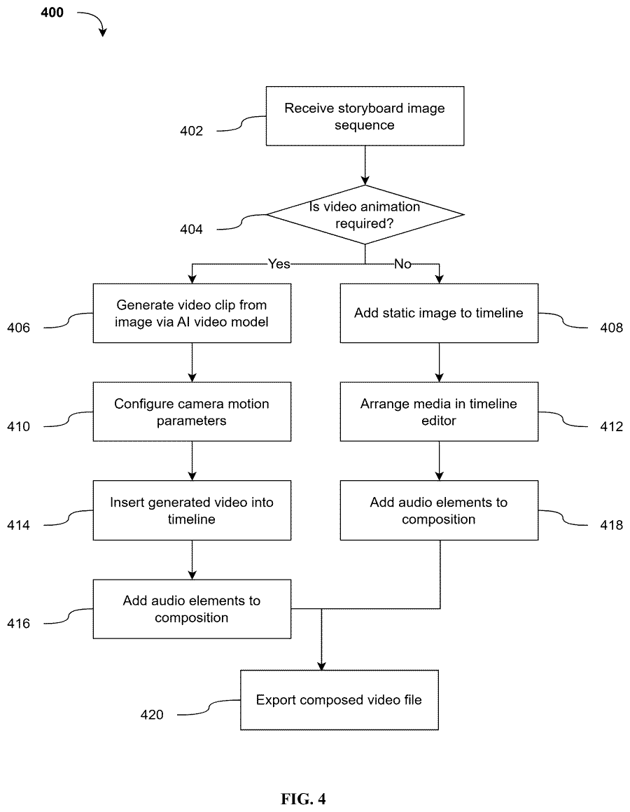

Referring to FIG. 4, a method 400 for video composition is illustrated. The method 400 may be performed by a processor executing instructions stored in a memory. The method 400 may enable users to compose video content from storyboard images and generated media assets within the AI-assisted media generation workflow described with reference to FIG. 1.

The method 400 begins at a step 402 of receiving a storyboard image sequence. At step 402, the processor may receive a sequence of storyboard images associated with scenes of the narrative project. The storyboard images may have been generated using the method 200 described with reference to FIG. 2 or may have been uploaded by the user. The storyboard image sequence may be organized according to the scene and shot structure stored in the narrative state model.

As shown in FIG. 4, the method 400 proceeds to a step 404 where the processor determines if video animation is required. At step 404, the method 400 may branch based on whether the user desires to generate animated video clips from the storyboard images or to arrange static storyboard images in a timeline sequence. In some embodiments, the determination may be based on user selection or project configuration settings. The storyboard editor interface may display inline video playback of previz animation clips within the storyboard frame sequence, enabling users to preview animated content before proceeding to video composition.

If video animation is required at step 404, the method 400 proceeds to a step 406 of generating video clips. At step 406, the processor may be configured to transmit storyboard images to a video generation model via an application programming interface to generate animated video clips. The processor may construct prompts incorporating the storyboard images and narrative context from the narrative state model. The processor may transmit the prompts to the video generation model and may receive generated video clips comprising animated sequences derived from the storyboard images.

In some cases, the method may include a step of visualizing camera movements within the pre-visualization animation. The camera movement visualization may enable users to specify camera motion parameters such as pan, tilt, zoom, dolly, crane, and tracking movements that are incorporated into the generated video clips. The storyboard editor interface may provide camera motion selection controls that enable users to select from predefined camera movement types or to specify custom camera motion paths for each shot. The video generation model may receive the camera motion parameters as part of the prompt and may generate animated video clips that simulate the specified camera movements, enabling users to visualize how the camera will move through the scene during production. The camera movement visualization may enhance the planning of complex shots by enabling users to evaluate camera motion choices before committing to physical camera setups during production. The pre-visualization of camera movements may assist cinematographers and directors in communicating visual intent and in identifying potential challenges associated with planned camera movements.

In some cases, the video generation model may generate animatic video clips of extended duration, such as video clips ranging from forty seconds to sixty seconds in length. The extended duration animatic video clips may enable users to visualize longer continuous sequences within the narrative project, including complete scenes or multi-shot sequences that convey narrative progression across multiple beats. The system may also support generation of photo-realistic CGI scenes using video generation models capable of producing high-fidelity visual content that approaches the quality of computer-generated imagery used in professional film production. The photo-realistic CGI generation capability may enable users to produce pre-visualization content that more closely represents the intended final visual quality of the media project, assisting users in evaluating creative decisions and communicating visual intent to collaborators and stakeholders. The animatic and photo-realistic CGI generation capabilities may be accessible through the storyboard editor interface, enabling users to select the desired output quality and duration parameters when initiating video generation operations.

As further shown in FIG. 4, following step 406, the method 400 proceeds to a step 410 of configuring camera motion. At step 410, the processor may receive camera motion parameters from the user for the animated video clips. The camera motion parameters may specify movement characteristics such as pan, tilt, zoom, or tracking movements to be incorporated into the animated video clips. The processor may be configured to transmit storyboard images to the video generation model via the application programming interface to generate animated video clips incorporating camera motion parameters. The generated animated video clips may incorporate the specified camera motion to create dynamic visual sequences from the static storyboard images.

Following step 410, the method 400 proceeds to a step 414 of inserting video into timeline. At step 414, the processor may insert the generated animated video clips into a timeline editor interface. The timeline editor interface may be configured to receive media assets including storyboard images, video clips, and audio elements. The timeline editor interface may be configured to receive the animated video clips for arrangement in the sequence. The timeline editor interface may provide non-linear editing capabilities for arranging the animated video clips in a temporal sequence corresponding to the narrative structure.

Referring to FIG. 4, following step 414, the method 400 proceeds to a step 416 of adding audio. At step 416, the processor may receive audio elements for integration with the animated video clips. The audio elements may include voice content generated by an audio generation model, sound effects, and music or score content. The processor may arrange the audio elements in the timeline editor interface in synchronization with the animated video clips. The timeline editor interface may provide audio mixing capabilities for adjusting volume levels and timing of audio elements relative to the video content.

If video animation is not required at step 404, the method 400 proceeds to a step 408 of adding static images. At step 408, the processor may add the storyboard images from the storyboard image sequence as static image assets for arrangement in the timeline. The static images may be displayed for specified durations within the composed video sequence.

Following step 408, the method 400 proceeds to a step 412 of arranging media in timeline. At step 412, the processor may arrange the static storyboard images in the timeline editor interface. The timeline editor interface may be configured to receive media assets including storyboard images, video clips, and audio elements. The processor may be configured to arrange the media assets in a sequence according to the scene and shot structure of the narrative project. The timeline editor interface may provide editing tools for adjusting the duration and ordering of static images within the sequence.

As further shown in FIG. 4, following step 412, the method 400 proceeds to a step 418 of adding audio. At step 418, the processor may receive audio elements for integration with the static image sequence, similar to the audio addition at step 416. The audio elements may include voice content, sound effects, and music content. The processor may arrange the audio elements in the timeline editor interface in synchronization with the static image sequence.

Both paths from steps 416 and 418 converge at a step 420 of exporting the composed video file. At step 420, the processor may be configured to arrange the media assets in a sequence and export a composed video file. The processor may render the arranged video clips or static images together with the audio elements into a composed video file. The composed video file may be exported in a video format such as mp4. The method 400 may thereby enable users to compose video content from storyboard images using either animated video generation or static image arrangement, with integrated audio elements, to produce a completed media file for the narrative project.

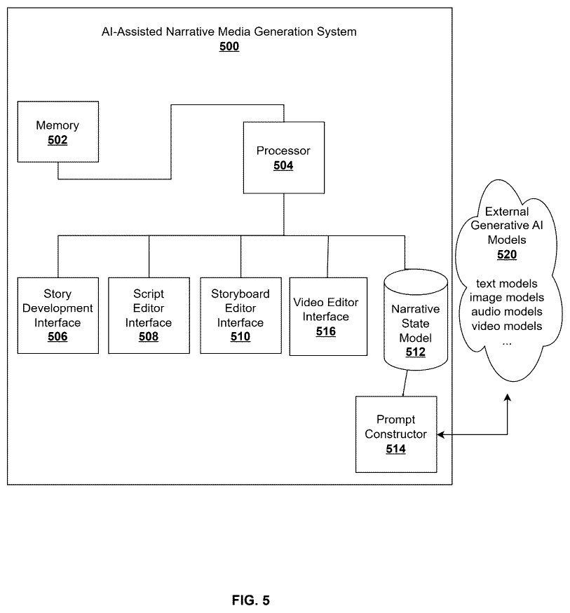

Referring to FIG. 5, a block diagram of an AI-assisted narrative media generation system 500 is illustrated. The AI-assisted narrative media generation system 500 may implement the methods and workflows described herein for AI-assisted media generation. The AI-assisted narrative media generation system 500 comprises a memory 502 and a processor 504 coupled to the memory 502. The Processor 504 is configured to execute instructions stored in the memory 502 to perform the operations described herein.

As shown in FIG. 5, the processor 504 is configured to provide a story development interface 506, a script editor interface 508, a storyboard editor interface 510, and a Video Editor Interface 516. The story development interface 506 is configured to receive user input defining narrative elements including at least one of plot metadata, character profiles, act structures, and beat sheet entries. The script editor interface 508 is configured to display screenplay content and receive user selections for AI-assisted text generation. The storyboard editor interface 510 is configured to receive shot parameters including shot type and camera level selections for AI-assisted image generation. The Video Editor Interface 516 is configured to receive media assets including storyboard images, video clips, and audio elements, and to arrange the media assets in a sequence for video composition and export

The AI-assisted narrative media generation system 500 further comprises a narrative state model 512 that persists narrative elements across the story development interface 506, the script editor interface 508, the storyboard editor interface 510, and the Video Editor Interface 516. The narrative state model 512 stores structured narrative elements including plot metadata, character profile data, and scene information associated with the media project. The processor 504 is connected to the narrative state model 512 to maintain and retrieve narrative context throughout the creative workflow.

As further shown in FIG. 5, the AI-assisted narrative media generation system 500 comprises a prompt constructor 514 that constructs prompts for external generative AI models based on the narrative state model 512 and user selections. A dashed connection extends from the narrative state model 512 to the prompt constructor 514, indicating that the prompt constructor 514 retrieves narrative context from the narrative state model 512 when constructing prompts. The prompt constructor 514 communicates bidirectionally with external generative AI models 520, represented as a cloud shape indicating external services positioned outside the system boundary. The bidirectional connection indicates that the prompt constructor 514 transmits prompts to the external generative AI models 520 via application programming interfaces and receives generated content in response. The processor 504 integrates the generated content from the external generative AI models 520 into the narrative state model 512 for display in the user interfaces.

With continued reference to FIG. 5, the External Generative AI Models 520 may comprise a plurality of external generative AI models accessible via respective application programming interfaces. The plurality of external generative AI models may include multiple text generation models from different providers, multiple image generation models from different providers, multiple audio generation models from different providers, and multiple video generation models from different providers. The Prompt Constructor 514 may be configured to transmit prompts to the plurality of external generative AI models via the respective application programming interfaces and to receive a plurality of generated content options in response. The plurality of generated content options may be presented to the user for selection within the user interfaces, enabling the user to choose the generated content that best aligns with creative preferences. The cloud shape representation of the External Generative AI Models 520 in FIG. 5 indicates that the plurality of models are external services positioned outside the system boundary of the AI-Assisted Narrative Media Generation System 500.

In some cases, the character profile data may include extensive lists of antagonist and villain archetype traits that enable development of deeper, more complex antagonist characters. The antagonist archetype traits may include classifications beyond simple villain designations, encompassing nuanced character motivations, psychological profiles, and behavioral patterns that inform antagonist development. The system may provide predefined antagonist archetype options that users may select when creating character profiles for antagonist and villain characters, with each archetype option including associated traits, typical motivations, and relationship dynamics with protagonist characters. The extensive antagonist archetype support may address limitations in character depth by enabling users to develop multi-dimensional antagonist characters with complex motivations rather than one-dimensional villain characterizations. The antagonist archetype traits may be incorporated into prompts for AI-assisted content generation, enabling the generated content to reflect the nuanced characterization established in the antagonist character profiles. The antagonist archetype functionality may extend to secondary antagonist characters, enabling users to develop supporting characters with depth and complexity that reinforces the thematic content of the narrative.

In some cases, the system may support enterprise customization capabilities that enable production studios to build custom fine-tuned AI applications using proprietary content. Well-resourced studios may utilize the system architecture to train custom AI models on their proprietary intellectual property, including studio-owned scripts, character libraries, visual style guides, and production archives. The enterprise customization may enable studios to develop AI-assisted generation capabilities that reflect the distinctive creative voice, visual style, and narrative conventions associated with the studio's brand and production history. The system may provide interfaces for uploading proprietary training materials and for configuring fine-tuning parameters that customize the behavior of integrated generative models. The enterprise customization capabilities may enable studios to maintain competitive differentiation by developing AI-assisted tools that generate content consistent with studio-specific quality standards and creative guidelines.

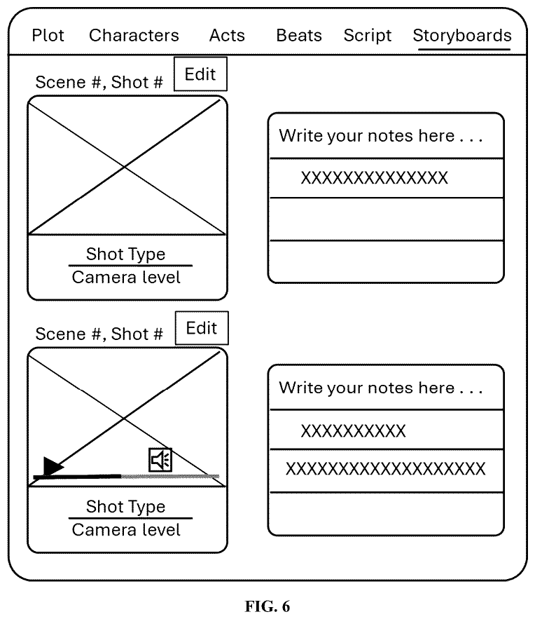

Referring to FIG. 6, an exemplary user interface for a storyboard view of the media generation system is illustrated. The storyboard view may be displayed by a system for AI-assisted media generation comprising a memory storing instructions and a processor coupled to the memory and configured to execute the instructions. The processor may be configured to provide a storyboard editor interface configured to receive shot parameters including shot type and camera level selections for AI-assisted image generation, as described previously with reference to the method 200 of FIG. 2.

As shown in FIG. 6, the storyboard editor interface may include a navigation area presenting navigation tabs for accessing different sections of the narrative project. The navigation tabs may include a Plot tab for accessing the plot development interface, a Characters tab for accessing character profile management, an Acts tab for accessing act structure organization, a Beats tab for accessing beat sheet editing, a Script tab for accessing the script editor interface, and a Storyboards tab for accessing the storyboard editor interface. The navigation tabs may enable users to transition between different stages of the narrative media generation workflow while maintaining access to the narrative state model that persists narrative elements across the interfaces.

The storyboard editor interface may present a grid layout displaying storyboard panels arranged in a visual sequence corresponding to the scene and shot structure of the narrative project. Each storyboard panel may include a placeholder image area configured to display a generated storyboard image or to indicate an empty frame awaiting image generation. The placeholder image areas may be sized according to an aspect ratio selection such as 16:9 for widescreen formats.

As further shown in FIG. 6, each storyboard panel may include fields for shot type and camera level parameters. The shot type field may present a dropdown menu or selection control for receiving a shot type selection from the user. The shot type selection may specify the framing of subjects within the storyboard image, such as extreme closeup, closeup, medium closeup, medium shot, cowboy shot, medium full shot, or full shot. The camera level field may present a dropdown menu or selection control for receiving a camera level selection from the user. The camera level selection may specify the vertical angle of the camera relative to the subject. Each storyboard panel may also include a scene number field and a shot number field identifying the organizational position of the storyboard frame within the narrative structure. The scene number field may display the scene to which the shot belongs, and the shot number field may display the sequential position of the shot within that scene. Each storyboard panel may further include a camera motion field for specifying camera movement parameters such as pan, tilt, zoom, dolly, crane, and tracking movements. Each storyboard panel may also include a notes field where users can type annotations, director notes, or production instructions associated with each storyboard frame.

In some embodiments, the storyboard editor interface may display cinematography diagram overlays showing shot type and camera level visual representations on storyboard frames. The cinematography diagram overlays may present a silhouette figure with horizontal lines indicating the framing boundaries for different shot types, enabling users to visualize the relationship between shot type selections and the resulting image composition. The visual representations may assist users in understanding cinematography terminology and selecting appropriate shot parameters for each storyboard frame.

The storyboard editor interface may present a vertically scrolling endless landscape canvas displaying storyboard frames in a continuous visual layout. The vertically scrolling canvas may enable users to view and navigate through a sequence of storyboard frames without pagination boundaries. The endless landscape layout may present storyboard frames in a horizontal arrangement within the vertically scrolling canvas, enabling users to view multiple frames simultaneously while scrolling through the complete storyboard sequence for the narrative project. In some embodiments, the storyboard editor interface may display inline video playback of previz animation clips within the storyboard frames, enabling users to preview animated content directly within the continuous visual layout.

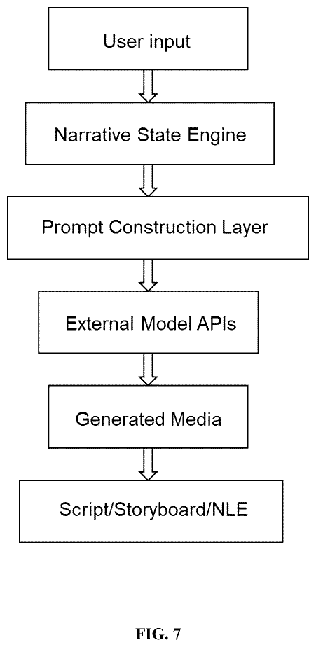

Referring to FIG. 7, a block diagram of system architecture for the AI-assisted media generation system is illustrated. The system architecture may comprise multiple interconnected layers that coordinate user interaction, narrative state management, prompt construction, generative model communication, and media composition to enable the AI-assisted media generation workflow described with reference to FIGS. 1-6.

The system architecture includes a User Interaction Layer positioned at the top of the architecture. The User Interaction Layer may provide interfaces through which users interact with the system to create and edit narrative elements and media assets. The User Interaction Layer may provide a story development interface configured to receive user input defining narrative elements including at least one of plot metadata, character profiles, act structures, and beat sheet entries. The User Interaction Layer may also provide a script editor interface configured to display screenplay content and receive user selections for AI-assisted text generation, as described previously with reference to the method 300 of FIG. 3. The User Interaction Layer may further provide a storyboard editor interface configured to receive shot parameters including shot type and camera level selections for AI-assisted image generation, as described previously with reference to the method 200 of FIG. 2.

Referring to FIG. 7, the system architecture includes a Narrative State Layer positioned below the User Interaction Layer. The Narrative State Layer may maintain a narrative state model that persists narrative elements across the story development interface, the script editor interface, and the storyboard editor interface. The Narrative State Layer may maintain a structured project model including project metadata, plot elements, characters, acts, beats, scenes, storyboard shots, and media assets. The narrative state model may store structured narrative elements including plot metadata, character profile data, and scene information associated with the media project, as described previously with reference to the method 100 of FIG. 1. The Narrative State Layer may provide contextual inputs to generative tools by making narrative elements available for prompt construction operations.

The system architecture includes a Prompt Construction Layer positioned below the Narrative State Layer. The Prompt Construction Layer may construct prompts for external generative AI models based on the narrative state model and user selections. Based on the current narrative state and user selections received through the User Interaction Layer, the Prompt Construction Layer may construct structured prompts for generative models. The prompts constructed by the Prompt Construction Layer may incorporate story metadata, character definitions, scene context, cinematography parameters, reference images, and user instructions. The prompt construction may utilize context-window-filling techniques that maximize the amount of narrative context included in prompts up to model token limits ranging from small limits to 2 million tokens. The context-window-filling techniques may enable the Prompt Construction Layer to include relevant plot metadata, character profile data, scene information, and other narrative context within the token capacity of the target generative model.

As further shown in FIG. 7, the system architecture includes a Model Integration Layer positioned below the Prompt Construction Layer. The Model Integration Layer may communicate with external generative AI services through application programming interfaces to generate text, images, audio, and video. The Model Integration Layer may transmit prompts constructed by the Prompt Construction Layer to external generative AI models via respective application programming interfaces. In some embodiments, the Model Integration Layer may transmit the prompt to a plurality of external generative AI models via respective application programming interfaces and may receive a plurality of generated content options for display in the user interface for user selection. The architecture of the Model Integration Layer may be model-agnostic and may support substitution or addition of models without changing the workflow structure of the system.

With continued reference to FIG. 7, the Model Integration Layer may transmit prompts to a plurality of external generative AI models via respective application programming interfaces. The plurality of external generative AI models may include multiple models for each content modality, enabling the system to generate multiple content options from different models for user selection. For image generation operations, the Model Integration Layer may transmit the prompt to multiple image generation models and may receive multiple generated storyboard images for display in the user interface. For text generation operations, the Model Integration Layer may transmit the prompt to multiple large language models and may receive multiple generated text options for user selection. The multi-model integration capability may enable users to compare outputs from different generative models and select the output that best matches creative intent. The Model Integration Layer may aggregate the plurality of generated content options received from the plurality of external generative AI models and may present the aggregated options in the user interface for user selection.

The system architecture includes a Media Composition Layer positioned below the Model Integration Layer. The Media Composition Layer may integrate generated content from the external generative AI models into the narrative state model. Generated and uploaded media may be integrated into a screenplay editor, a storyboard canvas, and a timeline editing environment through the Media Composition Layer. The Media Composition Layer may enable iterative refinement from narrative concept to script to storyboard to pre-visualization media by coordinating the flow of generated content between the Model Integration Layer and the user interfaces provided by the User Interaction Layer.

With continued reference to FIG. 7, the system architecture includes an Export Layer positioned at the bottom of the architecture. The Export Layer may support export of creative outputs including scripts, storyboard sequences, and composed video files. The Export Layer may receive composed media from the Media Composition Layer and may render the media into output formats for distribution or further production use. The Export Layer may support export of composed video files in formats such as mp4, as described previously with reference to step 420 of the method 400 of FIG. 4.

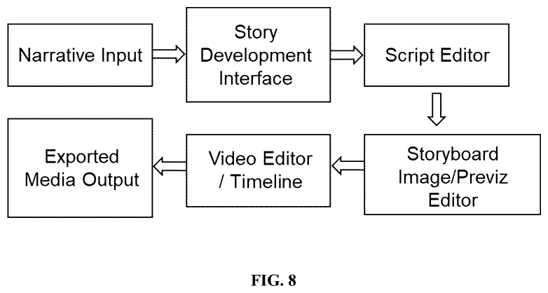

Referring to FIG. 8, a narrative workflow pipeline for AI-assisted media generation is illustrated. The narrative workflow pipeline depicts the sequential progression of a narrative project from initial concept through final media output. The narrative workflow pipeline may be implemented by the system architecture described with reference to FIG. 7 and may coordinate the methods described with reference to FIGS. 1-4 into a unified creative workflow.

The narrative workflow pipeline begins with a Narrative Input stage positioned at the start of the pipeline. At the Narrative Input stage, the system may receive an initial narrative concept or idea from a user. The initial narrative concept may comprise a title, a genre selection, a theme, a logline, or other foundational narrative information that establishes the creative direction for the media project. The Narrative Input stage may correspond to step 102 of the method 100 described with reference to FIG. 1, where the processor receives user input for a narrative concept.

With continued reference to FIG. 8, the narrative workflow pipeline proceeds from the Narrative Input stage to a Story Development Interface stage. At the Story Development Interface stage, structured story elements including plot metadata, themes, story types, and other foundational narrative components may be developed and refined with AI assistance. The Story Development Interface stage may enable users to define plot metadata such as title, logline, themes, story types, genres, tone, audience designations, settings, and B-story information. The Story Development Interface stage may also enable users to create character profiles including character names, roles, arcs, descriptions, personality traits, archetypes, wants, needs, lies, and ghost information. The Story Development Interface stage may further enable users to define act structures and beat sheet entries that organize the narrative progression. The structured story elements developed at the Story Development Interface stage may be stored in the narrative state model for use in subsequent stages of the pipeline.

The narrative workflow pipeline continues from the Story Development Interface stage to a Script Editor stage. At the Script Editor stage, screenplay content may be created and edited based on the narrative context established in the preceding stage. The Script Editor stage may provide tools for generating and refining dialogue, action descriptions, scene headings, and other screenplay elements. The Script Editor stage may enable users to leverage AI-assisted text generation for both rewriting existing screenplay content and generating new screenplay content, as described with reference to the method 300 of FIG. 3. The screenplay content created at the Script Editor stage may be stored in the narrative state model and may inform subsequent visual generation operations.

As further shown in FIG. 8, the narrative workflow pipeline advances from the Script Editor stage to a Storyboard Image/Previz Editor stage. At the Storyboard Image/Previz Editor stage, visual representations of scenes may be created based on the screenplay content and narrative context from preceding stages. The Storyboard Image/Previz Editor stage may enable generation of storyboard images incorporating cinematography parameters such as shot type and camera level selections, as described with reference to the method 200 of FIG. 2. The Storyboard Image/Previz Editor stage may also enable generation of audio elements including voice content, sound effects, and music, as well as video elements including animated clips with camera motion. The storyboard images and associated media assets created at the Storyboard Image/Previz Editor stage may be stored in the narrative state model for use in the subsequent composition stage.

The narrative workflow pipeline proceeds from the Storyboard Image/Previz Editor stage to a Video Editor/Timeline stage. At the Video Editor/Timeline stage, media assets may be arranged and composed into a cohesive sequence. The Video Editor/Timeline stage may provide non-linear editing capabilities for arranging video clips, static images, and audio elements into a temporal sequence corresponding to the narrative structure. The Video Editor/Timeline stage may enable users to insert media, trim clips, add transitions, mix audio, and apply color adjustments to the composed sequence, as described with reference to the method 400 of FIG. 4. The Video Editor/Timeline stage may enable iterative refinement of the composed media before final export.

As shown in FIG. 8, the narrative workflow pipeline concludes with an Exported Media Output stage. At the Exported Media Output stage, the system may produce a composed media file in a video format. The Exported Media Output stage may render the arranged video clips or static images together with audio elements into a completed video file suitable for distribution or further production use. The system may also export creative outputs as PDF templates in various formats including scripts and storyboard sequences. The PDF export functionality may enable users to generate formatted documents for sharing with collaborators, presenting to stakeholders, or archiving project materials. The narrative workflow pipeline may thereby enable users to progress from an initial narrative concept through plot development, script creation, visual storyboarding, and timeline composition to produce a final exported video file or formatted document outputs. The system may support export in multiple video formats including .mp4, .mov, .mkv, and .webm, and multiple audio formats including .mp3 and .wav.

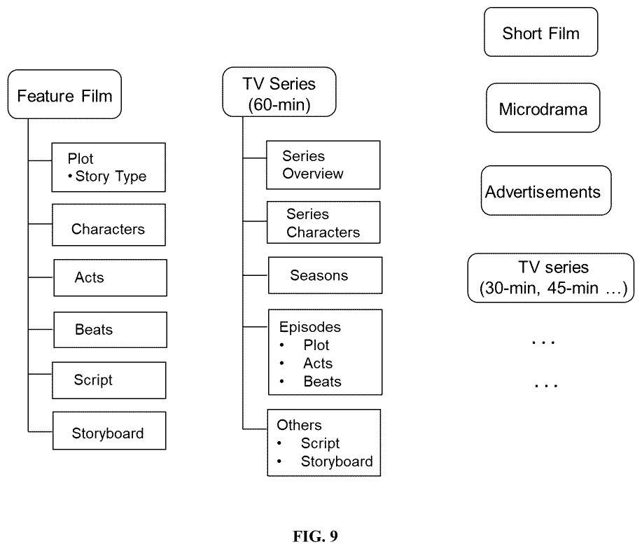

Referring to FIG. 9, a hierarchical project data model for a narrative media generation system is illustrated. The hierarchical project data model depicts the organizational structure of narrative elements maintained within the system. The hierarchical project data model may implement the narrative state model described previously with reference to FIGS. 1-8, providing a structured representation of narrative elements that enables contextual generative operations across plot, script, and storyboard interfaces.

At the top of the hierarchy, a PROJECT node serves as the root element that contains all narrative data associated with a single media production. The PROJECT node may store project-level metadata including a project identifier, a project name, and a media format designation such as feature film, television series, short film, microdrama, or advertisement. The PROJECT node may connect to subordinate components through parent-child relationships that define the organizational structure of narrative elements within the project.

As shown in FIG. 9, for a feature film project, the PROJECT node includes a Plot node as a first subordinate component. The Plot node may store plot-related metadata including a title, a logline, themes, story types, genres, tone, audience designation, setting, B-story information, and other details. Each plot metadata field may be associated with unique prompt scaffolding that guides AI-assisted generation of content specific to that field. The Plot node may include a story types field that references a predefined story types list with definitions, where each story type entry includes a story type name and a descriptive definition explaining the narrative pattern, such as David versus Goliath, Buddy Story, Love Story, and other recurring narrative archetypes.

A Characters node is positioned as a second subordinate component of the feature film PROJECT node. The Characters node may maintain character profile data for all characters defined within the narrative project. The character profile data may comprise a character name, a character role, a character arc, a character description, personality traits, archetypes, a want, a need, a lie, a ghost, and other details. The Characters node may also store references to character reference images including portrait headshots and images depicting characters in various costumes and outfits. As described previously with reference to the method 200 of FIG. 2, constructing the prompt may comprise injecting character profile data from the narrative state model into the prompt to maintain character consistency across generated content.

An Acts node is positioned as a third subordinate component of the feature film PROJECT node. The Acts node may define the structural organization of the narrative using a three-act structure comprising Act 1, a first half of Act 2, a second half of Act 2, and Act 3. The Acts node may include nested sub-elements comprising Beats, Scenes, and Shots that define the hierarchical structure of narrative content within each act.

The Beats sub-element within the Acts node may represent the beat sheet structure that defines narrative progression points. The beat sheet data may comprise a plurality of beat entries organized according to a predefined beat template, where each beat entry may comprise a beat label and a beat description. The system may support a 40-beat default template for feature film narrative structure with custom beat terminology and definitions, with beat labels such as Prologue, Protagonist Want, Antagonist, Create Plan, and Epilogue that define the narrative progression through the story structure. The system may also support additional predefined beat templates beyond the default template, including publicly available beat sheet frameworks such as Save The Cat that users may select as alternatives. The customizable beat template functionality may enable users to select from multiple available beat templates or to create custom beat templates tailored to specific narrative approaches.

The Scenes sub-element within the Acts node may represent individual scene divisions within the acts. Each scene may be associated with scene information including a scene heading, action descriptions, dialogue content, and references to corresponding beat entries. The Shots sub-element within the Acts node may represent individual storyboard shots within scenes. Each shot may be associated with shot parameters including shot type selections, camera level selections, and style settings. The Shots sub-element may store references to generated storyboard images and associated media assets including video clips and audio elements.

A Script node is positioned as a fourth subordinate component of the feature film PROJECT node. The Script node may store screenplay content associated with the narrative project, including scene headings, action descriptions, character dialogue, parentheticals, and transitions formatted according to industry-standard screenplay conventions.

A Storyboard node is positioned as a fifth subordinate component of the feature film PROJECT node. The Storyboard node may store storyboard images associated with scenes and shots within the narrative project. The Storyboard node may also store associated media elements including audio and video content that may be edited together by the user into a composed sound and video file for export.

As further shown in FIG. 9, for a television series project, the PROJECT node includes a Series Overview node storing series-level metadata including a series name, a logline, themes, story types, genres, tone, audience designation, setting, and other details. A Series Characters node stores character profile data shared across all episodes within the series, comprising character name, role, arc, description, personality, archetypes, want, need, lie, ghost, and other details. A Seasons node contains Season sub-elements, each storing a season title and season overview.

Each Season sub-element may contain Episode sub-elements, each storing an episode title and episode overview. Each Episode sub-element may include an episode-level Plot node storing episode-specific metadata including themes, story type, genres, tone, B-story, C-story, D-story, and other details. Each Episode sub-element may further include an Acts node with a teaser and four-act structure comprising Teaser, Act 1, Act 2, Act 3, and Act 4. Each Episode sub-element may include a Beats node with a 25-beat default template with custom beat terminology and definitions organized across the teaser and act sections. The system may also support additional predefined beat templates for television formats. Each Episode sub-element may further include a Script node for per-episode screenplay content and a Storyboard node for per-episode storyboard images and composed sound and video media.

The hierarchical project data model may support additional media format templates including short film templates, microdrama templates, advertisement templates for 15-second and 30-second durations, television series templates for 30-minute and 45-minute episode formats, and other types of media. Each media format template may include format-specific beat sheet templates with appropriate beat counts and terminology tailored to the conventions and constraints of the corresponding media type.

The hierarchical arrangement of the project data model illustrates how narrative context may flow from the project level through plot and character definitions into structural elements and ultimately to individual storyboard shots and media content. The flow of narrative context through the hierarchy may enable the system to maintain contextual relationships between narrative elements throughout the creative workflow. When constructing prompts for generative AI models, the system may traverse the hierarchical structure to retrieve relevant narrative context including plot metadata from the Plot node, character profile data from the Characters node, act structure data and beat sheet data from the Acts node, and screenplay content from the Script node. The hierarchical project data model may thereby enable context-aware prompt construction that promotes consistency across generated content throughout the narrative media generation workflow.

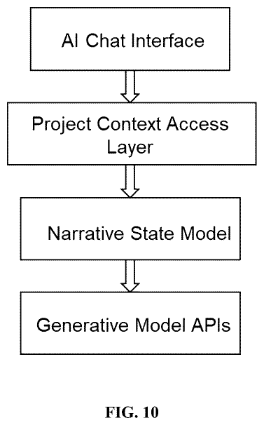

Referring to FIG. 10, a block diagram of a project-aware AI assistant architecture within the media generation system is illustrated. The project-aware AI assistant architecture may comprise four vertically arranged layers connected by directional arrows indicating the flow of information through the system. The project-aware AI assistant architecture may enable users to interact with an AI assistant that maintains awareness of narrative context established within the narrative project, enabling context-aware responses that maintain consistency with established narrative elements and character definitions throughout the creative workflow.

At the top of the architecture, an AI Chat Interface layer is positioned. The AI Chat Interface layer may serve as the user-facing component where users interact with the AI assistant through conversational input. The AI Chat Interface layer may receive user queries and instructions related to the narrative project. In some embodiments, users may enter natural language prompts requesting assistance with brainstorming ideas, generating script coverage, creating pitch materials, or other creative tasks related to the narrative project. The AI Chat Interface layer may provide a text input field for receiving user queries and may display AI-generated responses in a conversational format.

As shown in FIG. 10, the system may support referencing other projects within the AI Chat Interface layer to enable sequel or shared-world narrative workflows. In some embodiments, users may connect other projects for sequels or shared-world narratives, enabling the AI assistant to access narrative context from multiple related projects when generating responses. The cross-project referencing capability may enable users to maintain narrative consistency across a series of related media productions by providing the AI assistant with access to character definitions, plot elements, and world-building details established in prior projects.

Below the AI Chat Interface layer, a Project Context Access Layer is positioned. The Project Context Access Layer may retrieve and manage access to project-specific information stored within the system. The Project Context Access Layer may enable the AI assistant to access relevant narrative data associated with the current project, including plot elements, character definitions, and other story context. In some embodiments, the Project Context Access Layer may retrieve narrative context from the hierarchical project data model described with reference to FIG. 9, traversing the structure to gather plot metadata from the Plot node, character profile data from the Characters node, act structure data and beat sheet data from the Acts node, and scene information from the Scenes sub-element.

As further shown in FIG. 10, the third layer in the architecture is a Narrative State Model layer. The Narrative State Model layer may maintain the structured representation of the narrative project. The Narrative State Model layer may store and organize narrative elements including plot metadata, character profile data, act structures, beat sheets, and screenplay content. The Narrative State Model layer may provide the contextual foundation that informs AI-assisted generation operations performed by the AI assistant. The Narrative State Model layer may correspond to the narrative state model described previously with reference to FIGS. 1-9, enabling the project-aware AI assistant to leverage the same structured narrative representation used throughout the narrative media generation workflow.

In some embodiments, the project-aware AI assistant architecture may implement retrieval augmented generation using documents containing story structure definitions including character arcs, archetypes, story types, and beats. The retrieval augmented generation implementation may enable the AI assistant to retrieve relevant story structure definitions from a document repository when responding to user queries. The documents may contain definitions for character arcs that describe patterns of character transformation throughout a narrative, archetypes that define recurring character types and their associated traits, story types that categorize narrative patterns such as David versus Goliath or Love Story, and beats that define narrative progression points within the story structure. The retrieval augmented generation implementation may enable the AI assistant to provide responses that incorporate established storytelling frameworks and terminology consistent with the structured approach of the narrative media generation system.

FIG. 10 shows that at the bottom of the architecture, a Generative Model APIs layer is positioned. The Generative Model APIs layer may handle communication with external generative AI services through application programming interfaces. The Generative Model APIs layer may transmit constructed prompts to AI models and may receive generated content in response. The Generative Model APIs layer may communicate with large language models for generating text content in response to user queries received through the AI Chat Interface layer. In some embodiments, the Generative Model APIs layer may transmit prompts to multiple large language models and may aggregate or select responses for presentation to the user through the AI Chat Interface layer.

The directional arrows connecting the layers in FIG. 10 may indicate a bidirectional or sequential flow of information through the project-aware AI assistant architecture. The AI Chat Interface layer may communicate with the Project Context Access Layer to initiate retrieval of relevant narrative context. The Project Context Access Layer may access the Narrative State Model layer to retrieve narrative elements including plot metadata, character profile data, and scene information. The retrieved context may flow to the Generative Model APIs layer, where prompts may be constructed incorporating the narrative context and user instructions. The Generative Model APIs layer may submit the constructed prompts to external AI models for content generation and may receive generated responses. The generated responses may flow back through the architecture to the AI Chat Interface layer for display to the user. The project-aware AI assistant architecture may thereby enable the AI assistant to provide project-aware responses that maintain consistency with established narrative elements and character definitions throughout the creative workflow.

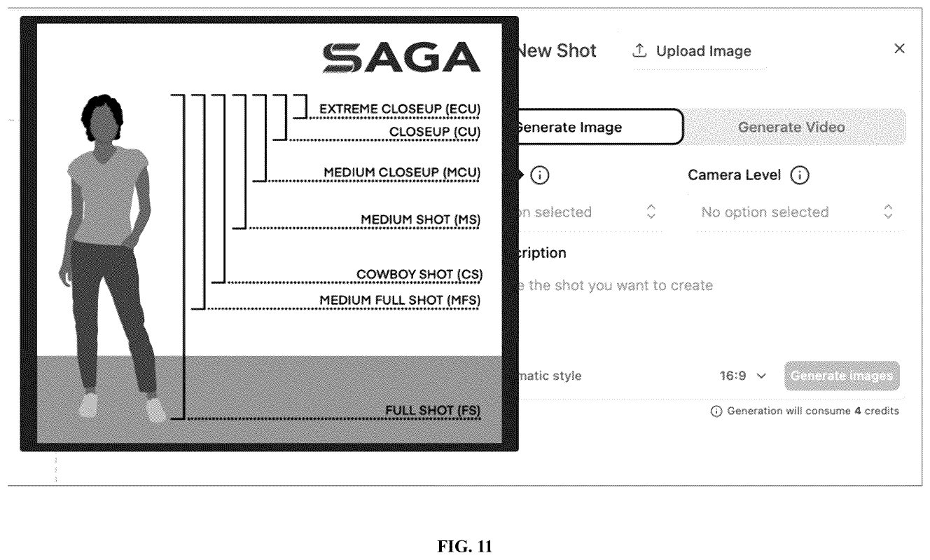

Referring to FIG. 11, a user interface for creating a new shot within a storyboard editor of the media generation system is illustrated. The user interface may be displayed by the storyboard editor interface described previously with reference to FIGS. 2 and 5, enabling users to configure shot parameters and generate storyboard images using AI-assisted image generation capabilities.

As illustrated in FIG. 11, the user interface is divided into two main sections. On the left side of the user interface, a reference diagram displays a silhouette of a standing human figure with horizontal lines extending from various body positions to indicate different shot type framings. The reference diagram may assist users in understanding the relationship between shot type selections and the resulting image composition by providing a visual representation of how each shot type frames a subject within the storyboard image.

The shot types displayed in the reference diagram are labeled from top to bottom according to the framing boundaries relative to the human figure. An Extreme Closeup (ECU) label is positioned at the head level of the silhouette, indicating a shot type that frames only the head or a portion of the face. A Closeup (CU) label is positioned at the neck level, indicating a shot type that frames the head and neck of the subject. A Medium Closeup (MCU) label is positioned at the chest level, indicating a shot type that frames the subject from approximately the chest upward. A Medium Shot (MS) label is positioned at the waist level, indicating a shot type that frames the subject from approximately the waist upward. A Cowboy Shot (CS) label is positioned at the mid-thigh level, indicating a shot type that frames the subject from approximately mid-thigh upward. A Medium Full Shot (MFS) label is positioned at the knee level, indicating a shot type that frames the subject from approximately the knees upward. A Full Shot (FS) label is positioned at the feet level, indicating a shot type that frames the entire body of the subject from head to feet.

As further shown in FIG. 11, on the right side of the user interface, a panel displays options for creating a new shot. The panel includes tabs at the top for selecting between different generation modes. A Generate Image tab may be selected to configure parameters for generating a static storyboard image using an image generation model. A Generate Video tab may be selected to configure parameters for generating an animated video clip using a video generation model. In the illustrated configuration, the Generate Image tab is shown in a selected state, indicating that the user interface is configured for storyboard image generation.

Below the tabs, the panel includes a Camera Level dropdown menu for receiving a camera level selection from the user. The camera level selection may specify the vertical angle of the camera relative to the subject, such as eye level, low angle, high angle, or bird's eye view. In the illustrated configuration, the Camera Level dropdown displays a state indicating that no option has been selected, prompting the user to select a camera level parameter for the storyboard image generation.

As shown in FIG. 11, a Description text field is positioned below the Camera Level dropdown menu. The Description text field may receive a shot description from the user, where the shot description comprises text input describing the visual content desired for the storyboard image. The Description text field displays placeholder text indicating where users can describe the shot they want to create. The shot description entered in the Description text field may be incorporated into the prompt constructed for transmission to the image generation model, as described previously with reference to the method 200 of FIG. 2.

At the bottom of the panel, options for cinematic style and aspect ratio selection are displayed. A cinematic style option may apply filmmaker-tuned prompt parameters for generating images with cinematic visual qualities. The cinematic style option may incorporate prompt scaffolding designed to produce storyboard images with lighting, composition, and visual characteristics consistent with professional cinematography. An aspect ratio selection control displays the current aspect ratio setting, with 16:9 shown as the selected aspect ratio in the illustrated configuration. The 16:9 aspect ratio corresponds to a widescreen format commonly used in film and television production.

As further shown in FIG. 11, a Generate images button is positioned at the lower right corner of the panel. Activation of the Generate images button may cause the processor to construct a prompt incorporating the shot description, the shot type selection, the camera level selection, the cinematic style parameters, and narrative context retrieved from the narrative state model. The processor may transmit the constructed prompt to the image generation model via an application programming interface and may receive generated storyboard images for display in the storyboard editor interface. An information indicator adjacent to the Generate images button notes that generation will consume a specified number of credits, indicating a credit-based usage model for the image generation functionality.

An Upload Image button appears at the top right of the panel, enabling users to upload existing images for use as storyboard frames or as reference images. In some embodiments, the storyboard editor interface may be configured to receive reference image selections including at least one of character reference images, location reference images, and prop reference images. The reference image selections may be uploaded through the Upload Image button or may be retrieved from reference images previously stored in the narrative state model on character pages, location pages, or prop pages within the application. The processor may be configured to inject the reference image selections into prompts transmitted to the image generation model, enabling the image generation model to incorporate visual characteristics from the reference images when generating new storyboard images.

With continued reference to FIG. 11, when a user enters a shot description in the Description text field that includes a character name, the processor may be configured to retrieve character profile data from the narrative state model based on character name matching within the shot description. The processor may perform fuzzy name matching to identify character names appearing in the shot description and may retrieve corresponding character profile data from the Characters node of the hierarchical project data model described with reference to FIG. 8. The processor may inject a physical description associated with a matched character into the prompt for the image generation model. The injection of character physical descriptions into prompts may promote visual consistency across storyboard images by ensuring that characters are depicted with consistent appearances throughout the storyboard sequence without requiring users to re-describe character appearances in each shot description.

A close button is positioned at the upper right corner of the user interface, enabling users to dismiss the shot creation panel and return to the main storyboard editor view. The shot creation user interface may thereby enable users to configure shot parameters including shot type, camera level, cinematic style, and aspect ratio, enter shot descriptions, and initiate AI-assisted storyboard image generation within the storyboard editor interface of the media generation system.

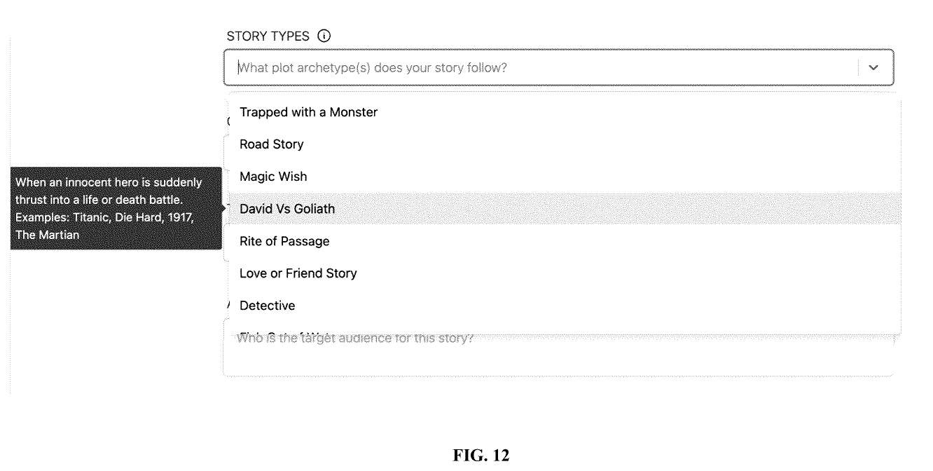

Referring to FIG. 12, a user interface for a plot development page within the media generation system is illustrated. The user interface displays a story types selection dropdown menu that enables users to select plot archetypes for the narrative project. The story development interface may be provided by the system for AI-assisted media generation described previously with reference to FIGS. 1-10, enabling users to define plot metadata including story type selections that inform subsequent AI-assisted content generation operations.

As shown in FIG. 12, the user interface includes a header labeled STORY TYPES positioned at the top of the story types selection area. An information icon is positioned to the right of the header text, enabling users to access additional information about story types and their role in narrative development. Below the header, a dropdown field displays placeholder text reading “What plot archetype(s) does your story follow?” with a downward-pointing chevron indicating the expandable menu functionality. The placeholder text may prompt users to consider the underlying narrative pattern that structures the story being developed.

The dropdown menu is shown in an expanded state in FIG. 12, revealing a list of selectable story type options arranged vertically. The story type options displayed in the list include Trapped with a Monster at the top of the visible list, followed by Road Story, Magic Wish, David Vs Goliath, Rite of Passage, Love or Friend Story, and Detective at the bottom of the visible list. The David Vs Goliath option appears highlighted in the illustrated configuration, indicating either a hover state or current selection focus. The story type options may represent recurring narrative patterns that have been used in storytelling across cultures and time periods, providing users with established frameworks for structuring narrative content.

As further shown in FIG. 12, a tooltip panel is displayed to the left side of the user interface, providing contextual help information for the currently highlighted story type. The tooltip panel contains explanatory text that describes the David Vs Goliath story type as a narrative pattern involving an innocent hero suddenly thrust into a life or death battle. The tooltip panel also provides example films that exemplify the David Vs Goliath story type, including Titanic, Die Hard, 1917, and The Martian. The tooltip panel has a dark background with light text for visual contrast against the main interface, enabling users to read the contextual help information while viewing the dropdown menu options.

The contextual help provided through the tooltip panel may assist users in understanding the characteristics of each story type and in selecting story types that align with the narrative concept being developed. By presenting example films for each story type, the tooltip panel may enable users to recognize familiar narrative patterns and to apply established storytelling frameworks to new creative projects. The story type selections made through the story development interface may be stored in the narrative state model as part of the plot metadata and may inform subsequent AI-assisted generation operations including character development, beat sheet generation, and screenplay writing.

In FIG. 12, below the story types dropdown, a partially visible text field is shown with placeholder text reading “Who is the target audience for this story?” indicating an additional input field for specifying the intended audience demographic for the narrative project. The audience designation field may enable users to define the target audience as part of the plot metadata, which may inform the tone, content, and style of AI-generated content throughout the narrative media generation workflow.

In some embodiments, the method may include a step of fine-tuning the external generative AI model using datasets of movie scripts with quality ratings based on online scores, award nominations, and box office success. The fine-tuning process may utilize datasets comprising movie scripts that have been rated according to a quality scale derived from combinations of online scores, award nominations, box office success, and other factors. The fine-tuning may over-weight the neural network for movies that have achieved higher quality ratings, enabling the fine-tuned model to generate content that reflects patterns and characteristics associated with successful narrative media. The fine-tuned model may be integrated into the narrative media generation system through the Model Integration Layer described with reference to FIG. 7, enabling users to benefit from AI-assisted generation that has been trained on high-quality narrative content. The story type selections made through the story development interface may be used in conjunction with the fine-tuned model to generate content that adheres to established narrative patterns while reflecting the quality characteristics of successful films within each story type category.

In some cases, the story development interface may enable users to select multiple story types and combine the selected story types to create hybrid narrative structures. The combination of story types may enable users to formulate pitches using comparative references, such as describing a narrative concept as a combination of two recognized films that exemplify different story types. The system may store the combined story type selections in the narrative state model as part of the plot metadata, and may incorporate the combined story types when constructing prompts for AI-assisted content generation. The prompt construction may reference characteristics of each selected story type, enabling the generated content to reflect narrative patterns from multiple story type frameworks. The story type combination capability may align with common practices used by professionals in the film industry, where pitches frequently describe new projects by referencing combinations of successful existing works.

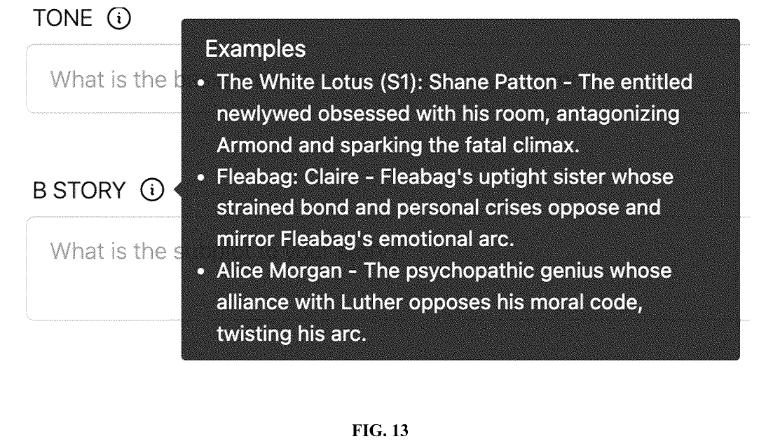

Referring to FIG. 13, a user interface element displaying a tooltip panel with B Story examples is illustrated. The tooltip panel may be displayed within the story development interface of the media generation system described previously with reference to FIGS. 1-12, providing contextual help information that supports users in defining B Story elements for the narrative project.

With continued reference to FIG. 13, the tooltip panel includes a header labeled Examples positioned at the top of the panel. Below the Examples header, three bullet point entries are arranged vertically, each referencing a television series and describing a B Story character from that series. The bullet point entries may provide users with concrete examples of how B Story characters function within established narrative works, enabling users to understand the role of B Story elements in reinforcing themes and creating narrative complexity.

The first bullet point entry references The White Lotus Season 1 and describes Shane Patton as the entitled newlywed obsessed with his room, antagonizing Armond and sparking the fatal climax. The description illustrates how a B Story character may create conflict that intersects with and amplifies the primary narrative arc, demonstrating the relationship between B Story elements and the overall thematic structure of a narrative work.

As further shown in FIG. 13, the second bullet point entry references Fleabag and describes Claire as Fleabag's uptight sister whose strained bond and personal crises oppose and mirror Fleabag's emotional arc. The description illustrates how a B Story character may serve as a foil to the protagonist, with the B Story character's journey reflecting and contrasting with the protagonist's development in ways that reinforce the thematic content of the narrative.

The third bullet point entry references Luther and describes Alice Morgan as the psychopathic genius whose alliance with Luther opposes his moral code, twisting his arc. The description illustrates how a B Story character may challenge the protagonist's values and create moral complexity within the narrative, demonstrating the role of B Story elements in deepening character development and thematic exploration.

As shown in FIG. 13, the tooltip panel appears to be associated with a B STORY input field visible in the background of the user interface. The B STORY input field includes a label with an information icon positioned adjacent to the label text. A text input field with placeholder text asking about the subplot to the story is partially visible beneath the B STORY label, indicating where users may enter B Story information for the narrative project. A TONE label with an associated information icon is visible above the B STORY section, indicating the organizational structure of the story development interface where multiple plot metadata fields are arranged vertically.

The tooltip panel has a dark background with white text, providing visual contrast against the main interface elements and enabling users to read the contextual help information while viewing the associated input field. The positioning of the tooltip panel adjacent to the B STORY input field may enable users to reference the example descriptions while formulating B Story content for the narrative project being developed.

The contextual help information provided through the tooltip panel may assist users in understanding the characteristics and functions of B Story elements within narrative structures. By presenting examples from recognized television series, the tooltip panel may enable users to recognize patterns in how B Story characters interact with protagonists, create conflict, and reinforce thematic content. The B Story information entered through the story development interface may be stored in the narrative state model as part of the plot metadata and may inform subsequent AI-assisted generation operations including character development, beat sheet generation, and screenplay writing. The AI-assisted generation operations may incorporate the B Story information when constructing prompts for external generative AI models, enabling generated content to reflect the subplot relationships and thematic reinforcement patterns established through the B Story definitions.

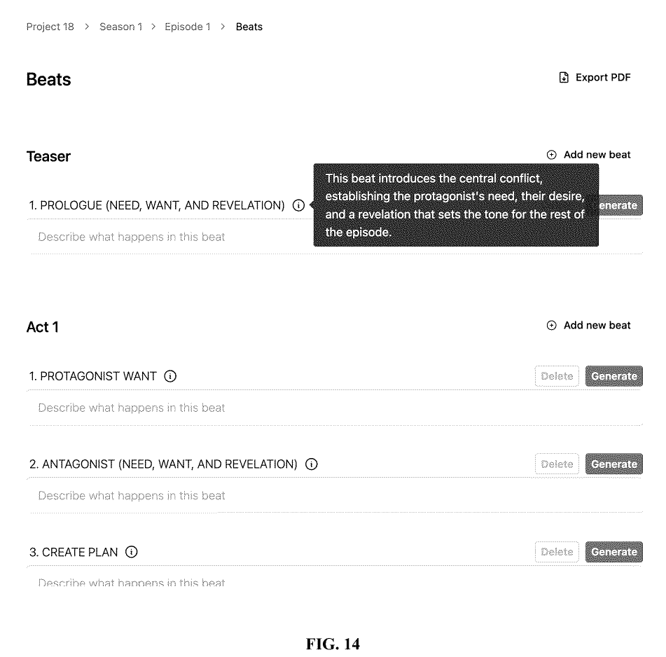

Referring to FIG. 14, a user interface for a beats editor page within the media generation system is illustrated. The beats editor page may be displayed by the system for AI-assisted media generation described previously with reference to FIGS. 1-12, enabling users to define and organize beat sheet entries that structure the narrative progression of the media project.

With continued reference to FIG. 14, the beats editor interface includes a hierarchical navigation breadcrumb positioned at the top of the interface. The hierarchical navigation breadcrumb displays a path from Project 18 through Season 1 to Episode 1 to Beats, indicating the current location within a television series project structure. The hierarchical navigation breadcrumb may enable users to navigate between different levels of the project hierarchy and to understand the organizational context of the beat sheet being edited. The hierarchical navigation breadcrumb may reflect the hierarchical project data model described with reference to FIG. 8, where beat sheet data is organized within the Acts node as a sub-element of the project structure.

The main content area of the beats editor interface is divided into sections corresponding to different acts within the episode structure. A Teaser section appears at the top of the interface, representing the opening segment of a television episode that precedes the first act. The Teaser section contains a prologue beat entry 1 with parenthetical notation indicating Need, Want, and Revelation. The prologue beat entry 1 may define an opening narrative moment establishing context before the main story begins. The beat sheet data may comprise the prologue beat entry 1 that defines an opening narrative moment establishing context before the main story begins, setting the stage for the narrative events that follow in subsequent acts.

As further shown in FIG. 14, the prologue beat entry 1 includes a text input field with placeholder text reading “Describe what happens in this beat.” The text input field may receive a beat description from the user, where the beat description comprises text input describing the narrative events, character actions, or story developments that occur at the corresponding point in the narrative progression. An information icon appears adjacent to the beat title of the prologue beat entry 1. When activated, the information icon displays a tooltip containing explanatory text that reads “This beat introduces the central conflict, establishing the protagonist's need, their desire, and a revelation that sets the tone for the rest of the episode.” The tooltip may provide contextual help information that assists users in understanding the function and characteristics of the prologue beat within the narrative structure.

The Teaser section includes an Add new beat button positioned in the upper right area of the section. The Add new beat button may enable users to add additional beat entries to the Teaser section, expanding the beat sheet structure to accommodate narrative content that extends beyond the predefined beat template. The Add new beat functionality may enable users to customize the beat sheet structure according to the requirements of the specific narrative being developed.

As shown in FIG. 14, below the Teaser section, an Act 1 section contains multiple beat entries arranged vertically. The Act 1 section represents the first act of the television episode structure, where the narrative establishes characters, conflicts, and story direction. The first beat entry within the Act 1 section is labeled Protagonist Want with an associated information icon. The Protagonist Want beat entry includes Delete and Generate buttons positioned to the right of the beat title. A text input field with placeholder text appears below the beat title for receiving a beat description.

The second beat entry within the Act 1 section is an antagonist beat entry 2 with parenthetical notation indicating Need, Want, and Revelation. The antagonist beat entry 2 is accompanied by an information icon and Delete and Generate buttons. The beat sheet data may comprise the antagonist beat entry 2 that defines a narrative moment introducing or developing the opposing force in the story. The antagonist beat entry 2 may establish the antagonist's motivations, desires, and the revelation that creates conflict with the protagonist's goals.

As further shown in FIG. 14, the third beat entry within the Act 1 section is a create plan beat entry 3 with an information icon and Delete and Generate buttons. The beat sheet data may comprise the create plan beat entry 3 that defines a narrative moment where the protagonist formulates their approach to achieving their goal. The create plan beat entry 3 may represent a turning point in the narrative where the protagonist transitions from reacting to circumstances to actively pursuing objectives.

Each beat entry within the Act 1 section includes a text input field with placeholder text for describing the beat content. The Delete button associated with each beat entry may enable users to remove beat entries from the beat sheet structure. The Generate button associated with each beat entry may enable users to initiate AI-assisted generation of beat descriptions based on the narrative context stored in the narrative state model. When the Generate button is activated, the processor may construct a prompt incorporating plot metadata, character profile data, and preceding beat descriptions from the narrative state model, and may transmit the prompt to a large language model to generate a beat description for the corresponding beat entry.

As illustrated in FIG. 14, the Act 1 section also includes an Add new beat button in the upper right area of the section, enabling users to add additional beat entries to the act structure. The Add new beat functionality may enable users to expand the beat sheet beyond the predefined template to accommodate narrative complexity or alternative story structures.

The interface header displays a Beats title on the left side and an Export PDF button on the right side. The Export PDF button may enable users to export the beat sheet content as a formatted document for sharing with collaborators, presenting to stakeholders, or archiving project materials. The exported PDF may include the beat labels and beat descriptions for all beat entries organized according to the act structure of the narrative project.

As described previously with reference to FIG. 9, the beat sheet data may comprise a plurality of beat entries organized according to a predefined beat template, where each beat entry comprises a beat label and a beat description. The system may support a 40-beat default template for feature film narrative structure with custom beat terminology and definitions. The 40-beat default template may include beat labels such as Prologue, Protagonist Want, Antagonist, Create Plan, and Epilogue that define the narrative progression through the feature film story structure. The system may also support a 25-beat default template for television episode narrative structure with custom beat terminology and definitions. The 25-beat default template may include beat labels organized across the Teaser and Acts 1 through 4 sections, as illustrated in FIG. 14, providing a structured framework for developing television episode narratives. The predefined beat templates may incorporate custom beat terminology and definitions that reflect established storytelling frameworks and best practices used in professional film and television production.

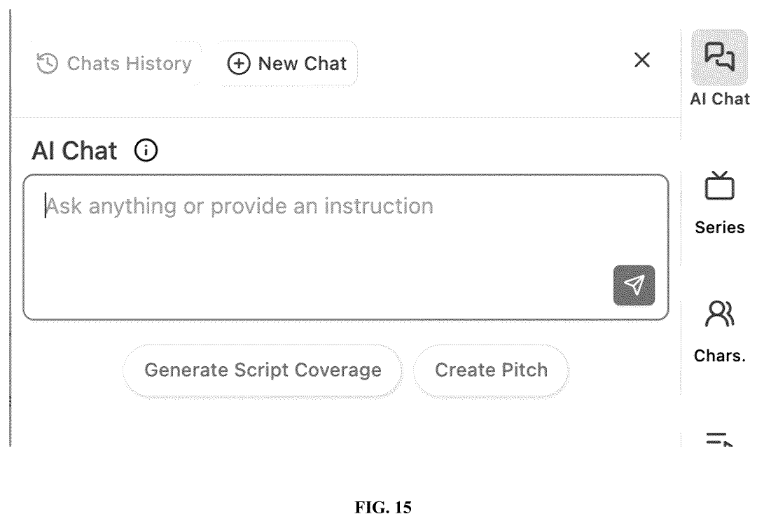

Referring to FIG. 15, a user interface for an AI chat feature within the media generation system is illustrated. The AI chat feature may be provided by the system for AI-assisted media generation described previously with reference to FIGS. 1-14, enabling users to interact with a project-aware AI assistant through conversational input. The AI chat feature may implement the project-aware AI assistant architecture described with reference to FIG. 10, providing users with access to AI-assisted brainstorming, content generation, and creative support capabilities that maintain awareness of narrative context established within the narrative project.

FIG. 15 shows that the user interface includes a top navigation area containing controls for managing chat sessions. A Chats History button with a clock icon is positioned on the left side of the navigation area. The Chats History button may enable users to access previous chat sessions associated with the narrative project, allowing users to review prior conversations with the AI assistant and to continue discussions from earlier sessions. A New Chat button with a plus icon is positioned adjacent to the Chats History button. The New Chat button may enable users to initiate a new chat session, clearing the current conversation context and beginning a fresh interaction with the AI assistant. A close button marked with an X is positioned on the right side of the navigation area, enabling users to dismiss the AI chat interface and return to other areas of the application.

Below the navigation area, a heading displays the text AI Chat accompanied by an information icon represented as a circled letter i. The AI Chat heading may identify the current interface as the conversational AI assistant feature of the media generation system. The information icon may enable users to access additional information about the AI chat feature, including guidance on how to interact with the AI assistant and descriptions of available capabilities.

As further shown in FIG. 15, the main content area of the AI chat interface contains a text input field with placeholder text reading “Ask anything or provide an instruction.” The text input field may receive user queries and instructions in natural language format. Users may enter questions about narrative development, requests for creative suggestions, instructions for generating specific content, or other conversational input related to the narrative project. The text input field spans the width of the interface, providing space for users to enter detailed queries or multi-sentence instructions. A send button is positioned in the lower right corner of the text input field, represented by a paper airplane icon within a dark square. Activation of the send button may cause the processor to transmit the user query to the project-aware AI assistant for processing and response generation.

Below the text input field, two action buttons are displayed horizontally, providing quick access to predefined AI chat functions. A first button is labeled Generate Script Coverage, enabling users to initiate AI-assisted analysis of screenplay content stored in the narrative state model. The Generate Script Coverage function may cause the AI assistant to analyze the screenplay and generate coverage documentation including a synopsis, character analysis, and evaluation of narrative elements. A second button is labeled Create Pitch, enabling users to initiate AI-assisted generation of pitch materials for the narrative project. The Create Pitch function may cause the AI assistant to generate pitch documentation based on plot metadata, character profiles, and other narrative elements stored in the narrative state model. The action buttons may enable users to access common AI-assisted functions without requiring users to formulate detailed natural language queries.

With continued reference to FIG. 15, a vertical sidebar is positioned along the right edge of the interface, containing navigation icons for different application sections. The sidebar includes an AI Chat icon at the top, indicating the currently active interface section. Below the AI Chat icon, a Series icon represented by a television symbol provides access to series-level project management features for television series projects. A Chars. icon represented by a person symbol is positioned below the Series icon, indicating access to character management features where users may view and edit character profiles stored in the narrative state model. Additional interface elements appear at the bottom of the sidebar, providing access to other sections of the narrative media generation workflow. The sidebar navigation may enable users to transition between the AI chat interface and other application sections while maintaining access to the project-aware AI assistant capabilities throughout the creative workflow.

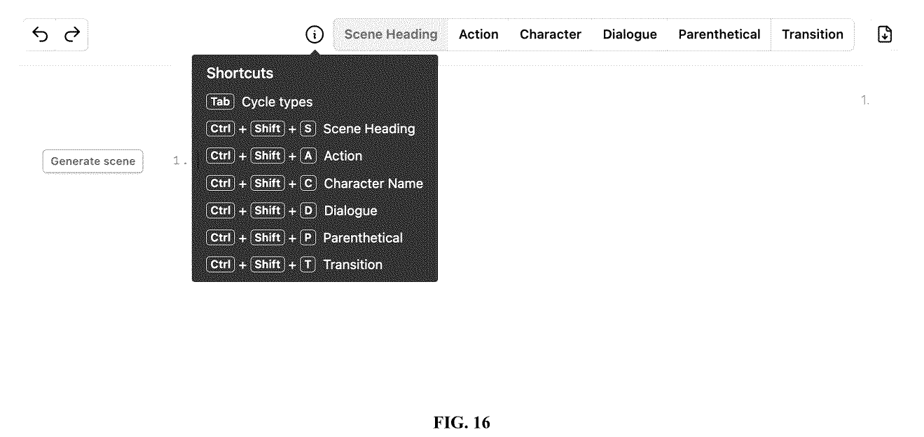

Referring to FIG. 16, a user interface wireframe for a script editor page within the media generation system is illustrated. The script editor page may be displayed by the system for AI-assisted media generation described previously with reference to FIGS. 1-14, enabling users to create and edit screenplay content using industry-standard formatting conventions and AI-assisted text generation capabilities.

As shown in FIG. 16, the script editor interface includes a navigation bar positioned at the top of the screen. The navigation bar contains formatting option buttons arranged horizontally that correspond to standard screenplay formatting elements. The formatting option buttons include a Scene Heading button for formatting scene heading lines that establish location and time of day, an Action button for formatting action description paragraphs that describe visual elements and character movements, a Character button for formatting character name lines that precede dialogue, a Dialogue button for formatting spoken dialogue content, a Parenthetical button for formatting parenthetical directions that appear within dialogue blocks, and a Transition button for formatting transition instructions such as cut to or fade out. The formatting option buttons may enable users to apply appropriate screenplay formatting to text content by selecting the desired element type before entering text or by converting existing text to the selected format. An information icon is positioned to the left of the formatting option buttons, enabling users to access additional information about screenplay formatting conventions. An export icon is positioned to the right of the formatting option buttons, enabling users to export the screenplay content in various formats.

As further shown in FIG. 16, a shortcuts tooltip panel is displayed below the navigation bar. The shortcuts tooltip panel presents keyboard shortcut information for the script editor interface, enabling users to apply screenplay formatting efficiently without requiring mouse interaction with the formatting option buttons. The shortcuts tooltip panel includes a Tab shortcut for cycling through element types, enabling users to sequentially advance through the available formatting options by pressing the Tab key. The shortcuts tooltip panel also includes multiple Ctrl+Shift combination shortcuts for directly selecting specific screenplay element types. A Ctrl+Shift+S shortcut corresponds to Scene Heading, enabling users to apply scene heading formatting by pressing the Ctrl, Shift, and S keys simultaneously. A Ctrl+Shift+A shortcut corresponds to Action, enabling users to apply action description formatting. A Ctrl+Shift+C shortcut corresponds to Character Name, enabling users to apply character name formatting. A Ctrl+Shift+D shortcut corresponds to Dialogue, enabling users to apply dialogue formatting. A Ctrl+Shift+P shortcut corresponds to Parenthetical, enabling users to apply parenthetical formatting. A Ctrl+Shift+T shortcut corresponds to Transition, enabling users to apply transition formatting. The keyboard shortcuts may enable users familiar with screenwriting workflows to maintain typing efficiency by applying formatting without interrupting the writing process.

With continued reference to FIG. 16, the main content area of the script editor interface displays a screenplay editing workspace. The screenplay editing workspace includes line numbering along the left margin, enabling users to reference specific lines within the screenplay and to track the length of screenplay content. The line numbering may assist users in navigating to specific locations within the screenplay and may facilitate communication about screenplay content when collaborating with other users or when receiving feedback from reviewers.

A Generate scene button is positioned adjacent to the first line position in the screenplay editing workspace. The first line position represents the location where users may begin entering screenplay content, including content corresponding to the prologue beat entry 1 described with reference to FIG. 14. The Generate scene button may enable users to initiate AI-assisted scene generation at the current cursor position. When the Generate scene button is activated, the processor may construct a prompt incorporating narrative context from the narrative state model, including plot metadata, character profile data, and beat sheet data, and may transmit the prompt to a large language model to generate screenplay content for the corresponding scene. The generated screenplay content may include scene headings, action descriptions, character dialogue, and other screenplay elements formatted according to industry-standard conventions. The Generate scene button may assist users experiencing writer's block by providing AI-generated content that users may accept, edit, or reject according to creative preferences.

As further shown in FIG. 16, undo and redo navigation arrows are positioned in the upper left corner of the script editor interface. The undo navigation arrow may enable users to reverse recent editing actions, restoring the screenplay content to a previous state. The redo navigation arrow may enable users to restore editing actions that were previously undone, enabling users to move forward through the editing history after reversing changes. The undo and redo navigation functionality may enable users to experiment with AI-generated content and manual edits while maintaining the ability to revert to earlier versions of the screenplay content.

In some embodiments, the system may support uploading scripts in multiple text formats including Final Draft FDX format and Fountain format. The Final Draft FDX format may comprise an XML-based file format used by Final Draft screenwriting software, enabling users to import existing screenplays created in Final Draft into the media generation system. The Fountain format may comprise a plain text markup format for screenwriting that uses simple syntax conventions to indicate screenplay element types, enabling users to import screenplays created in text editors or other applications that support the Fountain format. The support for multiple upload formats may enable users to continue working on existing screenplay projects within the media generation system and to leverage the AI-assisted editing capabilities described with reference to the method 300 of FIG. 3 for refining imported screenplay content.

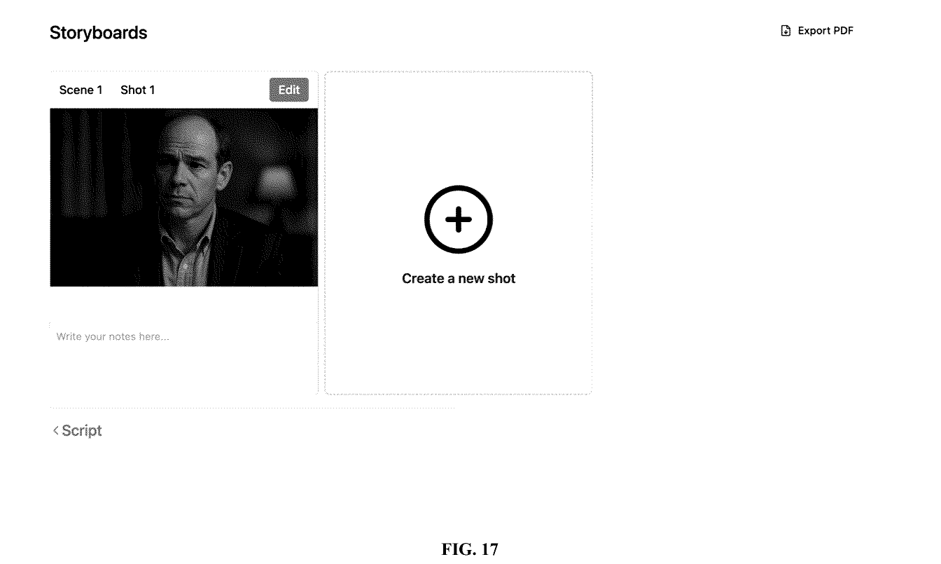

Referring to FIG. 17, a user interface for a storyboard editor page within the media generation system is illustrated. The storyboard editor page may be displayed by the system for AI-assisted media generation described previously with reference to FIGS. 1-15, enabling users to view, organize, and annotate storyboard frames associated with scenes of the narrative project.

As shown in FIG. 17, the storyboard editor interface includes a header region positioned at the top of the interface. The header region displays a Storyboards title on the left side, identifying the current interface section within the narrative media generation workflow. An Export PDF button is positioned at the top right corner of the interface. The Export PDF button may enable users to export the storyboard content as a formatted document for sharing with collaborators, presenting to stakeholders, or archiving project materials. The exported PDF may include the storyboard images, scene and shot identifiers, and associated notes for all storyboard frames organized according to the scene structure of the narrative project.

The main content area of the storyboard editor interface displays storyboard frame containers arranged horizontally. A first storyboard frame container is positioned on the left side of the main content area. The first storyboard frame container includes a header bar containing scene and shot identifiers displayed as Scene 1 and Shot 1, indicating the organizational position of the storyboard frame within the narrative structure. An Edit button is positioned within the header bar of the first storyboard frame container. The Edit button may enable users to modify the shot parameters, shot description, or other configuration settings associated with the storyboard frame.

As further shown in FIG. 17, below the header bar of the first storyboard frame container, a storyboard image is displayed. The storyboard image shows a black and white photograph of a man wearing a collared shirt and jacket, captured in a medium close-up shot composition with dramatic lighting. The medium close-up shot composition may frame the subject from approximately the chest upward, consistent with the shot type definitions described previously with reference to FIG. 11. The dramatic lighting characteristics of the storyboard image may reflect the cinematic style parameters applied during image generation, as described previously with reference to the method 200 of FIG. 2.

Beneath the storyboard image within the first storyboard frame container, a text input area is provided. The text input area displays placeholder text reading “Write your notes here . . . ” to indicate the function of the input area. The text input area may enable users to add annotations or notes associated with the storyboard shot. In some embodiments, users may enter director notes, production instructions, dialogue references, or other contextual information that supports the production process. The notes entered in the text input area may be stored in the narrative state model in association with the corresponding storyboard shot and may be included in exported PDF documents.

With continued reference to FIG. 17, a second container is positioned on the right side of the main content area. The second container displays an empty storyboard frame placeholder with a dashed border outline. The dashed border outline may visually distinguish the empty placeholder from populated storyboard frame containers, indicating that the placeholder awaits content creation. Within the empty placeholder, a circular button containing a plus symbol is centered. Text below the circular button reads “Create a new shot” to indicate the function for adding additional storyboard shots to the sequence. Activation of the circular button may cause the processor to display the shot creation interface described with reference to FIG. 11, enabling users to configure shot parameters and generate a new storyboard image for the corresponding position in the storyboard sequence.

At the bottom left of the storyboard editor interface, a collapsible section labeled Script is displayed. A left-pointing chevron indicator is positioned adjacent to the Script label, suggesting that the section can be expanded to reveal associated screenplay content linked to the storyboard view. The collapsible Script section may enable users to view screenplay content corresponding to the scenes represented in the storyboard frames without navigating away from the storyboard editor interface. In some embodiments, the expanded Script section may display scene headings, action descriptions, and dialogue content that inform the visual composition of the storyboard frames. The integration of screenplay content within the storyboard editor interface may enable users to reference narrative context while creating and reviewing storyboard images.

As further shown in FIG. 17, the system may generate location set reference images that can be uploaded or generated on a project overview page and reused across storyboard generation. The location set reference images may depict scene settings, architectural elements, environmental characteristics, or other visual attributes of locations where narrative events occur. Users may upload existing location photographs or may generate location reference images using the image generation capabilities of the system. The location set reference images may be stored in the narrative state model in association with location identifiers, enabling the system to retrieve and inject location reference images into prompts when generating storyboard images for scenes occurring at the corresponding locations. The reuse of location set reference images across storyboard generation may promote visual consistency in the depiction of recurring locations throughout the storyboard sequence.

In some cases, the system may implement Relational Entity Reference Injection for locations and props. The system may maintain dedicated databases for Location and Prop reference images within the Narrative State Model. When a user's prompt text references a specific location, such as an apartment or office, or a specific prop, such as a car or weapon, the Prompt Construction Layer may automatically retrieve the corresponding reference image array and inject it into the outbound API payload. This forces the external model to use the exact uploaded or generated visual architecture for those entities, rather than hallucinating new visual attributes for every frame. The location reference images may depict scene settings, architectural elements, environmental characteristics, or other visual attributes of locations where narrative events occur. The prop reference images may depict objects, vehicles, weapons, documents, or other items that appear within scenes of the narrative project. By maintaining these dedicated reference image databases and automatically injecting the corresponding images when entities are referenced in prompts, the system enforces pre-generation consistency without requiring post-generation evaluation or comparison of visual attributes between images.

The system may generate prop reference images that can be uploaded or generated and named for reference when generating storyboards. The prop reference images may depict objects, vehicles, weapons, documents, or other items that appear within scenes of the narrative project. Users may upload existing prop photographs or may generate prop reference images using the image generation capabilities of the system. Each prop reference image may be associated with a prop name or identifier, enabling users to reference props by name within shot descriptions entered in the storyboard editor interface. When a shot description includes a prop name, the processor may retrieve the corresponding prop reference image from the narrative state model and may inject the prop reference image into the prompt transmitted to the image generation model. The injection of prop reference images into prompts may enable the image generation model to depict props with consistent visual characteristics across storyboard frames where the props appear.

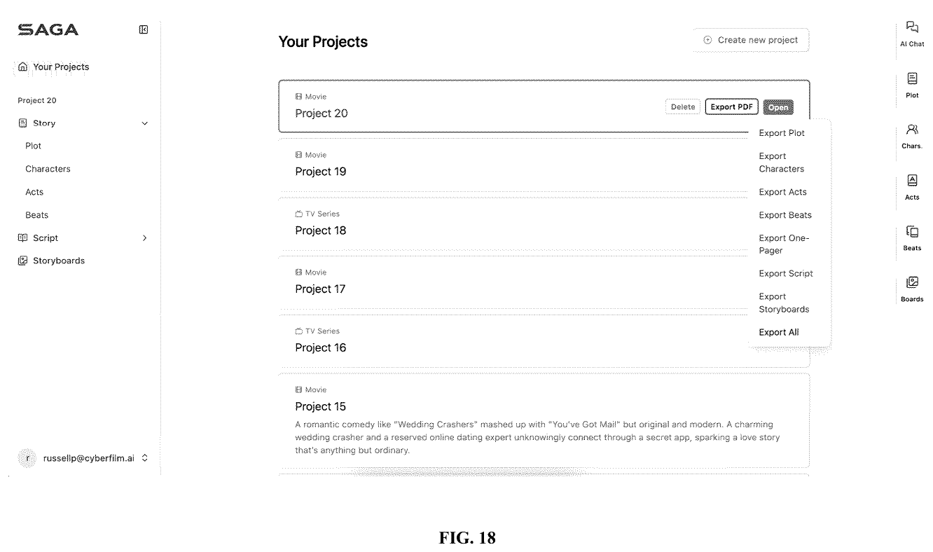

Referring to FIG. 18, a user interface for a project management homepage within the media generation system is illustrated. The project management homepage may be displayed by the system for AI-assisted media generation described previously with reference to FIGS. 1-16, enabling users to create, organize, access, and manage narrative projects within the application.

As shown in FIG. 18, the project management homepage includes a left sidebar navigation panel positioned along the left edge of the interface. A logo labeled SAGA is positioned at the top of the left sidebar navigation panel, identifying the application branding. Below the logo, a menu structure provides navigation controls for accessing different areas of the application and different sections within individual projects.

The menu structure within the left sidebar navigation panel includes a Your Projects link positioned below the logo. The Your Projects link may enable users to navigate to the project management homepage from other areas of the application, providing access to the list of narrative projects associated with the user account. Below the Your Projects link, a Project 20 section is displayed with an expandable Story submenu. The Story submenu contains entries for Plot, Characters, Acts, and Beats, corresponding to the story development interface, character profile management, act structure organization, and beat sheet editing sections described previously with reference to FIGS. 1-16. The expandable submenu structure may enable users to navigate directly to specific sections within a selected project without requiring intermediate navigation steps.

As further shown in FIG. 18, below the Story submenu, a Script menu item is displayed with an expansion indicator, suggesting that the Script section may contain additional sub-navigation options. A Storyboards menu item is positioned below the Script menu item, providing access to the storyboard editor interface described previously with reference to FIGS. 2, 5, 10, and 16. At the bottom of the left sidebar navigation panel, a user email address is displayed, indicating the currently authenticated user account associated with the application session.

The main content area of the project management homepage displays a heading titled Your Projects positioned at the top of the content area. A create new project button is positioned in the upper right corner of the main content area. The Create new project button may enable users to initiate creation of a new narrative project, which may prompt users to specify project metadata including a project name and a media format designation.

With continued reference to FIG. 18, below the heading, a vertical list of project cards is arranged within the main content area. Each project card displays project metadata that identifies and describes the corresponding narrative project. A first project card labeled Project 20 is shown in a selected state, indicated by visual highlighting or border treatment that distinguishes the selected project from other project cards in the list. The first project card includes a Movie type indicator, identifying the media format of the project as a feature film format.

The first project card displays three action buttons positioned within the card interface. A Delete button may enable users to remove the project from the project list, deleting the project and associated narrative data from the system. An Export PDF button may enable users to export project content as formatted PDF documents. An Open button may enable users to open the project and navigate to the project workspace where users may access the story development interface, script editor interface, storyboard editor interface, and other project sections.

The project management homepage may include project management controls that enable users to delete existing projects from the application. Each project card displayed in the vertical list may include a Delete button that, when activated, initiates a project deletion operation. The project deletion operation may remove the project and all associated narrative elements, screenplay content, storyboard images, and media assets from the system. In some cases, the system may display a confirmation prompt before completing the deletion operation to prevent accidental removal of project content. The project deletion functionality may enable users to manage their project library by removing completed projects, abandoned projects, or test projects that are no longer needed. The project management homepage may thereby provide comprehensive project lifecycle management including project creation, project access, project export, and project deletion within a unified interface.

As further shown in FIG. 18, an expanded dropdown menu extends from the Export PDF button of the first project card, presenting export options for generating various formatted documents from the project content. The export options displayed in the dropdown menu include Export Plot for generating a PDF document containing plot metadata, Export Characters for generating a PDF document containing character profile data, Export Acts for generating a PDF document containing act structure information, Export Beats for generating a PDF document containing beat sheet entries, Export One-Pager for generating a condensed summary document, Export Script for generating a formatted screenplay document, Export Storyboards for generating a document containing storyboard images and annotations, and Export All for generating a comprehensive document containing all project content. The variety of export options may enable users to generate documents tailored to specific purposes such as sharing with collaborators, presenting to stakeholders, or archiving project materials.

As shown in FIG. 18, additional project cards are displayed below the first project card within the vertical list. A Project 19 project card includes a Movie type indicator, identifying the project as a feature film format. A Project 18 project card includes a TV Series type indicator, identifying the project as a television series format. The system may support television series workflow including series overview, character library, season hierarchy, and episode hierarchy with per-episode scripts and storyboards. The television series workflow may enable users to organize narrative content across multiple seasons and episodes within a single project structure, with each episode containing dedicated script and storyboard sections. The hierarchical project data model may support additional media format templates including short film templates, microdrama templates, advertisement templates for 15-second and 30-second durations, television series templates for 30-minute and 45-minute episode formats, comics templates, graphic novel templates, fictional novel templates, and other types of media. Each media format template may include format-specific hierarchical node structures and beat sheet templates with appropriate beat counts and terminology tailored to the conventions and constraints of the corresponding media type.

A Project 17 project card includes a Movie type indicator. A Project 16 project card includes a TV Series type indicator. A Project 15 project card includes a Movie type indicator and displays a visible description text describing a romantic comedy concept. The description text may provide users with a preview of the project content without requiring users to open the project, enabling users to identify and select projects from the list based on narrative concept summaries.

As further shown in FIG. 18, the system may support additional media templates including short film, microdrama, and advertisement formats of 15-second and 30-second durations. The media format designations displayed on project cards may include type indicators for short film projects, microdrama projects, and advertisement projects in addition to the Movie and TV Series type indicators illustrated in FIG. 18. The additional media templates may provide format-specific structural frameworks and beat sheet templates appropriate for each media type, enabling users to develop narrative content according to the conventions and constraints of the selected format.

In some cases, the system may support additional visual style formats including anime, manga, and graphic novel formats. The anime format may apply visual style parameters that generate storyboard images with characteristics associated with Japanese animation, including stylized character designs, dynamic action compositions, and visual effects conventions used in anime production. The manga format may apply visual style parameters that generate storyboard images with characteristics associated with Japanese comic art, including panel compositions, speed lines, and visual storytelling conventions used in manga publications. The graphic novel format may apply visual style parameters that generate storyboard images with characteristics associated with Western comic book and graphic novel art styles. The visual style formats may be selectable through the storyboard editor interface, enabling users to generate storyboard images that align with the intended visual style of the media project. The style format selections may be stored in the narrative state model as part of the project configuration, enabling consistent application of the selected visual style across all storyboard images generated for the project.

In some cases, the system may support interactive storytelling formats including virtual reality experiences and game narratives. The interactive storytelling formats may enable users to develop branching narrative structures where story progression depends on viewer or player choices. The narrative state model may store multiple narrative paths and decision points that define the branching structure of the interactive narrative. The beat sheet data may include conditional beat entries that activate based on prior narrative choices, enabling users to plan and visualize multiple story outcomes within a single project. The system may generate storyboard images and video content for each narrative branch, enabling users to pre-visualize the complete interactive experience across all possible story paths. The interactive storytelling support may enable users to develop content for virtual reality platforms, interactive streaming experiences, and narrative game productions using the same AI-assisted workflow provided for linear media formats.

A right sidebar navigation panel is positioned along the right edge of the project management homepage interface. The right sidebar navigation panel displays icon-based shortcuts arranged vertically, providing quick access to different sections of the narrative media generation workflow. The icon-based shortcuts include an AI Chat shortcut represented by a chat icon with an abbreviated label beneath the icon, providing access to the AI chat feature described with reference to FIG. 15. For example, a Plot shortcut provides access to the plot development interface; a Chars. shortcut represented by a person icon provides access to character profile management; an Acts shortcut provides access to act structure organization. A Beats shortcut provides access to beat sheet editing, a Boards shortcut provides access to the storyboard editor interface. Each icon-based shortcut includes a distinct icon with an abbreviated label positioned beneath the icon, enabling users to identify the corresponding application section.

With continued reference to FIG. 18, the system may support deployment across web, mobile, and television interfaces all operating on the same structured narrative project model. The project management homepage interface illustrated in FIG. 18 may be rendered within a web browser environment, and equivalent interfaces may be provided for mobile device applications and television interface applications. The structured narrative project model maintained by the system may persist narrative elements including plot metadata, character profile data, act structures, beat sheet entries, screenplay content, and storyboard assets in a format accessible across the web, mobile, and television deployment environments. The cross-platform deployment capability may enable users to access and edit narrative projects from different devices while maintaining consistency in the underlying project data structure.

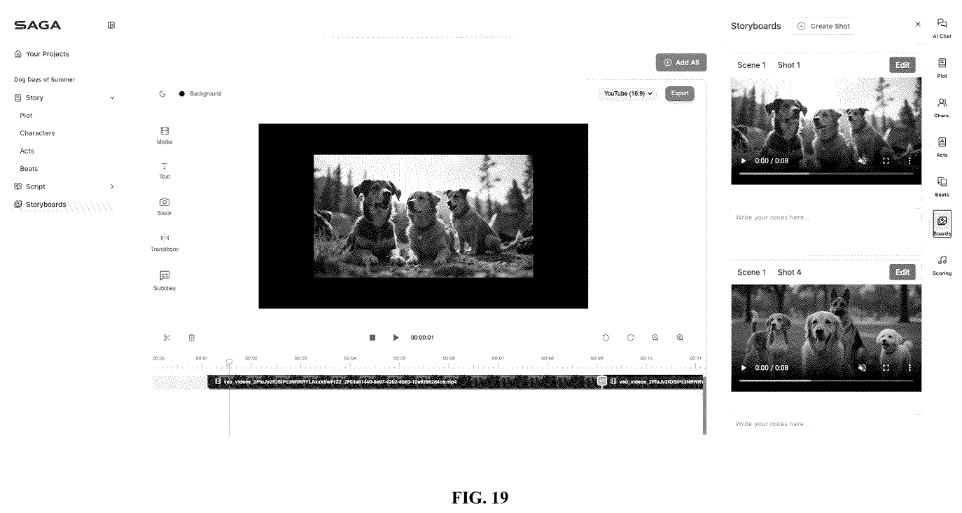

Referring to FIG. 19, a user interface for a storyboard editor page with an integrated video editing timeline within the media generation system is illustrated. The storyboard editor page with integrated timeline may be displayed by the system for AI-assisted media generation described previously with reference to FIGS. 1-18, enabling users to view storyboard content and compose video sequences within a unified interface environment.

As shown in FIG. 19, the storyboard editor interface includes a left sidebar navigation panel positioned along the left edge of the interface. The left sidebar navigation panel contains a hierarchical menu structure providing navigation controls for accessing different sections within the narrative project. A Your Projects link is positioned at the top of the hierarchical menu structure, enabling users to navigate to the project management homepage. Below the Your Projects link, a Movie Project section is displayed containing expandable categories for different project sections.

The hierarchical menu structure within the left sidebar navigation panel includes expandable categories for Story, Plot, Characters, Acts, Beats, Script, and Storyboards. The Story category appears in an expanded state in the illustrated configuration, revealing the Plot, Characters, Acts, and Beats subcategories beneath the Story category heading. The hierarchical menu structure may enable users to navigate directly to specific sections within the project while maintaining visibility of the overall project organization. The Storyboards category may be highlighted or visually distinguished to indicate the currently active interface section.

As further shown in FIG. 19, the main content area of the storyboard editor interface displays a storyboard workspace positioned in the upper portion of the interface. The storyboard workspace shows a storyboard frame container displaying Scene 1 Shot 4, indicating the organizational position of the displayed storyboard frame within the narrative structure. An Edit button is positioned in the upper right corner of the storyboard frame container, enabling users to modify the shot parameters, shot description, or other configuration settings associated with the storyboard frame.

The storyboard frame container within the storyboard workspace contains a sketch-style portrait image of a woman wearing glasses with long hair. The sketch-style portrait image is rendered in a black and white pencil drawing style, demonstrating the variety of visual styles that may be generated or uploaded for storyboard frames within the media generation system. The sketch-style rendering may reflect style parameters selected during image generation or may represent an uploaded image created using traditional illustration techniques. Below the sketch-style portrait image, a text field is provided with placeholder text reading “Write your notes here” for adding shot annotations associated with the storyboard frame.

In some cases, the storyboard editor interface may present a living storyboard design that displays active video pre-visualization content inline within the storyboard sequence. The living storyboard design may enable storyboard frames containing generated video clips to display animated playback directly within the storyboard canvas, rather than requiring users to navigate to a separate video playback interface. Each storyboard frame that includes associated video content may display the video as an inline playback element with transport controls for play, pause, and scrubbing operations. The living storyboard design may enable users to view the storyboard sequence as a dynamic visual representation of the narrative, with static storyboard images and animated video previz clips presented together in a unified scrolling canvas. The inline video playback may enable users to evaluate the visual flow and pacing of the storyboard sequence without interrupting the storyboard review workflow. The living storyboard design may present the storyboard content in a what-you-see-is-what-you-get format that reflects how the composed sequence will appear when exported as a video file.

In some cases, the storyboard editor interface may present an endless landscape vertical-scrolling storyboard canvas that enables users to view and navigate through storyboard sequences of arbitrary length. The endless scrolling design may enable the storyboard canvas to expand dynamically as users add additional storyboard frames, without imposing fixed page boundaries or requiring pagination controls. Users may scroll vertically through the storyboard sequence to navigate between scenes and shots, with the storyboard frames arranged in a continuous visual flow that represents the sequential progression of the narrative. The landscape orientation of storyboard frames within the vertical scrolling canvas may present each frame in a widescreen aspect ratio consistent with cinematic presentation formats. The endless scrolling storyboard canvas may enable users to review complete storyboard sequences for feature-length projects containing hundreds of individual shots within a single continuous interface, facilitating evaluation of visual continuity and narrative pacing across the entire project.

With continued reference to FIG. 19, adjacent to the storyboard frame container displaying Scene 1 Shot 4, a placeholder panel is displayed with a plus icon and text reading “Create a new shot.” The placeholder panel may indicate the interface for adding additional storyboard shots to the sequence, consistent with the storyboard frame creation functionality described previously with reference to FIG. 17.

Below the storyboard workspace, an Add All Storyboard Shots to Editor button is positioned. The Add All Storyboard Shots to Editor button may provide functionality for transferring storyboard content from the storyboard workspace to the integrated video editing timeline component positioned in the lower portion of the interface. Activation of the Add All Storyboard Shots to Editor button may cause the processor to retrieve all storyboard images associated with the narrative project from the narrative state model and to insert the storyboard images into the timeline editing environment as media assets arranged according to the scene and shot structure of the project.

As further shown in FIG. 19, the lower portion of the storyboard editor interface displays an integrated video editing timeline component. The integrated timeline component may provide non-linear editing capabilities for arranging video clips, static images, and audio elements into a composed sequence, as described previously with reference to the method 400 of FIG. 4. The integrated timeline component includes a Background toggle and an aspect ratio selector positioned in an upper control area. The aspect ratio selector displays “YouTube 16:9” as the current selection, indicating a widescreen aspect ratio format suitable for video distribution on video sharing platforms. A Render Story button is positioned adjacent to the aspect ratio selector, enabling users to initiate rendering of the composed timeline sequence into an exported video file.

The integrated timeline component includes a Media panel positioned on the left side of the timeline interface. The Media panel displays thumbnail images of uploaded media assets available for use in the timeline composition. The thumbnail images within the Media panel may represent storyboard images, video clips, audio files, or other media content that has been generated or uploaded within the narrative project. Users may select media assets from the Media panel and drag the selected assets onto the timeline tracks for arrangement in the composed sequence.

FIG. 19 shows that a central preview area is positioned within the integrated timeline component. The preview area displays a storyboard image of an animated character in an interior room setting, representing the currently selected or playhead-positioned frame within the timeline sequence. The preview area may enable users to view the visual content at the current playback position and to preview the composed sequence during editing operations. The preview area may update dynamically as users navigate through the timeline or as playback progresses through the composed sequence.

A Filters panel is positioned on the right side of the integrated timeline component, adjacent to the preview area. The Filters panel displays filter options that may be applied to media assets within the timeline composition. The filter options displayed in the Filters panel include Normal, Grayscale, Invert, Sepia, Solarize, and Dramatic, with corresponding preview thumbnails showing the visual effect of each filter option. Users may select filter options from the Filters panel to apply color grading and visual effects to storyboard images or video clips within the timeline sequence. The filter options may enable users to establish visual consistency across the composed sequence or to apply stylistic treatments that enhance the cinematic quality of the final video output.

As further shown in FIG. 19, the integrated timeline component includes transport controls positioned below the preview area. The transport controls include a stop button and a play button for controlling playback of the composed timeline sequence. A timecode display showing “00:00:00” is positioned adjacent to the transport controls, indicating the current playback position within the timeline sequence in hours, minutes, and seconds format. The transport controls may enable users to preview the composed sequence, to navigate to specific positions within the timeline, and to evaluate the timing and pacing of the arranged media assets.

A horizontal timeline ruler is displayed below the transport controls, presenting time markers from 00:00 through 00:10 and beyond. The timeline ruler may provide a visual reference for the temporal position of media assets within the composed sequence and may enable users to navigate to specific time positions by clicking on the timeline ruler. A media clip is positioned on a timeline track below the timeline ruler, representing a storyboard image or video clip that has been arranged within the composed sequence. The media clip may be displayed as a thumbnail or waveform representation indicating the duration and position of the asset within the timeline.

With continued reference to FIG. 19, the right side of the integrated timeline component includes additional tool panels accessible through icon buttons. The tool panels include a Filters panel for accessing color grading and visual effect options, an Effects panel for accessing transition effects and motion effects, and an Animation panel for accessing animation controls that may be applied to static images or video clips within the timeline. The tool panels may provide access to editing capabilities including trim operations for adjusting the start and end points of media clips, insert operations for adding media assets at specific timeline positions, transition effects for creating visual transitions between adjacent clips, audio mixing controls for adjusting volume levels and timing of audio elements, and color adjustment controls for modifying the visual appearance of media assets.

In some embodiments, the method may include a step of generating virtual table read audio by synthesizing character voices to read screenplay dialogue aloud. The virtual table read audio generation may utilize audio generation models to synthesize voice content based on character dialogue stored in the screenplay content within the narrative state model. Users may select character voices for each character defined in the narrative project, and the system may generate synthesized audio of the characters speaking their dialogue lines. The generated virtual table read audio may be imported into the Media panel of the integrated timeline component and may be arranged on audio tracks within the timeline to synchronize with corresponding storyboard images or video clips. The virtual table read functionality may enable users to hear the characters bring the screenplay to life, assisting users in evaluating the dynamic of exchange and pacing of the dialogue content.

In some cases, the method may include a step of providing a rehearsal partner feature that enables users to practice dialogue delivery with AI-generated character voices. The rehearsal partner feature may utilize audio generation models to synthesize character voices that read dialogue lines from the screenplay, enabling actors or writers to rehearse scenes by performing opposite the AI-generated voices. Users may select which character voice to use for each character in a scene, and the system may generate synthesized audio of the selected characters speaking their dialogue lines with appropriate timing and pacing. The rehearsal partner feature may enable users to evaluate the flow and rhythm of dialogue exchanges, identify areas where dialogue may benefit from revision, and practice performance delivery before production begins. The rehearsal partner feature may operate in conjunction with the virtual table read functionality, enabling users to hear complete scene performances or to isolate specific character voices for targeted rehearsal.

In some cases, the AI chat interface may support document upload functionality that enables users to upload narrative documents for conversion into structured film projects. The document upload capability may accept various file types including novels, short stories, treatments, outlines, and existing screenplay drafts in formats such as plain text (.txt), PDF (.pdf), Word documents (.doc, .docx), Final Draft (.FDX), and Fountain (.fountain). Upon receiving an uploaded document, the system may parse the document content and extract narrative elements including characters, plot points, settings, themes, and story structure. The extracted narrative elements may be mapped to the hierarchical data structure of the narrative state model, populating the plot metadata, character profiles, act structure, and beat sheet entries based on the content of the uploaded document.

In some embodiments, the AI chat interface may support cross-project context access that enables users to reference narrative elements from other projects within the same user account. The cross-project access capability may enable development of sequel projects, shared-universe narratives, or franchise content where characters, locations, plot elements, or stylistic conventions established in one project are referenced or continued in subsequent projects. When a user creates a sequel project, the AI chat interface may provide access to character profiles, plot metadata, and other narrative elements from the predecessor project, enabling the system to maintain continuity in character descriptions, established backstory, and narrative conventions across multiple related projects. The cross-project context access may enable the prompt construction layer to retrieve and inject narrative context from linked projects when generating content for the current project, facilitating consistent character depictions and narrative coherence across an extended franchise or series of related media projects.

The manuscript-to-screenplay conversion capability may enable users to transform prose narrative from novels and other written works into screenplay format suitable for film production. When a user uploads a novel manuscript and requests conversion to a film project, the system may analyze the prose content to identify scenes, dialogue, character actions, and narrative beats. The system may generate screenplay content that adapts the prose narrative into visual storytelling, converting descriptive passages into action lines, extracting dialogue from narrative text, and organizing the content into properly formatted screenplay elements including scene headings, action descriptions, character names, dialogue, parentheticals, and transitions. The converted screenplay may be integrated into the script editor interface for user review and refinement.

The document upload and conversion functionality may significantly reduce the time required to adapt existing written works into film projects. Rather than manually extracting narrative elements from source material and re-entering the information into the narrative media generation system, users may upload the source document and receive a complete film project with populated plot metadata, character profiles, beat sheet entries, and generated screenplay content. The conversion process may preserve the narrative essence of the source material while adapting the storytelling approach for the visual medium of film. Users may review and refine the converted project, making adjustments to character profiles, plot elements, and screenplay content as desired to achieve the intended adaptation.

As further shown in FIG. 19, in some embodiments, the method may include a step of generating original music scores using audio generation models to match the emotion and tempo of each scene. The original music score generation may utilize audio generation models to create music content that complements the narrative tone and pacing of scenes within the media project. Users may specify emotional characteristics, tempo preferences, or genre parameters for the music score, and the system may generate original music content based on the specified parameters and the narrative context stored in the narrative state model. The generated original music scores may be imported into the Media panel of the integrated timeline component and may be arranged on audio tracks within the timeline to accompany the visual content of the composed sequence. The original music score generation may enable users to score their narrative projects with music that matches the emotion and tempo of each scene without requiring users to license existing music or to engage external composers.

The system may perform character name matching operations when generating storyboard images to maintain visual consistency across generated content. When a user enters a shot description in the storyboard editor interface, the shot description may include references to characters by name. The system may receive a character name within the shot description as part of the text input provided by the user. The character name may appear as a proper noun or identifier within the natural language description of the visual content desired for the storyboard image.

Upon receiving the shot description containing a character name, the system may perform matching operations to identify the corresponding character profile data within the narrative state model. The system may match the character name to character profile data stored in the narrative state model by comparing the character name appearing in the shot description against character names stored in the Characters node of the hierarchical project data model. In some embodiments, the matching operation may employ fuzzy name matching techniques that account for variations in character name spelling, partial name references, nicknames, or other textual variations that may appear in user-entered shot descriptions. The fuzzy name matching techniques may enable the system to identify character references even when users do not enter the exact character name as stored in the narrative state model.

When the system identifies a match between a character name in the shot description and character profile data in the narrative state model, the system may retrieve the physical description associated with the matched character. The character profile data stored in the narrative state model may include a physical description field that contains text describing the visual appearance of the character, including attributes such as hair color, eye color, facial features, body type, clothing, and other distinguishing visual characteristics. The physical description may have been entered by the user during character profile creation or may have been generated using AI-assisted text generation during the character development stage of the narrative media generation workflow.

Following retrieval of the physical description, the system may inject the physical description associated with the matched character profile data into the prompt for the image generation model. The injection of the physical description into the prompt may occur during the prompt construction process, where the system assembles the various components of the prompt including the shot description, shot parameters, style settings, and narrative context. The injected physical description may be incorporated into the prompt in a manner that instructs the image generation model to depict the character with the visual attributes specified in the physical description.

The character name matching and physical description injection process may enable users to reference characters by name in shot descriptions without requiring users to re-describe the physical appearance of each character in every shot. In some embodiments, a storyboard sequence for a feature film may include hundreds of individual shots across dozens of scenes, with characters appearing in multiple shots throughout the sequence. By automatically injecting character physical descriptions based on name matching, the system may reduce the burden on users to maintain consistency in character descriptions across shot descriptions. The automatic injection may also promote visual consistency in the generated storyboard images by ensuring that the image generation model receives consistent physical description information for each character across all shots in which the character appears.

In some embodiments, the system may perform character name matching for multiple characters appearing within a single shot description. When a shot description references two or more characters by name, the system may match each character name to corresponding character profile data in the narrative state model and may inject the physical descriptions for all matched characters into the prompt. The prompt construction process may organize the injected physical descriptions in a manner that enables the image generation model to distinguish between the multiple characters and to depict each character with the appropriate visual attributes within the generated storyboard image.

The character name matching operation may be performed as part of the prompt construction operations described previously, where the system constructs prompts for external generative AI models based on the narrative state model and user selections. The matching and injection operations may occur automatically when the user initiates storyboard image generation, without requiring explicit user action to retrieve or specify character physical descriptions. The automatic nature of the character name matching and physical description injection may streamline the storyboard creation workflow by enabling users to focus on describing the narrative content and composition of each shot while the system handles the retrieval and incorporation of character visual attributes from the narrative state model.

The beat sheet data maintained by the narrative state model may comprise an epilogue beat entry that defines a closing narrative moment showing the aftermath or resolution of the story. The epilogue beat entry may represent the final beat within the beat sheet structure, positioned following the climax and resolution beats that conclude the primary narrative conflict. The epilogue beat entry may comprise a beat label identifying the beat as an epilogue and a beat description containing text that describes the narrative events, character states, or thematic resolutions that occur in the closing moments of the media project. In some embodiments, the epilogue beat entry may depict the consequences of the protagonist's journey, the new equilibrium established following the resolution of the central conflict, or reflective moments that reinforce the thematic content of the narrative. The epilogue beat entry may be included in the predefined beat templates for feature films and television episodes, enabling users to develop closing narrative content that provides satisfying conclusions to the stories being developed within the narrative media generation system.

The method may include a step of translating the narrative content and synchronizing lip movements for multilingual distribution to global audiences. The translation step may utilize large language models to translate screenplay content, dialogue, and other narrative text from a source language into one or more target languages. The system may transmit prompts containing the source language content to the large language model via an application programming interface and may receive translated content in the target language. The translated content may be stored in the narrative state model in association with the corresponding source language content, enabling the system to maintain parallel versions of the narrative content in multiple languages.

Following translation of the narrative content, the system may perform lip synchronization operations to align character lip movements in video content with the translated dialogue audio. The lip synchronization operations may utilize video generation models or specialized lip sync models to modify the visual appearance of character faces in generated video clips such that the lip movements correspond to the phonemes and timing of the translated dialogue. The system may generate synthesized voice audio in the target language using audio generation models and may synchronize the generated video content with the translated audio to produce multilingual video outputs. The translation and lip synchronization capabilities may enable users to distribute narrative media content to global audiences by producing localized versions of the media project in multiple languages without requiring re-filming or manual animation of lip movements.

The system may include a companion application for mobile devices configured to display storyboard previz animations and animatic videos on set during production. The companion application may be implemented as a mobile application for tablet devices such as iPad devices, enabling production personnel to view storyboard content and previz animations in a portable format suitable for use during filming operations. The companion application may communicate with the narrative media generation system to retrieve storyboard images, previz animation clips, and animatic video sequences associated with the narrative project. The companion application may display the retrieved content on the mobile device screen, enabling directors, cinematographers, and other production personnel to reference the visual plan for each shot while positioning cameras, directing actors, and coordinating production activities on set.

The companion application may provide playback controls for viewing previz animation clips and animatic video sequences, enabling production personnel to review the intended camera movements, timing, and visual composition for each shot. The companion application may also provide navigation controls for accessing different scenes and shots within the storyboard sequence, enabling production personnel to locate specific storyboard content relevant to the current production activities. The companion application may operate on the same structured narrative project model maintained by the narrative media generation system, ensuring that the storyboard content displayed on the mobile device reflects the current state of the narrative project including any updates made through the web-based interfaces.

The system may collect user selection data across multiple generated options from different models to learn model preferences and optimize future generation. When the system transmits prompts to a plurality of external generative AI models and presents users with multiple generated content options for selection, the system may record the user selection indicating which generated option the user chose to retain for the narrative project. The user selection data may include an identifier of the selected generated content, an identifier of the generative model that produced the selected content, and metadata describing the generation context including the prompt content, shot parameters, or other configuration settings.

The system may aggregate user selection data across multiple generation operations and across multiple users to identify patterns in model preferences. The aggregated user selection data may indicate which generative models produce outputs that users prefer for different types of generation tasks, different visual styles, different narrative contexts, or other distinguishing factors. The system may analyze the aggregated user selection data to determine model preference rankings that reflect the relative quality or desirability of outputs from different generative models as perceived by users of the narrative media generation system.

Based on the learned model preferences, the system may optimize future generation operations by prioritizing models that have demonstrated higher user preference rates. In some embodiments, the system may adjust the ordering in which generated options are presented to users, positioning outputs from preferred models more prominently in the selection interface. In some embodiments, the system may reduce or eliminate the use of models that consistently produce outputs that users do not select, reallocating generation resources to models that produce more desirable outputs. The model preference learning capability may enable the system to continuously improve the quality of generated content by adapting to user preferences observed through selection behavior.

The system may support multilingual workflows enabling narrative content creation in multiple languages including Japanese and Hindi. The multilingual workflow support may enable users to create narrative projects with plot metadata, character profile data, beat sheet entries, screenplay content, and other narrative elements authored in languages other than English. The user interfaces provided by the system may support text input and display in multiple languages, including languages that utilize non-Latin character sets such as Japanese kanji, hiragana, and katakana characters, and Hindi Devanagari script characters.

The multilingual workflow support may extend to the AI-assisted generation capabilities of the system. When constructing prompts for external generative AI models, the system may incorporate narrative context in the language of the narrative project, enabling the generative models to produce outputs in the corresponding language. The large language models integrated with the system may support text generation in multiple languages, enabling users to generate plot suggestions, character descriptions, beat sheet content, and screenplay dialogue in Japanese, Hindi, and other supported languages. The multilingual workflow support may enable users in markets including Japan and India to develop narrative content in their native languages using the AI-assisted capabilities of the narrative media generation system.

The multilingual workflow support may also extend to the audio generation capabilities of the system. The audio generation models integrated with the system may support voice synthesis in multiple languages, enabling users to generate character voice audio in Japanese, Hindi, and other supported languages for use in virtual table reads, previz animations, and composed video outputs. The combination of multilingual text generation and multilingual audio generation may enable users to produce complete narrative media content in multiple languages within the unified workflow of the narrative media generation system.

In some cases, the system may support content rating configurations that enable generation of narrative content appropriate for different audience classifications. The content rating configurations may include options for generating content suitable for general audiences, content suitable for mature audiences, and content with expanded ratings up to R-rated or equivalent classifications used in different markets. The content rating configuration may be stored in the narrative state model as part of the project metadata and may be incorporated into prompts transmitted to external generative AI models. The prompt construction may include content rating parameters that guide the generative models to produce content consistent with the selected rating classification, including appropriate treatment of violence, language, and mature themes. The content rating support may enable users to develop narrative projects targeting different audience demographics and market requirements while maintaining consistency in the tone and content of AI-generated material throughout the project.

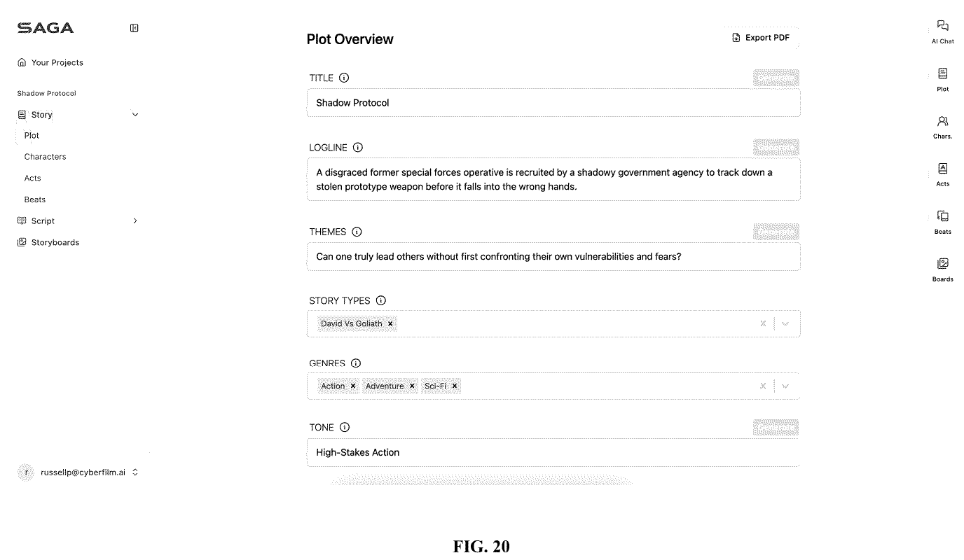

Referring to FIG. 20, a user interface for a film template plot page is illustrated. The film template plot page may be displayed within the story development interface and may present structured input fields for capturing plot metadata associated with a feature film project. The plot page may include input fields for title, logline, themes, story types, genres, tone, audience designation, setting, and B-story information. Each input field may include AI-assisted generation controls that enable users to generate suggested content based on other plot elements already defined in the narrative state model. The plot page may present the input fields in a structured layout that guides users through the plot development process.

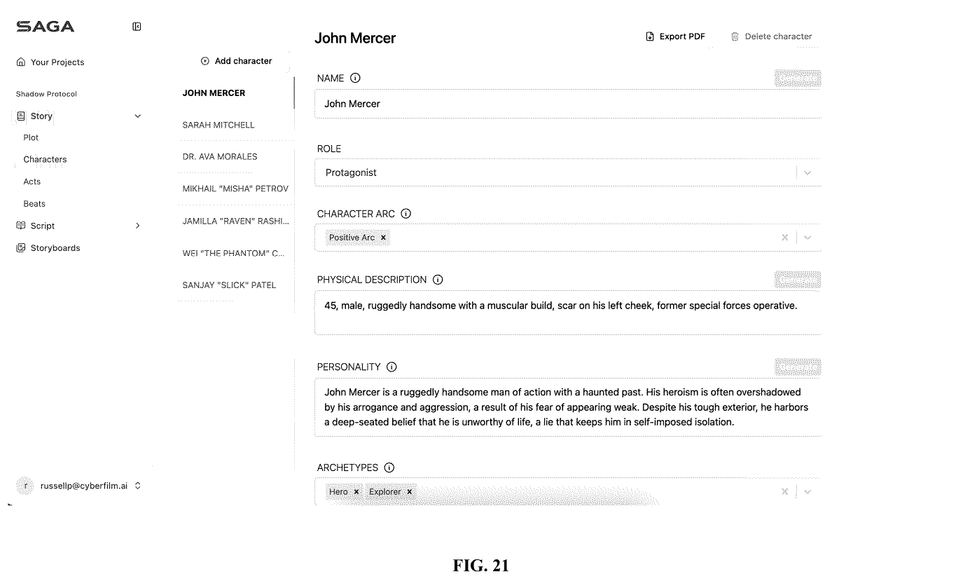

Referring to FIG. 21, a user interface for a film character page is illustrated. The character page may be displayed within the story development interface and may present structured input fields for capturing character profile data. The character page may include input fields for character name, character role, character arc, physical description, personality traits, archetype, want, need, lie, and ghost. The character page may also include controls for uploading or generating character reference images, including portrait headshots and costume reference images. The character page may include voice selection controls for selecting synthesized voices to be associated with the character for virtual table read and rehearsal features. The field of the physical description textbox contains detailed text describing the character's physical attributes, such as age, gender, build, distinguishing features, and other visual characteristics. The text entered in the physical description textbox is stored in the narrative state model and is automatically injected into image and video generation prompts as needed when the character name is referenced in shot descriptions or other user input. This automatic injection eliminates the need for users to repeatedly type character physical descriptions in each generation prompt, reducing data entry redundancy and preventing typographical errors or omissions that would cause inconsistent character depictions. In a prior-art workflow, generating a 100-shot storyboard would require the user to manually type a character's physical description 100 separate times, introducing exposure to human typographical omission. The system reduces this manual data entry requirement to exactly one instance at the initial character profile creation, and by automating the injection for subsequent shots, the system structurally eliminates the possibility of human omission errors during the prompting phase.

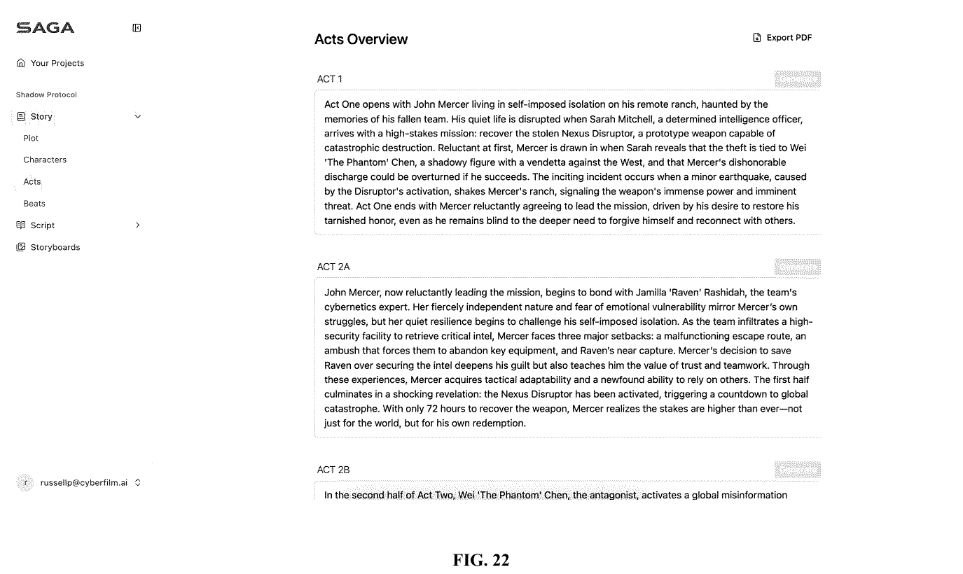

Referring to FIG. 22, a user interface for a film acts page is illustrated. The acts page may be displayed within the story development interface and may present the act structure for the narrative project. For feature films, the acts page may display a three-act structure comprising Act 1, Act 2A, Act 2B, and Act 3. For television episodes, the acts page may display a teaser and four-act structure. The acts page may enable users to define act boundaries and to associate scenes with specific acts within the narrative structure.

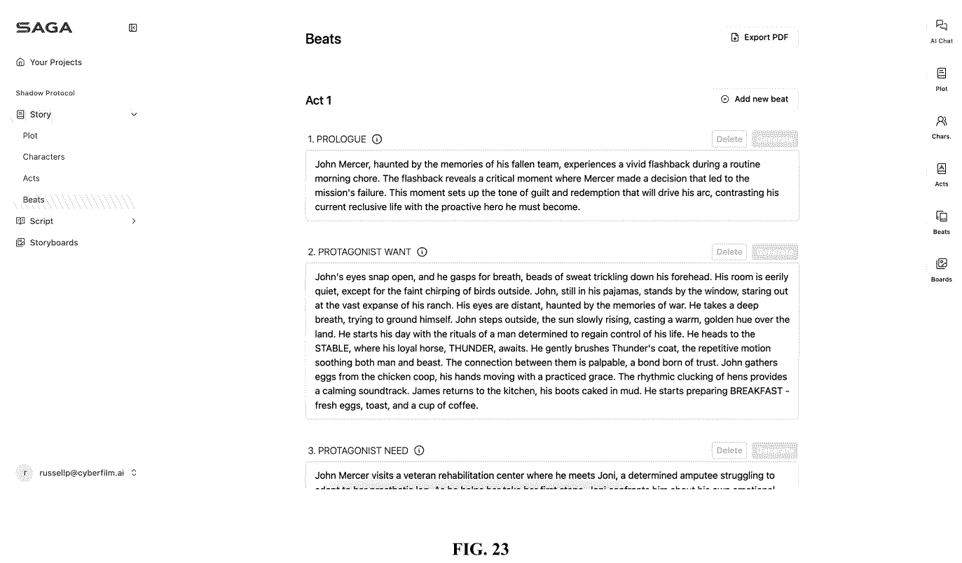

Referring to FIG. 23, a user interface for a film beats page is illustrated. The beats page may be displayed within the story development interface and may present beat sheet entries organized according to a predefined beat template. For feature films, the beats page may display a 40-beat template with defined beat terminology. For television episodes, the beats page may display a 25-beat template. Each beat entry may include a beat label and a beat description field. The beats page may include AI-assisted generation controls for generating beat descriptions based on the plot metadata and character profile data stored in the narrative state model.

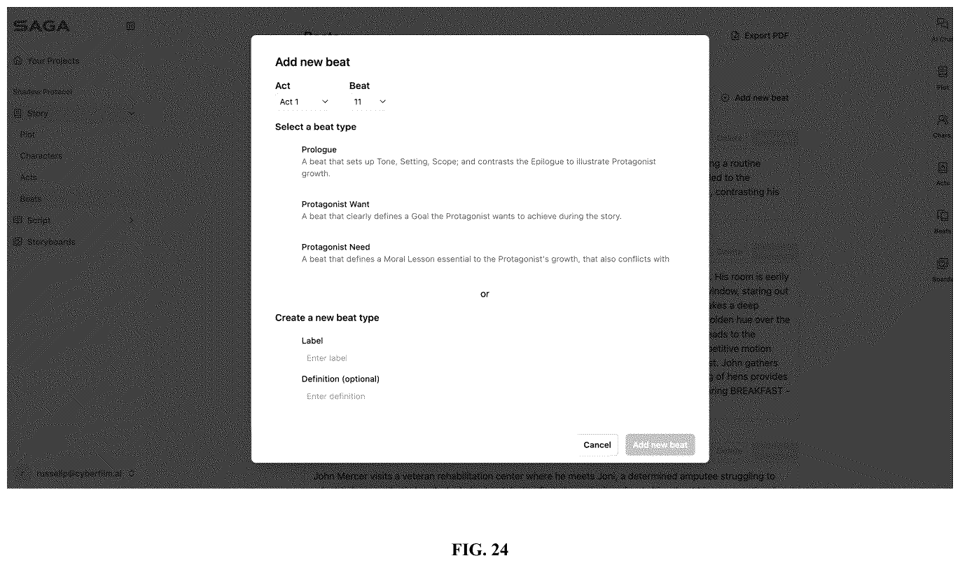

Referring to FIG. 24, a user interface for customizable beat templates is illustrated. The customizable beat templates interface may enable users to select from predefined beat templates or to create custom beat templates for their narrative projects. The interface may display available beat template options and may enable users to modify beat labels, add new beats, remove beats, or reorder beats within the template. The customizable beat templates may enable users to adapt the narrative structure to different storytelling approaches while maintaining the benefits of structured beat sheet organization.

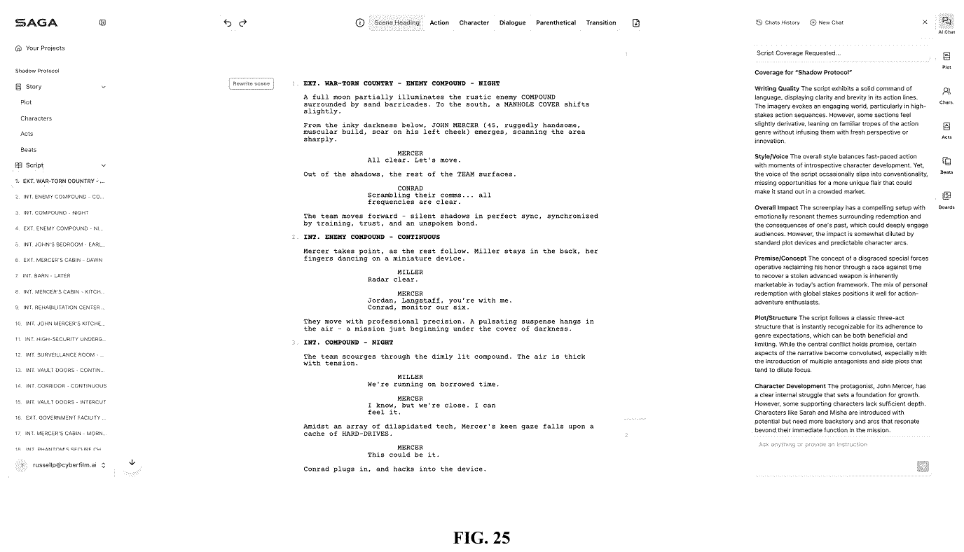

Referring to FIG. 25, a user interface for a script editor page is illustrated. The script editor page may display screenplay content in industry-standard screenplay format and may provide editing controls for creating and modifying screenplay elements. The script editor page may include formatting controls for scene headings, action descriptions, character names, dialogue, parentheticals, and transitions. The script editor page may include AI-assisted generation controls including a generate button for generating continuation content and rewrite controls for modifying selected text.

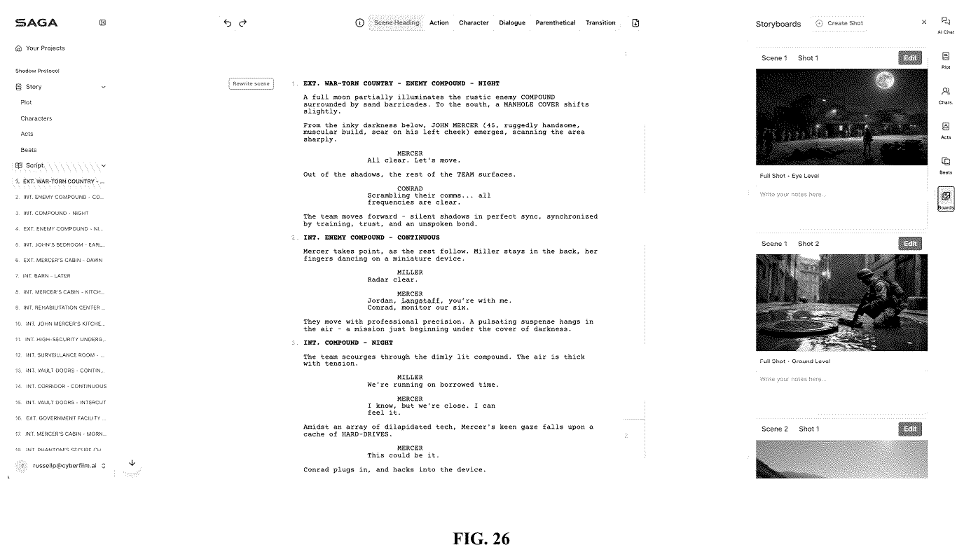

Referring to FIG. 26, a user interface for a script page with a storyboard taskpane is illustrated. The script page may include a storyboard taskpane positioned adjacent to the screenplay editing area. The storyboard taskpane may display storyboard images associated with the currently selected scene in the screenplay. The storyboard taskpane may enable users to visualize the visual representation of scenes while writing screenplay content, facilitating coordination between the written narrative and the visual storyboard. The storyboard taskpane may include controls for generating new storyboard images based on the screenplay content.

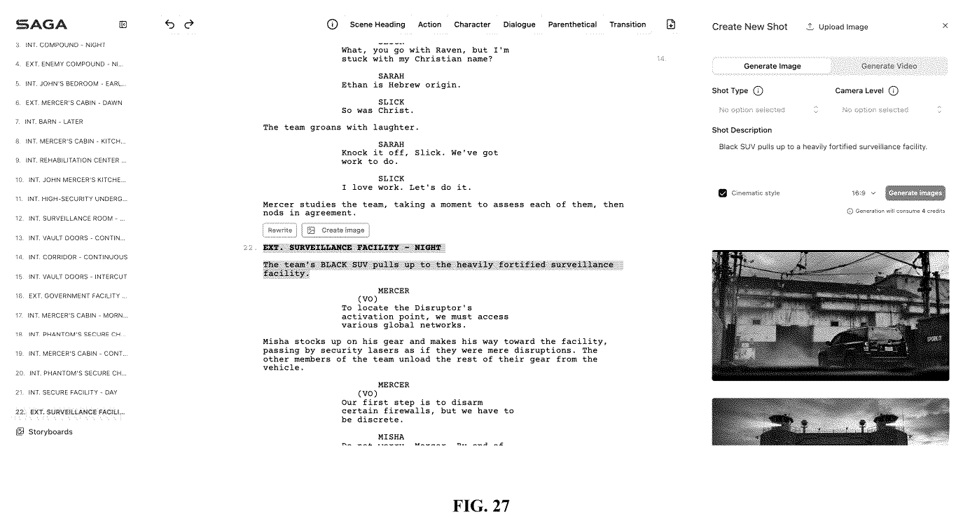

Referring to FIG. 27, a user interface for transitioning from a script page to storyboards with an auto-generated prompt is illustrated. When a user selects a scene heading in the script editor and initiates storyboard generation, the system may automatically generate a prompt based on the scene heading and associated action descriptions. The auto-generated prompt may incorporate narrative context from the narrative state model including character physical descriptions, location references, and style settings. The user may review and modify the auto-generated prompt before transmitting it to the image generation model.

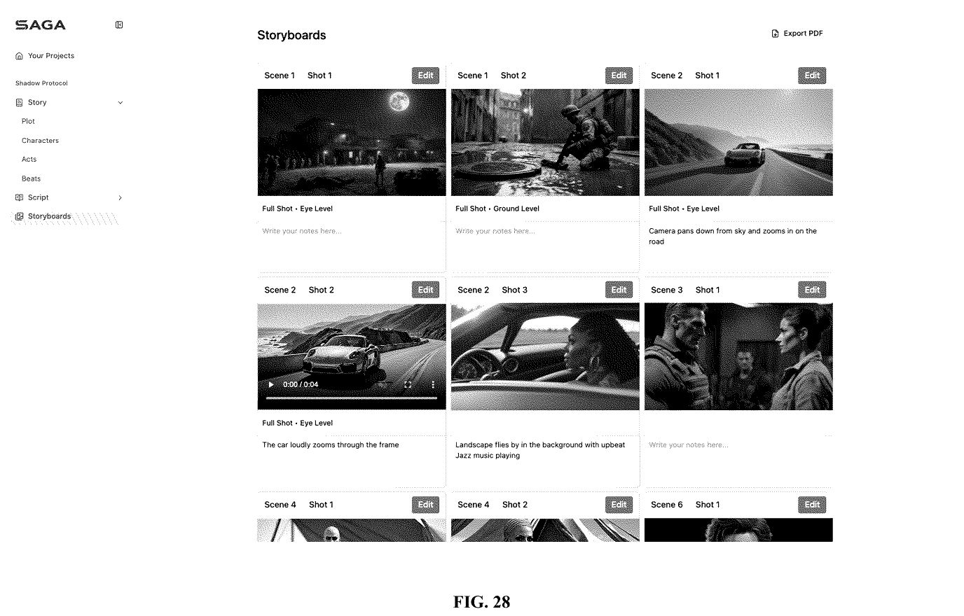

Referring to FIG. 28, a user interface for a storyboard page is illustrated. The storyboard page may display a sequence of storyboard frames arranged in a grid or vertical scrolling layout. Each storyboard frame may include a generated storyboard image, shot metadata including scene number and shot number, shot type and camera level designations,, camera motion parameters, and a notes field for user annotations. The storyboard page may include controls for creating new shots, editing existing shots, and reordering shots within the sequence.

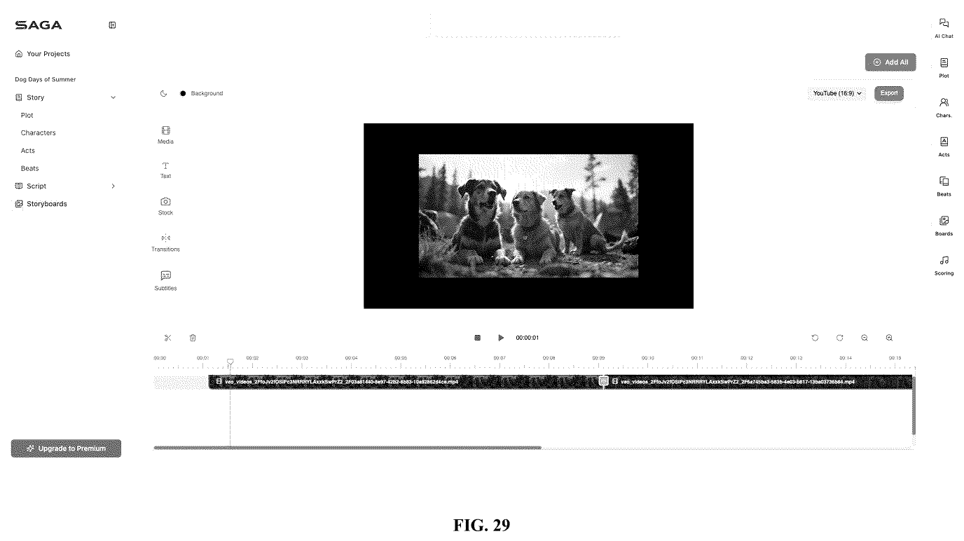

Referring to FIG. 29, a user interface showing a non-linear editing video editor component on a storyboard page is illustrated. The video editor component may be integrated within the storyboard page and may provide timeline-based editing capabilities for arranging and composing media assets. The video editor component may include a timeline ruler, media tracks for video and audio content, transport controls for playback, and tool panels for filters, effects, and animation. The video editor component may enable users to compose storyboard images, video clips, and audio elements into a cohesive sequence for export. The video editor component may support export of composed video files in multiple formats including .mp4, .mov, .mkv, and .webm for video, and .mp3 and .wav for audio.

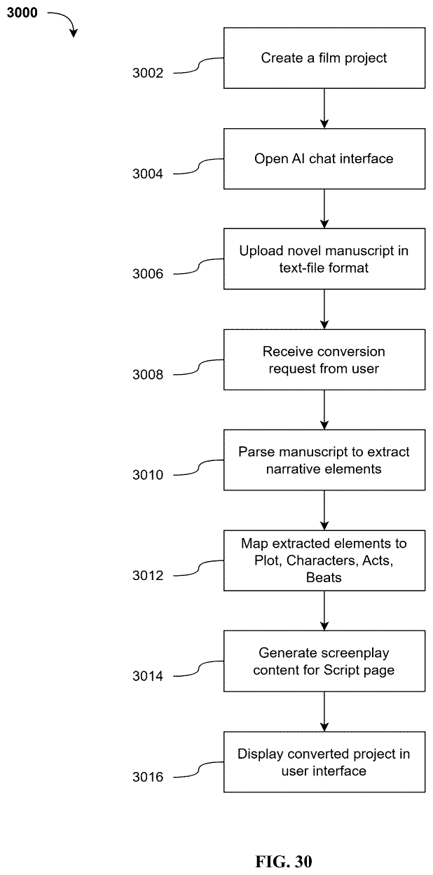

Referring to FIG. 30, a method 3000 for converting a novel manuscript into a film project using an AI chat interface is illustrated. The method 3000 may enable users to transform existing written works such as novels, short stories, or other narrative manuscripts into structured film projects with complete screenplays through document upload to the AI chat interface.

The method 3000 begins at a step 3002 of creating a film project. At step 3002, the processor may receive user input to create a new film project within the narrative media generation system. The method 3000 proceeds to a step 3004 of opening an AI chat interface. At step 3004, the processor may display an AI chat interface that provides conversational access to AI-assisted generation capabilities with full access to the project context stored in the narrative state model.

The method 3000 continues to a step 3006 of uploading a novel manuscript in text-file format. At step 3006, the processor may receive a document upload through the AI chat interface. The uploaded document may comprise a novel manuscript, short story, screenplay draft, treatment, or other narrative document in various file formats including plain text, PDF, Word document, Final Draft (.FDX), Fountain (.fountain), or other standard document formats.

At step 3008, the method 3000 receives a conversion request from a user. The user may provide a natural language instruction through the AI chat interface requesting conversion of the uploaded manuscript into a film project. The conversion request may specify preferences such as target runtime, genre emphasis, or specific characters or plot elements to prioritize in the adaptation.

The method 3000 proceeds to step 3010 of parsing the manuscript to extract narrative elements. At step 3010, the processor may analyze the uploaded manuscript using a large language model to identify narrative elements including characters, plot points, settings, themes, dialogue, and story structure. The parsing operation may identify protagonist and antagonist characters, character relationships, major plot beats, subplots, and thematic content present in the source manuscript.

At step 3012, the method 3000 maps the extracted elements to Plot, Characters, Acts, and Beats. The processor may organize the extracted narrative elements according to the hierarchical data structure of the narrative state model. Character information extracted from the manuscript may be mapped to character profile data including names, physical descriptions, roles, arcs, wants, needs, and relationships. Plot information may be mapped to plot metadata including title, logline, themes, story types, and settings. Story structure identified in the manuscript may be mapped to act structure data and beat sheet entries according to predefined beat templates.

The method 3000 continues to step 3014 of generating screenplay content for a Script page. At step 3014, the processor may construct prompts incorporating the mapped narrative elements and may transmit the prompts to a large language model to generate screenplay content adapted from the source manuscript. The generated screenplay content may include scene headings, action descriptions, character dialogue, and transitions formatted according to industry-standard screenplay conventions. The screenplay generation may transform prose narrative from the manuscript into visual storytelling appropriate for film format.

The method 3000 concludes at step 3016 of displaying the converted project in a user interface. At step 3016, the processor may integrate the generated content into the narrative state model and may display the completed project across the story development interface, script editor interface, and storyboard editor interface. The manuscript-to-screenplay conversion capability may enable users to rapidly adapt existing written works into complete film projects, significantly reducing the time required to develop screenplay content from source material.

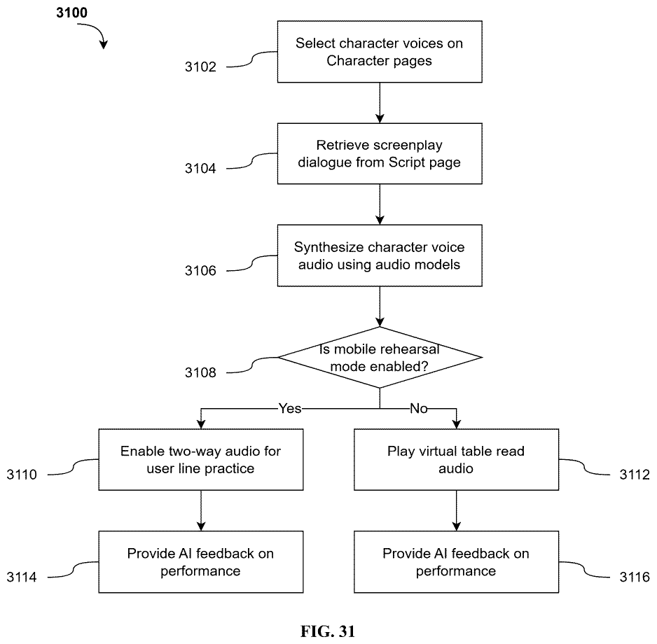

Referring to FIG. 31, a method 3100 for character voice synthesis and rehearsal mode in AI-assisted narrative media generation is illustrated. The method 3100 begins at step 3102 of selecting character voices on Character pages. At step 3102, the processor may display voice selection controls within the character profile interface, enabling users to preview and select synthesized voices for each character. The method 3100 proceeds to step 3104 of retrieving screenplay dialogue from the Script page, and continues to step 3106 of synthesizing character voice audio using audio models.

At step 3108, the method 3100 determines if mobile rehearsal mode is enabled. If mobile rehearsal mode is enabled, the method 3100 proceeds to step 3110 of enabling two-way audio for user line practice, where users can perform dialogue lines while the system plays synthesized audio for other characters. Following step 3110, the method 3100 proceeds to step 3114 of providing AI feedback on performance. If mobile rehearsal mode is not enabled at step 3108, the method 3100 proceeds to step 3112 of playing virtual table read audio, and then to step 3116 of providing AI feedback on performance.

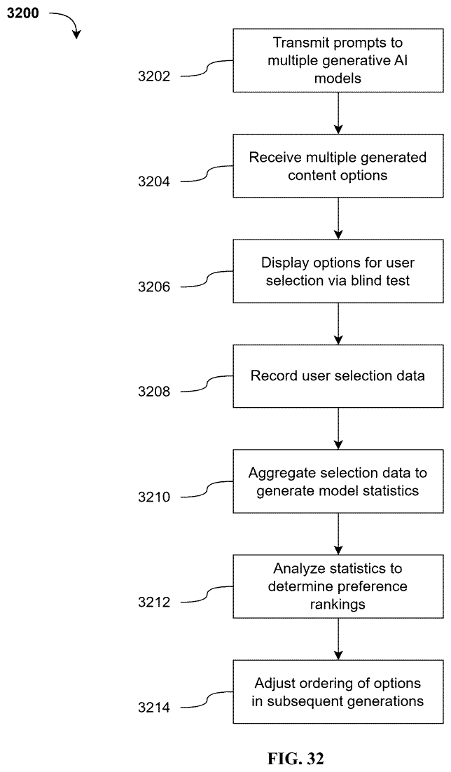

Referring to FIG. 32, a method 3200 for multi-model generation with preference tracking and adaptive ordering is illustrated. The method 3200 begins at step 3202 of transmitting prompts to multiple generative AI models. The method 3200 proceeds to step 3204 of receiving multiple generated content options, and continues to step 3206 of displaying options for user selection via blind test. At step 3208, the method 3200 records user selection data. The method 3200 continues to step 3210 of aggregating selection data to generate model statistics, proceeds to step 3212 of analyzing statistics to determine preference rankings, and concludes at step 3214 of adjusting the ordering of options in subsequent generations based on learned preferences.

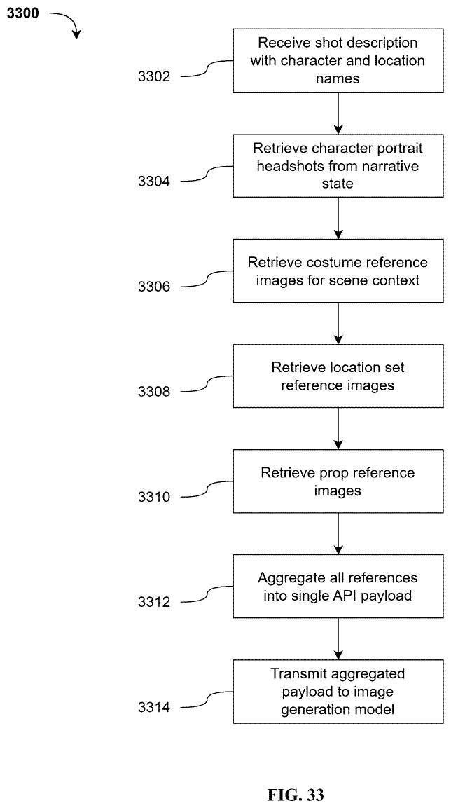

Referring to FIG. 33, a method 3300 for aggregating reference images into an API payload for image generation is illustrated. The method 3300 begins at step 3302 of receiving a shot description with character and location names. The method 3300 proceeds to step 3304 of retrieving character portrait headshots from the narrative state, continues to step 3306 of retrieving costume reference images for scene context, and advances to step 3308 of retrieving location set reference images. Following step 3308, the method 3300 proceeds to step 3310 of retrieving prop reference images. The method 3300 continues to step 3312 of aggregating all references into a single API payload, and concludes at step 3314 of transmitting the aggregated payload to an image generation model. The multi-image reference injection capability may enable the system to maintain character and location consistency by aggregating multiple visual references into a single outbound API payload.

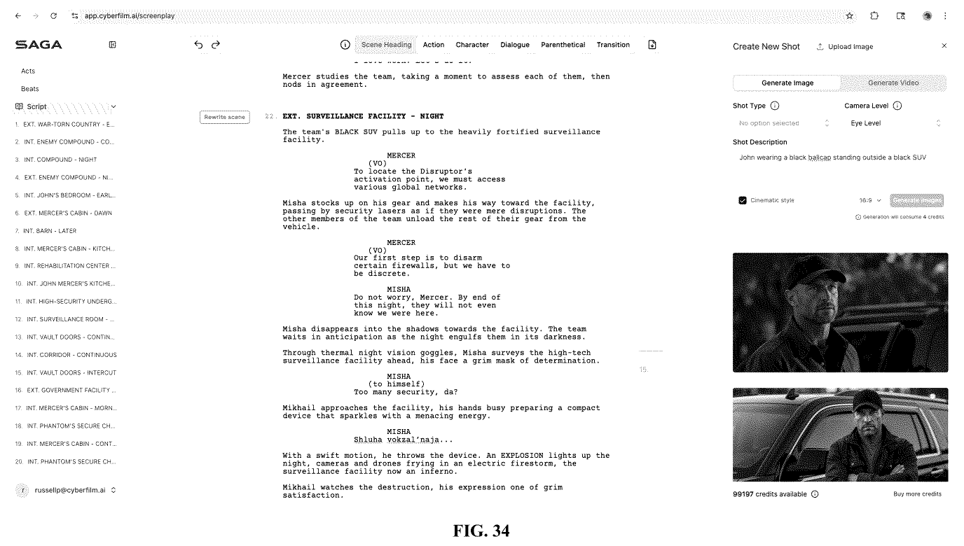

Referring to FIG. 34, a user interface showing use of a character's first name in an image prompt is illustrated. The user interface demonstrates the fuzzy character name matching capability of the system, which matches how creative professionals think about writing image prompts as they would describe to a Director of Photography or Cinematographer. A shot description input field displays a prompt containing a character's first name, such as “John wearing a black jacket standing outside a black SUV.” The system automatically identifies “John” as a reference to the character “John Mercer” stored in the narrative state model and retrieves the associated physical description data for injection into the prompt transmitted to the image generation model. The fuzzy matching capability enables users to reference characters using variations such as “John” or “Johnny” or changes later in the story like “John Sr” for the “John Mercer” character, without requiring the full name or repeated description of core features in each scene's prompt. This approach works effectively for novels and screenplays because characters are usually limited in number and typically do not re-use the same or similar names within a single project. The system enables users to write natural, concise prompts using character first names, nicknames, or informal references without manually re-entering physical descriptions for each generation request, eliminating data entry redundancy and maintaining visual consistency across generated content.

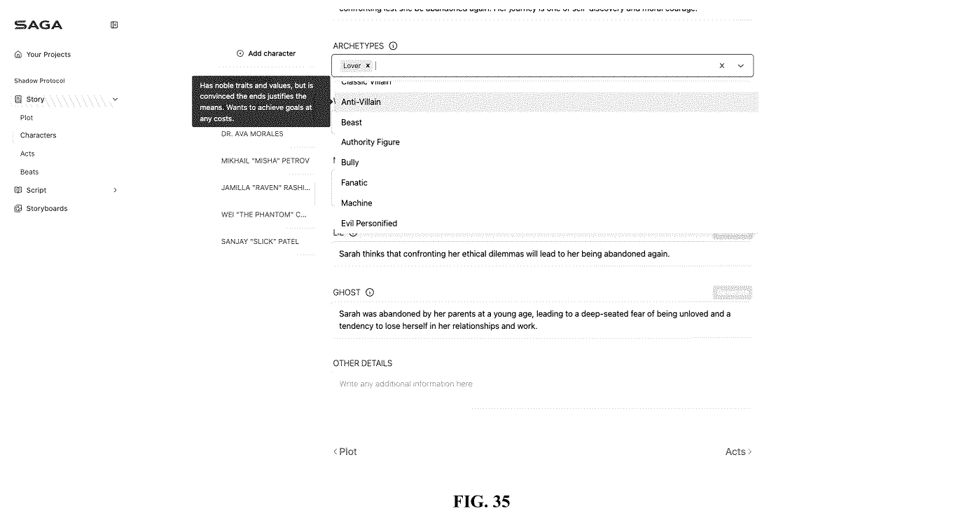

Referring to FIG. 35, a custom-defined list of universal archetype patterns is illustrated. The archetype patterns list presents a collection of narrative archetype categories that are custom-defined specifically for the application and this invention. The archetype patterns may include categories such as Hero, Mentor, Threshold Guardian, Herald, Shapeshifter, Shadow, Trickster, and Ally. Each archetype pattern may be associated with a definition explaining the narrative function and typical characteristics of characters fulfilling that archetype role. The custom archetype definitions represent proprietary story structure knowledge incorporated into the system to guide AI-assisted character development. The archetype selections are stored in the narrative state model and may be incorporated into prompts for AI-assisted character development and dialogue generation, enabling generated content to reflect established storytelling frameworks consistent with the structured approach of the narrative media generation system.

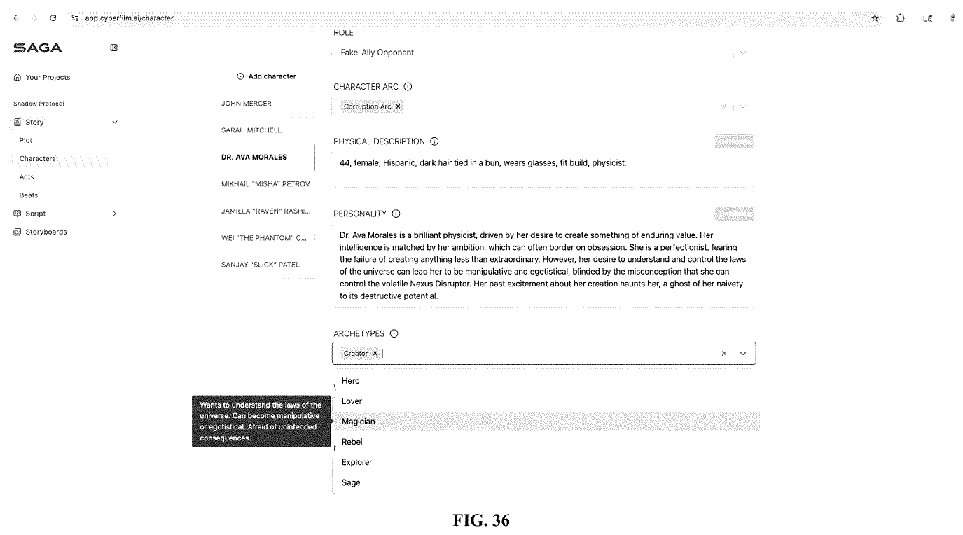

Referring to FIG. 36, a list of character archetypes with definitions is illustrated. The character archetypes list presents a collection of psychological and behavioral archetype options that are listed and defined specifically for the Saga application and this invention. The character archetypes may include options such as Hero, Lover, Magician, Rebel, Explorer, Sage, Creator, Ruler, Caregiver, Innocent, Jester, and Everyman. Each character archetype may be associated with a tooltip or definition panel explaining the motivations, fears, and typical behaviors associated with that archetype, with these definitions being custom to the application. The archetype selections inform AI-assisted generation of character dialogue, actions, and narrative arcs consistent with the selected archetype patterns, enabling the system to generate content that reflects the psychological depth and behavioral consistency established through the archetype definitions.

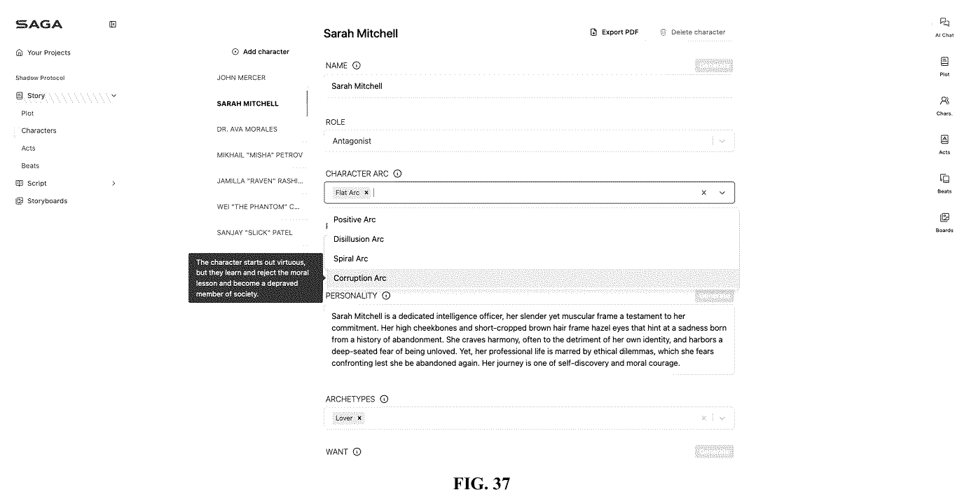

Referring to FIG. 37, a list of character arcs with definitions is illustrated. The character arcs list presents a collection of narrative arc options that are defined custom for the Saga application and this invention. The character arcs may include options such as Positive Arc, Flat Arc, Disillusion Arc, Corruption Arc, and Spiral Arc. Each character arc option may be associated with a definition explaining the transformation or consistency the character experiences throughout the narrative, with these definitions being proprietary to the application. The character arc selections are stored in the narrative state model and may be incorporated into prompts for AI-assisted screenplay generation to ensure character development remains consistent with the selected arc pattern throughout the generated content.

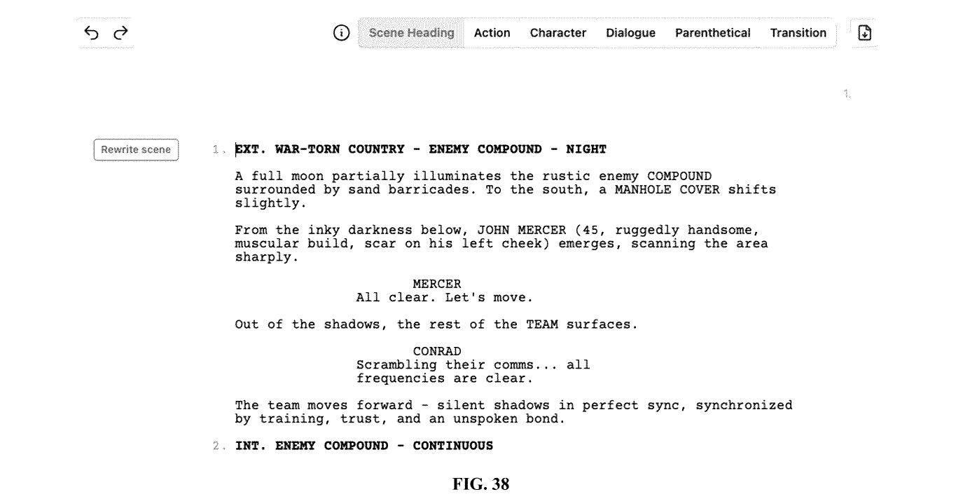

Referring to FIG. 38, a user interface for rewriting a scene with AI and user instruction is illustrated. The script editor interface displays formatted screenplay content in industry-standard format, including scene headings, action descriptions, and character dialogue blocks. A “Rewrite scene” button is positioned adjacent to the scene content, enabling users to invoke AI-assisted rewriting of selected scene content. When activated, the system constructs a prompt incorporating the selected scene text, narrative context from the narrative state model including character profiles and plot metadata, and any user-provided rewrite instructions. The rewritten scene content is generated by transmitting the prompt to a large language model and displaying the generated content for user review and acceptance. The rewrite functionality enables users to refine and improve existing screenplay content while maintaining consistency with established narrative elements stored in the narrative state model.

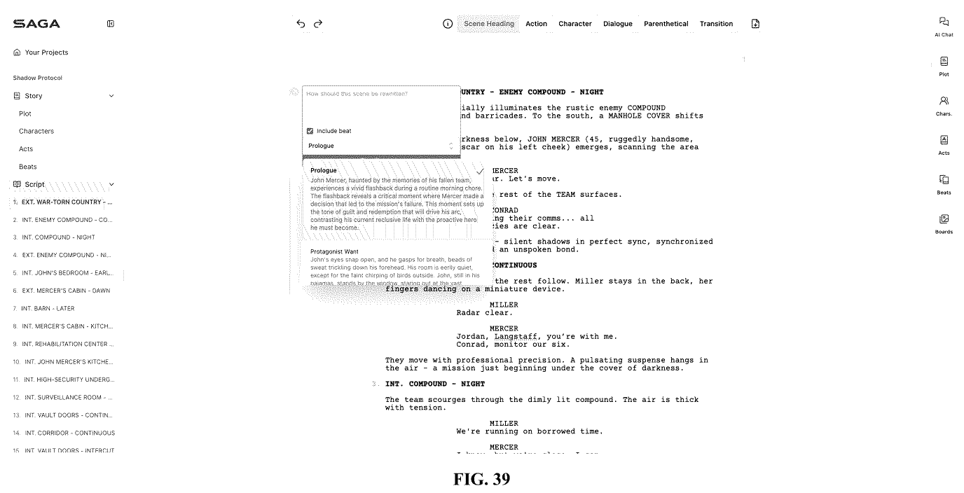

Referring to FIG. 39, a user interface for rewriting a scene with an optional text prompt and beat selection is illustrated. The interface displays a rewrite dialog panel that appears when the Rewrite Scene button is activated. The rewrite dialog panel includes a text input field where users may enter optional rewrite instructions describing the desired changes to the scene, such as making the dialogue longer or funnier, or specifying director notes for the revision. The rewrite dialog panel also includes a beat selection dropdown that enables users to select a beat from the beat sheet to guide the AI rewriting operation. When a beat is selected, the beat label and beat description are incorporated into the rewrite prompt, enabling the AI to align the rewritten scene content with the narrative function defined by the selected beat. This enables users to restructure scenes to better fulfill specific narrative beats within the story structure, ensuring that rewritten content maintains coherence with the overall narrative progression defined in the beat sheet.

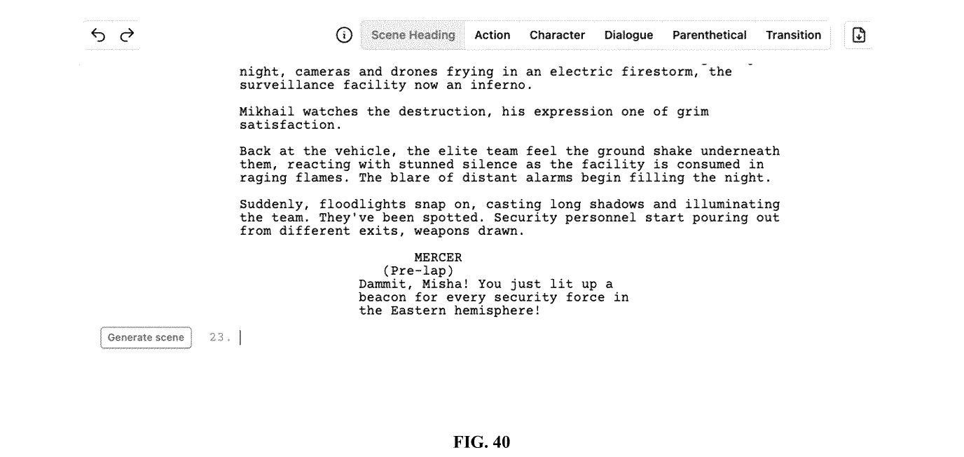

Referring to FIG. 40, a user interface showing a generate scene button inline on a script page is illustrated. The script editor interface displays formatted screenplay content with a “Generate Scene” button positioned inline within the editing workspace. The Generate Scene button may appear at the end of existing scene content or at a cursor position where the user wishes to generate new content. When activated, the system constructs a continuation prompt incorporating preceding screenplay content, narrative context from the narrative state model including character profiles and beat sheet data, and any user-provided generation instructions. The generated scene content is produced by transmitting the prompt to a large language model and displaying the generated content for user review, editing, and integration into the screenplay. The Generate Scene button assists users experiencing writer's block by generating fresh text and ideas based on the narrative context, enabling users to continue moving forward with screenplay development. The generated content may serve as a starting point that users may easily edit and refine according to creative preferences, enabling users to fill pages with content while maintaining creative control over the final screenplay.

The above description sets forth exemplary aspects of the present disclosure. It should be recognized, however, that such description is not intended as a limitation on the scope of the present disclosure. Rather, the description also encompasses combinations and modifications to those exemplary aspects described herein.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method for AI-assisted media generation, comprising:
receiving, by a processor, user input defining a narrative concept for a media project;
maintaining, by the processor, a narrative state model storing structured narrative elements including plot metadata, character profile data, and scene information associated with the media project, wherein the narrative state model comprises a hierarchical data structure that persists narrative elements across a plurality of user interfaces and enables retrieval of narrative context for prompt construction without requiring repeated user entry of narrative elements;
constructing, by the processor, a prompt based on the narrative state model and the user input, wherein constructing the prompt comprises automatically retrieving narrative context from the narrative state model based on the user input and injecting the retrieved narrative context into the prompt to maintain consistency across generated content;
transmitting, by the processor, the prompt to an external generative AI model via an application programming interface;
receiving, by the processor, generated content from the external generative AI model; and
integrating, by the processor, the generated content into the narrative state model for display in a user interface, wherein integrating the generated content comprises storing the generated content in association with corresponding narrative elements in the hierarchical data structure, thereby enabling subsequent prompt construction operations to retrieve the generated content as context for maintaining consistency across the media project.

2. The method of claim 1, wherein the plot metadata comprises at least one of a title, a logline, a theme, a story type, a genre, a tone, an audience designation, and a setting.

3. The method of claim 2, wherein the character profile data comprises at least one of a character name, a character role, a character arc, a character description, a personality trait, an archetype, a want, a need, a lie, and a ghost.

4. The method of claim 1, wherein the narrative state model further stores act structure data and beat sheet data defining narrative progression points within the media project.

5. The method of claim 4, wherein the beat sheet data comprises a plurality of beat entries organized according to a predefined beat template, each beat entry comprising a beat label and a beat description.

6. The method of claim 1, wherein constructing the prompt comprises injecting character profile data from the narrative state model into the prompt to maintain character consistency across generated content.

7. The method of claim 1, wherein the generated content comprises at least one of text content, image content, audio content, and video content.

8. The method of claim 7, wherein the external generative AI model comprises at least one of a large language model for generating text content, an image generation model for generating image content, an audio generation model for generating audio content, and a video generation model for generating video content.

9. The method of claim 1, further comprising transmitting the prompt to a plurality of external generative AI models via respective application programming interfaces and receiving a plurality of generated content options for display in the user interface for user selection.

10. The method of claim 9, further comprising:
presenting the plurality of generated content options in the user interface in a blinded format that withholds identifiers of originating generative AI models from the user;
recording user selection data indicating which generated content option from the plurality of generated content options is selected by the user, the user selection data comprising an identifier of the selected generated content option and an identifier of the generative AI model that produced the selected generated content option;
aggregating the user selection data across a plurality of generation operations to generate model selection statistics for each of the plurality of external generative AI models;
analyzing the model selection statistics to determine model preference rankings indicating which external generative AI models produce outputs that users select at higher rates; and
adjusting an ordering of generated content options presented in the user interface for subsequent generation operations based on the model preference rankings, wherein adjusting the ordering comprises at least one of increasing a number of generation requests allocated to higher-ranked generative AI models and reducing or eliminating generation requests allocated to lower-ranked generative AI models.

11. The method of claim 1, wherein constructing the prompt further comprises:
parsing the user input to extract character name tokens;
comparing the extracted character name tokens against character names stored in the narrative state model using fuzzy string matching to identify matched characters, wherein the fuzzy string matching accommodates variations in character name references including nicknames, abbreviated names, and partial name matches;
retrieving physical description data associated with each matched character from the narrative state model; and
automatically injecting the retrieved physical description data into the prompt, thereby maintaining visual consistency in generated image content depicting the matched characters without requiring user re-entry of character attributes.

12. A system for AI-assisted media generation, comprising:
a memory storing instructions; and
a processor coupled to the memory and configured to execute the instructions to:
provide a story development interface configured to receive user input defining narrative elements including at least one of plot metadata, character profiles, act structures, and beat sheet entries;
provide a script editor interface configured to display screenplay content and receive user selections for AI-assisted text generation;
provide a storyboard editor interface configured to receive shot parameters including shot type and camera level selections for AI-assisted image generation;
maintain a narrative state model that persists narrative elements across the story development interface, the script editor interface, and the storyboard editor interface, wherein the narrative state model comprises a hierarchical data structure storing associations between narrative elements that enables automatic retrieval of contextually relevant narrative elements during prompt construction;
construct prompts for external generative AI models based on the narrative state model and user selections, wherein constructing prompts comprises automatically identifying references to narrative elements within user selections and injecting corresponding narrative element data from the narrative state model into the prompts without requiring user re-entry of the narrative element data; and
integrate generated content from the external generative AI models into the narrative state model, wherein integrating generated content comprises updating the hierarchical data structure to store associations between the generated content and corresponding narrative elements, thereby enabling the generated content to be automatically retrieved as context for subsequent generation operations.

13. The system of claim 12, wherein the script editor interface is further configured to receive a user selection of text within the screenplay content and a rewrite instruction, and wherein the processor is further configured to construct a prompt incorporating the selected text, the rewrite instruction, and narrative context from the narrative state model for transmission to a large language model.

14. The system of claim 13, wherein the script editor interface is further configured to display a generate button adjacent to a cursor position within the screenplay content, and wherein activation of the generate button causes the processor to construct a continuation prompt based on preceding screenplay content and the narrative state model.

15. The system of claim 12, wherein the storyboard editor interface is further configured to receive reference image selections including at least one of character reference images, location reference images, and prop reference images, and wherein the processor is further configured to inject the reference image selections into prompts transmitted to an image generation model.

16. The system of claim 15, wherein the processor is further configured to retrieve character profile data from the narrative state model based on character name matching within a shot description and inject a physical description associated with a matched character into the prompt for the image generation model.

17. The system of claim 12, further comprising a timeline editor interface configured to receive media assets including storyboard images, video clips, and audio elements, and wherein the processor is further configured to arrange the media assets in a sequence and export a composed video file.

18. The system of claim 17, wherein the processor is further configured to transmit storyboard images to a video generation model via an application programming interface to generate animated video clips incorporating camera motion parameters, and wherein the timeline editor interface is configured to receive the animated video clips for arrangement in the sequence.

19. The system of claim 12, wherein the hierarchical data structure of the narrative state model comprises:
a project node associated with the media project;
a plot node subordinate to the project node and storing the plot metadata;
a characters node subordinate to the project node and storing the character profiles, each character profile comprising a character name, a physical description, and character arc data;
an acts node subordinate to the project node and storing the act structures, wherein the acts node comprises nested scene nodes and shot nodes representing hierarchical organization of narrative content;
a script node subordinate to the project node and storing screenplay content associated with the media project; and
a storyboard node subordinate to the project node and storing references to storyboard images and associated media elements including audio and video content, with associations to corresponding nodes in the hierarchical data structure, wherein the associations enable automatic retrieval of generated content as context for subsequent generation operations targeting related narrative elements.

20. A non-transitory computer-readable medium storing instructions that, when executed by a processor, cause the processor to perform operations comprising:
displaying a storyboard editor interface presenting a sequence of storyboard frames associated with scenes of a narrative project;
receiving a shot description and shot parameters for a new storyboard frame, the shot parameters including a shot type selection and a camera level selection;
parsing the shot description to identify character name references;
matching the identified character name references to character profile data stored in a narrative state model using fuzzy string matching that accommodates variations in character name references including nicknames and abbreviated names;
retrieving physical description data associated with matched character profiles from the narrative state model;
constructing a prompt incorporating the shot description, the shot parameters, the retrieved physical description data, and narrative context retrieved from the narrative state model associated with the narrative project, wherein the physical description data is automatically injected into the prompt without requiring user re-entry of character attributes, thereby reducing data entry redundancy and maintaining visual consistency across generated storyboard images;
transmitting the prompt to an image generation model via an application programming interface;
receiving a generated storyboard image from the image generation model; and
displaying the generated storyboard image within the storyboard editor interface for user selection.
